(19) United States
(12) Patent Application Publication
(10) Pub. No.: US 2022/0417499 A1
(43) Pub. Date: Dec. 29, 2022

(54) IMAGE PROCESSING APPARATUS AND METHOD

(71) Applicant: Sony Group Corporation, Tokyo (JP)

(72) Inventors: Mitsuru KATSUMATA, Tokyo (JP); Mitsuhiro HIRABAYASHI, Tokyo (JP); Masaru IKEDA, Tokyo (JP); Yoichi YAGASAKI, Tokyo (JP); Yuji FUJIMOTO, Tokyo (JP); Takeshi TSUKUBA, Tokyo (JP)

(73) Assignee: Sony Group Corporation, Tokyo (JP)

(21) Appl. No.: 17/781,053

(22) PCT Filed: Dec. 10, 2020
(86) PCT No.: PCT/JP2020/046001

§ 371 Date: May 31, 2022

Related U.S. Application Data
(60) Provisional application No. 62/947,913, filed on Dec. 13, 2019.
(60) Provisional application No. 62/951,138, filed on Dec. 20, 2019.
(60) Provisional application No. 63/004,010, filed on Apr. 2, 2020.

(51) Int. Cl. H04N 19/105; H04N 19/132; H04N 19/182; H04N 19/46

(52) U.S. Cl. CPC H04N 19/105; H04N 19/132; H04N 19/182; H04N 19/46

(57) ABSTRACT

An image of a fixed subpicture being a subpicture in which a position of a reference pixel is fixed in a time direction, in subpictures that are partial areas obtained by dividing a picture, is encoded with a resolution variable in a time direction. Furthermore, coded data obtained by encoding an image of a fixed subpicture being a subpicture in which a position of a reference pixel is fixed in a time direction, in subpictures that are partial areas obtained by dividing a picture, with a resolution variable in a time direction is decoded to generate the image of the resolution of the fixed subpicture. The present disclosure can be applied to, for example, an image processing apparatus, an image encoding apparatus, an image decoding apparatus, an information processing apparatus, an image processing method, an information processing method, or the like.

### TECHNICAL FIELD

The present disclosure relates to image processing apparatus and method, and more particularly, to image processing apparatus and method capable of suppressing a reduction in the degree of freedom of resolution control of an image of a subpicture.

### BACKGROUND ART

A conventional encoding method for deriving a prediction residual of a moving image, performing coefficient transform, quantizing, and encoding has been proposed (see, for example, Non-Patent Document 1). In the versatile video coding (VVC) described in Non-Patent Document 1, a function called reference picture resampling (RPR) for performing inter-picture prediction by changing inter-picture resolution is implemented. Furthermore, in the VVC, a function called a subpicture is implemented in which an image area corresponding to a picture is divided into a plurality of partial areas and used.

Moreover, it has been proposed to perform the RPR processing for each subpicture ID by switching the slice data assigned to this partial area (see, for example, Non-Patent Document 2).

### CITATION LIST

### Non-Patent Document

Non-Patent Document 1: Benjamin Bross, Jianle Chen, Shan Liu, Ye-Kui Wang, “Versatile Video Coding (Draft 7)”, JVET-P2001-vE, Joint Video Experts Team (JVET) of ITU-T SG 16 WP3 and ISO/IEC JTC 1/SC 29/WG 11 16th Meeting: Geneva, CH, 1-11 Oct. 2019
Non-Patent Document 2: Miska M. Hannuksela, Alireza Aminlou, Kashyap Kammachi-Sreedhar, “AHG8/AHG12: Subpicture-specific reference picture resampling”, JVET-P0403, Joint Video Experts Team (JVET) of ITU-T SG 16 WP 3 and ISO/IEC JTC 1/SC 29/WG 11 16th Meeting: Geneva, CH, 1-11 Oct. 2019

### SUMMARY OF THE INVENTION

### Problems to be Solved by the Invention

However, in a case of the method disclosed in Non-Patent Document 2, since the layout of the partial area to be the subpicture is fixed, there is a possibility that the degree of freedom of resolution control of the image of the subpicture is reduced.

The present disclosure has been made in view of such a situation, and is intended to suppress a reduction in the degree of freedom of resolution control of an image of a subpicture.

### Solutions to Problems

An image processing apparatus according to one aspect of the present technology is an image processing apparatus including an encoding unit that encodes an image of a fixed subpicture being a subpicture in which a position of a reference pixel is fixed in a time direction, in subpictures that are partial areas obtained by dividing a picture, with a resolution variable in a time direction to generate coded data.

An image processing method according to one aspect of the present technology is an image processing method including encoding an image of a fixed subpicture being a subpicture in which a position of a reference pixel is fixed in a time direction, in subpictures that are partial areas obtained by dividing a picture, with a resolution variable in a time direction to generate coded data.

An image processing apparatus according to another aspect of the present technology is an image processing apparatus including a decoding unit that decodes coded data obtained by encoding an image of a fixed subpicture being a subpicture in which a position of a reference pixel is fixed in a time direction, in subpictures that are partial areas obtained by dividing a picture, with a resolution variable in a time direction to generate the image of the resolution of the fixed subpicture.

An image processing method according to another aspect of the present technology is an image processing method including decoding coded data obtained by encoding an image of a fixed subpicture being a subpicture in which a position of a reference pixel is fixed in a time direction, in subpictures that are partial areas obtained by dividing a picture, with a resolution variable in a time direction to generate the image of the resolution of the fixed subpicture.

In the image processing apparatus and method according to one aspect of the present technology, an image of a fixed subpicture being a subpicture in which a position of a reference pixel is fixed in a time direction, in subpictures that are partial areas obtained by dividing a picture, is encoded with a resolution variable in a time direction.

The image processing apparatus and method according to another aspect of the present technology, coded data obtained by encoding an image of a fixed subpicture being a subpicture in which a position of a reference pixel is fixed in a time direction, in subpictures that are partial areas obtained by dividing a picture, with a resolution variable in a time direction is decoded to generate the image of the resolution of the fixed subpicture.

### BRIEF DESCRIPTION OF DRAWINGS

FIG. 1 is a diagram illustrating a configuration example of a bit stream.

FIG. 2 is a diagram illustrating an example of subpicture mapping information.

FIG. 3 is a diagram illustrating an example of subpicture ID mapping information.

FIG. 4 is a diagram illustrating an example of resolution control for each subpicture.

FIG. 5 is a diagram illustrating a method of controlling resolution of an image of a subpicture.

FIG. 6 is a diagram illustrating an example of resolution control of an image of a fixed subpicture.

FIG. 7 is a diagram illustrating an example of subpicture mapping information.

FIG. 8 is a diagram illustrating an example of subpicture ID mapping information.

FIG. 9 is a diagram illustrating an example of a non-subpicture area existence flag.

FIG. 10 is a diagram illustrating an example of effective area information.

FIG. 11 is a diagram illustrating an example of an uncoded area existence flag.

FIG. 12 is a diagram illustrating an example of an uncoded area existence flag.

FIG. 13 is a diagram illustrating an example of resolution control of an image of a fixed subpicture.

FIG. 14 is a diagram illustrating an example of subpicture mapping information.

FIG. 15 is a diagram illustrating an example of a no-slice data flag.

FIG. 16 is a diagram illustrating an example of an RPR-applied subpicture enable flag.

FIG. 17 is a diagram illustrating an example of an RPR-applied subpicture enable flag.

FIG. 18 is a diagram illustrating an example of an RPR-applied subpicture enable flag.

FIG. 19 is a block diagram illustrating a main configuration example of an image encoding device.

FIG. 20 is a flowchart illustrating an example of a flow of encoding processing.

FIG. 21 is a block diagram illustrating a main configuration example of an image decoding device.

FIG. 22 is a flowchart illustrating an example of a flow of decoding processing.

FIG. 23 is a diagram illustrating a method of controlling resolution of an image of a subpicture.

FIG. 24 is a diagram illustrating an example of a subpicture window and a padding sample.

FIG. 25 is a diagram illustrating an example of subpicture rendering information.

FIG. 26 is a diagram illustrating an example of subpicture setting information.

FIG. 27 is a diagram illustrating an example of subpicture setting information.

FIG. 28 is a diagram illustrating an example of subpicture setting information.

FIG. 29 is a diagram illustrating an example of a rescaling prohibition flag.

FIG. 30 is a flowchart illustrating an example of a flow of encoding processing.

FIG. 31 is a flowchart illustrating an example of a flow of decoding processing.

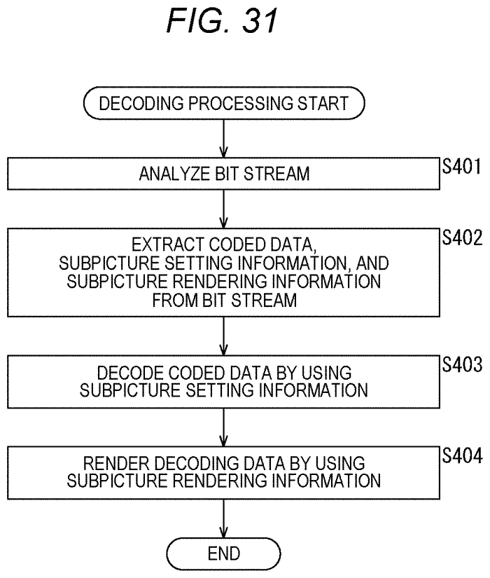

FIG. 32 is a diagram illustrating a method of controlling resolution of an image of a subpicture.

FIG. 33 is a diagram illustrating an example of subpicture rendering information.

FIG. 34 is a diagram illustrating an example of subpicture rendering information.

FIG. 35 is a diagram illustrating an example of subpicture rendering information.

FIG. 36 is a diagram illustrating an example of subpicture rendering information.

FIG. 37 is a diagram illustrating an example of subpicture rendering information.

FIG. 38 is a diagram illustrating an example of subpicture rendering information.

FIG. 39 is a diagram illustrating an example of subpicture rendering information.

FIG. 40 is a diagram illustrating an example of subpicture rendering information.

FIG. 41 is a diagram illustrating an example of subpicture rendering information.

FIG. 42 is a diagram illustrating a configuration example of a Matroska media container.

FIG. 43 is a diagram illustrating an example of subpicture rendering information.

FIG. 44 is a diagram illustrating an example of subpicture rendering information.

FIG. 45 is a diagram illustrating a main configuration example of an image processing system.

FIG. 46 is a diagram illustrating a main configuration example of a file generation device.

FIG. 47 is a diagram illustrating a main configuration example of a client device.

FIG. 48 is a flowchart illustrating an example of a flow of file generation processing.

FIG. 49 is a flowchart illustrating an example of a flow of reproduction processing.

FIG. 50 is a block diagram illustrating a main configuration example of a computer.

### MODE FOR CARRYING OUT THE INVENTION

Hereinafter, modes (hereinafter referred to as embodiments) for implementing the present disclosure will be described. Note that the description will be given in the following order.

1. Resolution control 1 of image of subpicture

2. First embodiment (encoding)

3. Second embodiment (decoding)

4. Resolution control 2 of image of subpicture

5. Third embodiment (encoding)

6. Fourth embodiment (decoding)

7. Resolution control 3 of image of subpicture

8. Fifth embodiment (image processing system)

9. Supplementary note

### <1. Resolution Control 1 of Image of Subpicture>

<Documents Supporting Technical Contents and Technical Terms>

The scope disclosed in the present technology includes not only the contents described in the embodiments but also the contents described in the following non-patent documents and the like known at the time of filing, the contents of other documents referred to in the following non-patent documents, and the like.

Non-Patent Document 1: (described above)

Non-Patent Document 2: (described above)

Non-Patent Document 3: Recommendation ITU-T H. 264 (04/2017) “Advanced video coding for generic audiovisual services”, April 2017

Non-Patent Document 4: Recommendation ITU-T H. 265 (02/18) “High efficiency video coding”, February 2018

Non-Patent Document 5: Ye-Kui Wang, Miska M. Hannuksela, Karsten Gruneberg, “WD of Carriage of VVC in ISOBMFF”, ISO/IEC JTC 1/SC 29/WG 11 N18856, Geneva, CH-October 2019

Non-Patent Document 6: “Information technology. Dynamic adaptive streaming over HTTP (DASH). Part 1: Media presentation description and segment formats”, ISO/IEC 23009-1: 2012(E), ISO/IEC JTC1/SC 29/WG 11, 2012-01-05

Non-Patent Document 7: https://www.matroska.org/index.html

That is, the content described in the above-described non-patent documents also serves as a basis for determining the support requirement. For example, even in a case where the quad-tree block structure and the quad tree plus binary tree (QTBT) block structure described in the above-described non-patent documents are not directly described in the examples, the quad-tree block structure and the QTBT block structure fall within the disclosure scope of the present technology and satisfy the support requirements of the claims. Furthermore, for example, technical terms such as parsing, syntax, and semantics are similarly within the disclosure scope of the present technology even in a case where there is no direct description in the examples, and satisfy the support requirements of the claims.

Furthermore, in the present specification, a “block” (not a block indicating a processing unit) used for description as a partial area or a processing unit of an image (picture) indicates an arbitrary partial area in the picture unless otherwise specified, and a size, a shape, a characteristic, and the like thereof are not limited. For example, the “block” includes an arbitrary partial area (processing unit) such as a transform block (TB), a transform unit (TU), a prediction block (PB), a prediction unit (PU), a smallest coding unit (SCU), a coding unit (CU), a largest coding unit (LCU), a coding tree block (CTB), a coding tree unit (CTU), a subblock, a macroblock, a tile, or a slice described in the above-described non-patent documents.

Furthermore, when the size of such a block is designated, the block size may be indirectly designated in addition to directly designating the block size. For example, the block size may be designated using identification information for identifying the size. Furthermore, for example, the block size may be designated by a ratio or a difference from the size of a reference block (for example, an LCU or an SCU). For example, in a case where information for designating a block size is transmitted as a syntax element or the like, information for indirectly designating a size as described above may be used as the information. As a result, the information amount of the information can be reduced, and the encoding efficiency can be improved in some cases. Furthermore, the designation of the block size also includes designation of a range of the block size (for example, designation of a range of allowable block sizes).

<RPR>

In the versatile video coding (VVC) described in Non-Patent Document 1, a function called reference picture resampling (RPR) for performing inter-picture prediction by changing inter-picture resolution is implemented. By changing the resolution between pictures, the encoding amount can be reduced while maintaining the image quality.

<Subpicture>

Furthermore, in the VVC, a function called a subpicture is implemented in which an image area corresponding to a picture is divided into a plurality of partial areas and used.

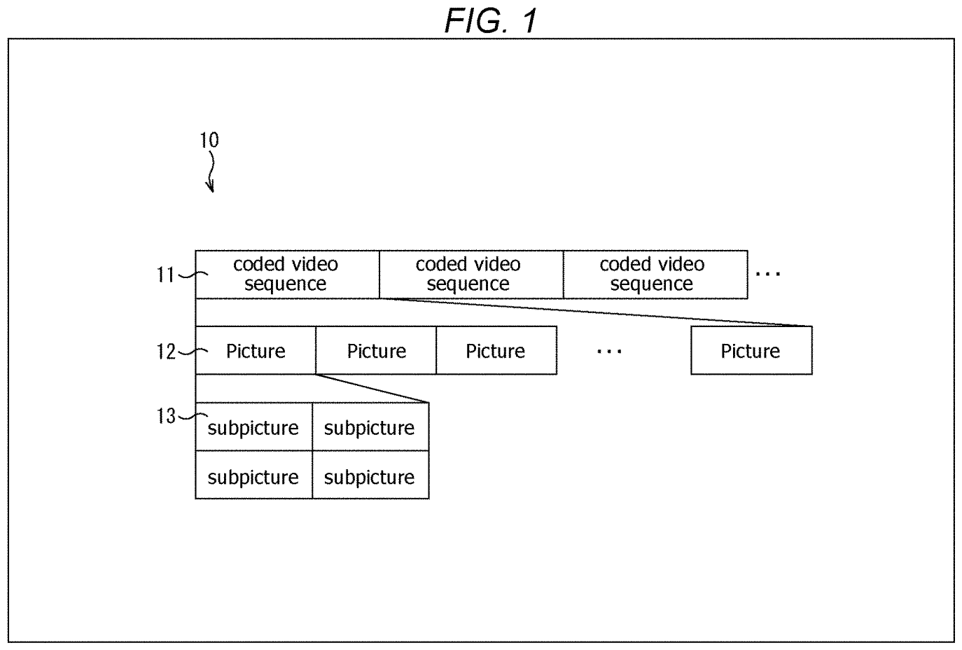

FIG. 1 is a diagram illustrating a main configuration example of a VVC bit stream that is a bit stream generated by encoding an image by a VVC encoding method. A VVC bit stream 10 illustrated in FIG. 1 is coded data of a moving image including a plurality of frame images. The VVC bit stream 10 includes a set of coded data 11 of a coded video sequence (CVS). The CVS is a set of pictures in a predetermined period. The picture is a frame image at a certain time. That is, the coded data 11 of the CVS is configured by a set of coded data 12 of pictures at each time within a predetermined period.

The coded data 12 of the picture includes a set of coded data 13 of a subpicture. The subpicture is a partial area obtained by dividing a picture (that is, an image area corresponding to a picture).

In the VVC described in Non-Patent Document 1, a picture and a subpicture have the following features. The picture and the subpicture are rectangular. There is no pixel having no coded data in the picture. There is no overlap between the subpictures. There are no pixels in the picture that are not included in any subpicture.

A subpicture is a function intended to implement decoding (distributed processing) for each subpicture or reduce an instance of a decoder by merging a plurality of pictures or subpictures into one picture.

For example, by assigning each of the images of six surfaces of an omnidirectional video (6 degree of freedom (DoF) content) to the subpicture, various types of control such as processing the images of the respective surfaces independently or processing the images in a merged manner are facilitated. Note that, since a subpicture is not an encoding unit such as a slice or a tile, for example, another subpicture can be referred to at the time of encoding.

In order to achieve such a subpicture, picture division information (subpicture mapping information) is signalled (that is, the information is transmitted from the encoding side apparatus to the decoding side apparatus).

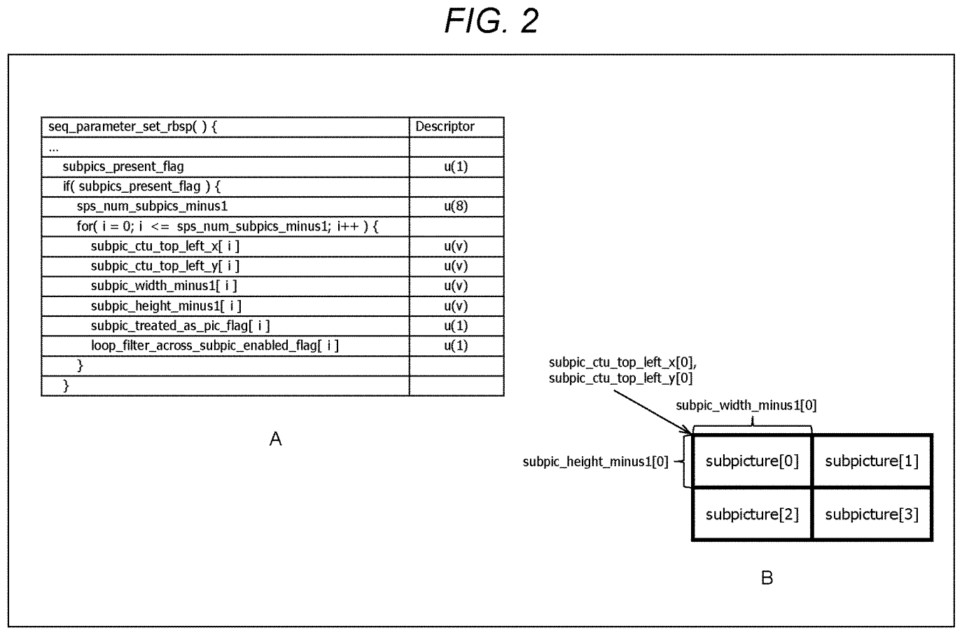

Subpicture mapping information is information fixed in the CVS (information that cannot be changed). For example, the subpicture mapping information is signalled in a sequence parameter set (SPS) that is a parameter set for each sequence as in syntax illustrated in A of FIG. 2.

Subpicture mapping information is information indicating a layout of each partial area to be a subpicture. As illustrated in B of FIG. 2, the subpicture mapping information expresses each divided area by position information (for example, XY coordinates) and size information of a reference pixel (for example, a pixel at an upper left end). In a case of the example of FIG. 2, a horizontal direction position (subpic_ctu_top_left_x) and a vertical direction position (subpic_ctu_top_left_y) of the upper left end pixel of the subpicture are indicated in units of CTU as position information of a reference pixel. Furthermore, as size information, a width (subpic_width_minus1) and a height (subpic_height_minus1) of the subpicture are indicated in units of CTUs.

Furthermore, in order to achieve such a subpicture, identification information (subpicture ID mapping information) of the subpicture for determining image data (slice data) assigned to each partial area represented by the subpicture mapping information is signalled. The subpicture ID mapping information is a list of identification information of subpictures assigned to each partial area.

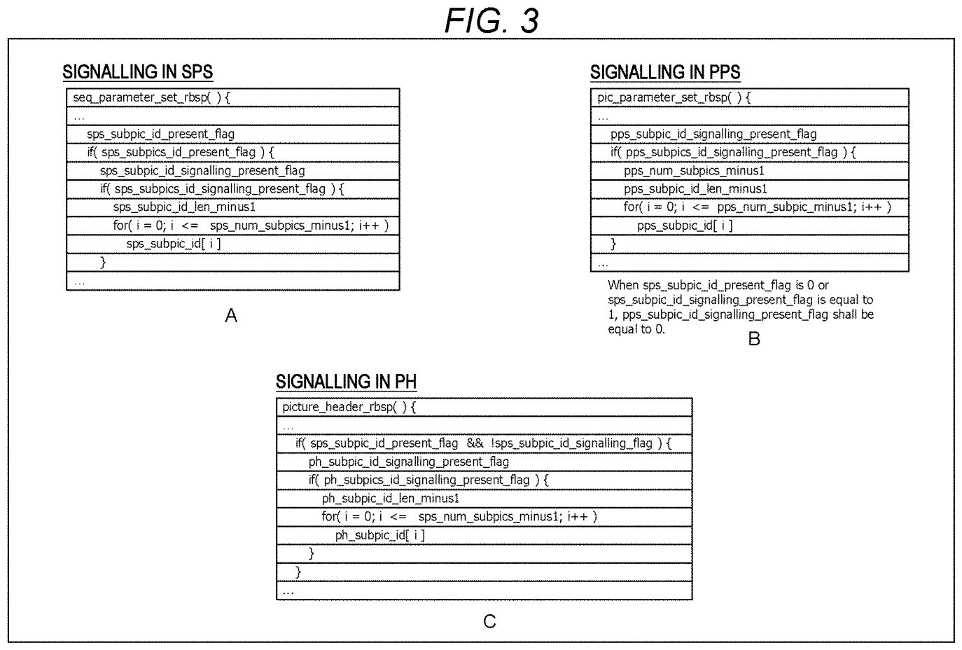

The subpicture ID mapping information is information (variable information) that can be changed for each picture. For example, the subpicture ID mapping information, as illustrated in A of FIG. 3, the subpicture ID mapping information can be signalled in the SPS. Furthermore, as illustrated in B of FIG. 3, the subpicture ID mapping information can also be signalled in a picture parameter set (PPS) which is a parameter set in units of pictures. Moreover, as illustrated in C of FIG. 3, the subpicture ID mapping information can be signalled in a picture header (PH).

In such subpicture ID mapping information, the same subpicture IDs are assigned to partial areas to which image data of the same slice is assigned between pictures, and thereby, the partial areas are identified as the same subpictures.

<Method of Applying RPR Technology for Each Subpicture>

Non-Patent Document 2 has proposed to perform the RPR processing for each subpicture ID by switching the slice data assigned to this partial area. The subpicture mapping information is fixed in the CVS, and the subpicture ID mapping information is variable in the time direction. That is, by signalling the subpicture ID mapping information in the PPS or PH, it is possible to switch slice data to be assigned to each partial area indicated by the subpicture mapping information for each picture.

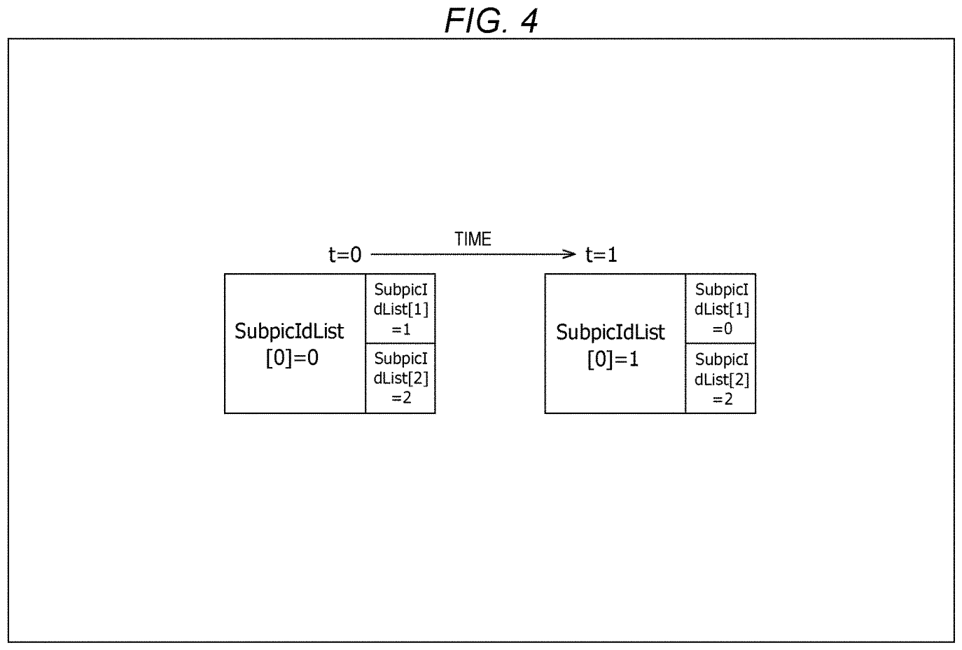

For example, as illustrated in FIG. 4, in a picture at time t=0 and a picture at time t=1, a subpicture ID is assigned to each partial area. That is, in the picture at the time t=0. the subpicture with subpicture ID=0 is the largest. The resolutions of the image of the subpicture with subpicture ID=1 and the image of the subpicture with subpicture ID=2 are half of the resolution of the image of the subpicture with the subpicture ID=0.

On the other hand, in the picture at the time t=1, the subpicture with the subpicture ID=1 is the largest, and the resolution of the image of the subpicture with the subpicture ID=0 is half of the resolution of the image of the subpicture with the subpicture ID=1. The resolution of the image of the subpicture with the subpicture ID=2 does not change. In such a sequence, the RPR processing is applied for each subpicture ID.

However, in this method, the resolution of the image of the subpicture is limited to the size of the partial area to be the subpicture. Then, since the layout of the partial area is fixed, the resolution of the image of the subpicture is further limited. That is, there is a possibility that the degree of freedom of the resolution control of the image of the subpicture is reduced. For example, in a case of the example of FIG. 4, since there are only two types of sizes of the partial area, the resolution of the image of the subpicture is also limited to the two types, and it is difficult to set other resolutions.

Furthermore, in the case of this method, since the partial area to which the same subpicture ID is assigned is switched in the time direction, the position of the subpicture greatly changes in the entire sequence. Therefore, there has been a possibility that a processing load of an encoder or a decoder that performs the RPR processing for each subpicture increases.

<RPR Processing of Fixed Subpicture>

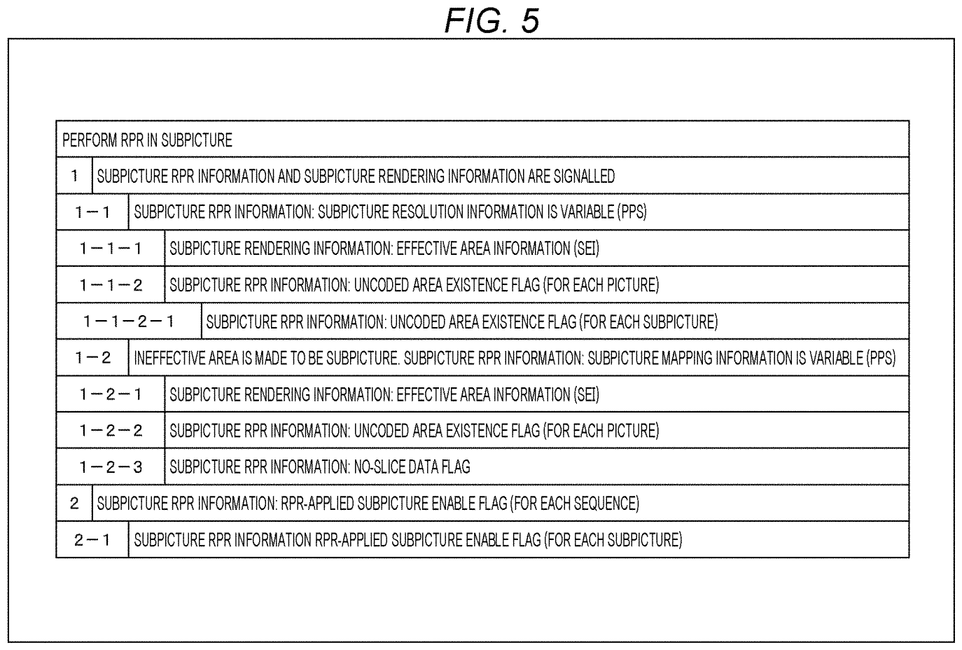

Therefore, as illustrated in the uppermost part of the table in FIG. 5, the RPR processing is performed in the subpicture in which the position of the reference pixel is fixed in the time direction. A subpicture in which the position of the reference pixel is fixed in the time direction is also referred to as a fixed subpicture.

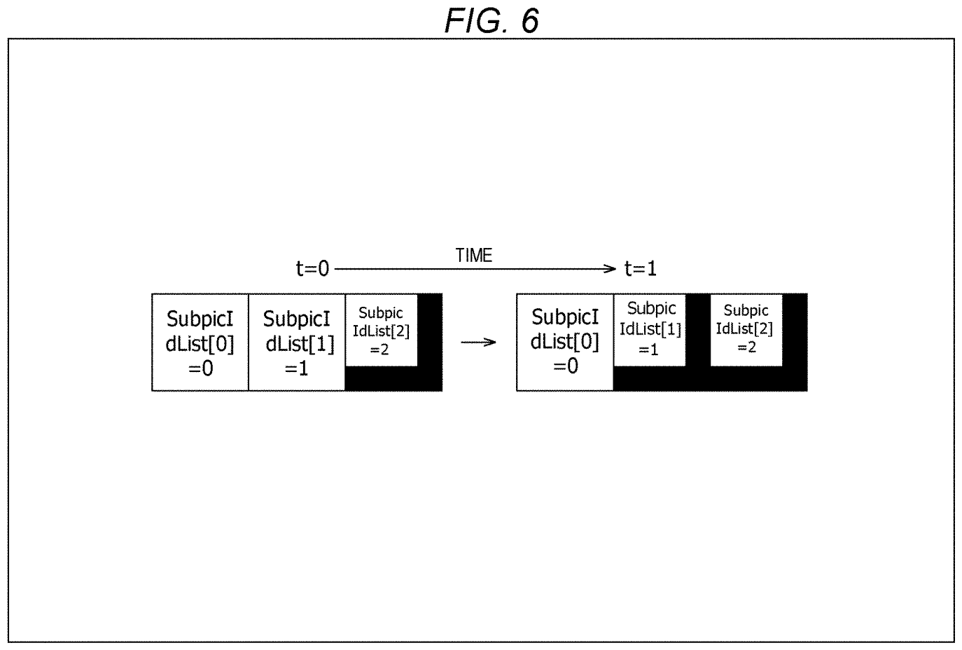

That is, instead of switching the subpicture ID assigned to each partial area as in the method described in Non-Patent Document 2, the resolution of the image is controlled in the partial area in which the assigned subpicture ID is fixed in the time direction as in the example illustrated in FIG. 6.

In the case of the example of FIG. 6, slice data of the subpicture ID=1 is assigned to a central partial area, that is, a partial area of SubpiclDList[1] in both the picture at the time t=0 and the picture at the time t=1. That is, the picture is a fixed subpicture. In this fixed subpicture, the resolution of the image in the picture at the time t=1 is smaller than the resolution of the image in the picture at the time t=0. That is, the resolution of the image is controlled to be variable in the time direction.

For example, in the image processing method (encoding processing), an image of a fixed subpicture being a subpicture in which a position of a reference pixel is fixed in a time direction, in subpictures that are partial areas obtained by dividing a picture, is encoded with a resolution variable in a time direction.

For example, in the image processing apparatus (image coding apparatus), an encoding unit that encodes an image of a fixed subpicture being a subpicture in which a position of a reference pixel is fixed in a time direction, in subpictures that are partial areas obtained by dividing a picture, with a resolution variable in a time direction, is provided.

For example, in the image processing method (decoding method), coded data obtained by encoding an image of a fixed subpicture being a subpicture in which a position of a reference pixel is fixed in a time direction, in subpictures that are partial areas obtained by dividing a picture, with a resolution variable in a time direction is decoded to generate the image of the resolution of the fixed subpicture.

For example, in the image processing apparatus (image decoding apparatus), a decoding unit that decodes coded data obtained by encoding an image of a fixed subpicture being a subpicture in which a position of a reference pixel is fixed in a time direction, in subpictures that are partial areas obtained by dividing a picture, with a resolution variable in a time direction to generate the image of the resolution of the fixed subpicture.

As a result, since the resolution of the image of the subpicture is not limited to the size of the partial area, it is possible to suppress a reduction in the degree of freedom of resolution control of the image of the subpicture. For example, in a case where a 360-degree video is set as a subpicture for each surface by a cube map method, in a case where a surface included in a recommended viewing direction is encoded with high resolution and other surfaces are encoded with low resolution, the resolution can be freely determined.

Furthermore, since the position of the subpicture is fixed, it is possible to suppress an increase in load of encoding processing and decoding processing for performing the RPR processing for each subpicture.

<Method 1>

In order to implement such control, as illustrated in the second row from the top of the table in FIG. 5, subpicture RPR information that is information used for decoding the RPR function and subpicture rendering information that is information used for rendering decoded data may be signalled for each subpicture (method 1).

As a result, the decoding side apparatus can more easily perform the RPR processing for each subpicture.

Furthermore, the decoding side apparatus can more easily render the image of the decoded subpicture.

<Method 1-1>

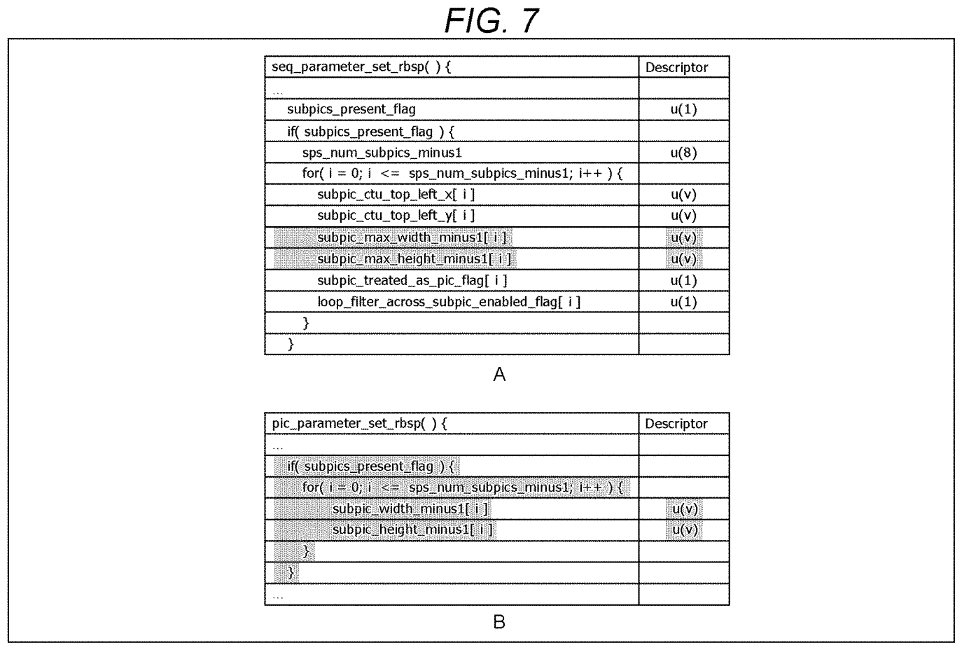

For example, as illustrated in the third row from the top of the table in FIG. 5, as the subpicture RPR information, subpicture resolution information that is information indicating the resolution of the image of the subpicture may be signalled so as to be variable in the time direction (Method 1-1). For example, the subpicture resolution information may be signalled in the PPS. In the case of the example in B of FIG. 7, subpic_width_minus1 indicating the width of the subpicture in units of CTU and subpic_height_minus1 indicating the height of the subpicture in units of CTU are signalled in the PPS.

That is, the encoding side apparatus may signal the subpicture resolution information, which is information indicating the resolution of the image of the subpicture, for each picture. Furthermore, the decoding side apparatus may analyze the subpicture resolution information signalled for each picture, decode the coded data, and generate an image of a fixed subpicture having a resolution indicated by the analyzed subpicture resolution information.

As a result, the resolution of the image of the subpicture can be made variable in the time direction within the range of equal to or less than the maximum resolution. Therefore, a reduction in the degree of freedom of the resolution control of the subpicture can be suppressed as compared with the method described in Non-Patent Document 2. Furthermore, by controlling the resolution of the fixed subpicture, the position of the subpicture whose resolution is to be controlled does not greatly change, and thus, it is possible to suppress an increase in the load of the encoding processing and the decoding processing as compared with the method described in Non-Patent Document 2.

On the other hand, among the subpicture mapping information, the subpicture reference pixel position information that is information indicating the position of the reference pixel of the subpicture, the subpicture maximum resolution information that is information indicating the maximum resolution (maximum size) of the subpicture, and the subpicture ID mapping information that is a list of the identification information of the subpicture may be fixed in the time direction (may not change in the time direction).

For example, these pieces of information may be signalled in the SPS. In a case of the example in A of FIG. 7, as the subpicture reference pixel position information, subpic_ctu_top_left_x indicating the horizontal direction position of the reference pixel in units of CTU and subpic_ctu_top_left_y indicating the vertical direction position of the reference pixel in units of CTU are signalled in the SPS. Furthermore, as the subpicture maximum resolution information, subpic_max_width_minus1 indicating the maximum width of the subpicture in CVS in units of CTU and subpic_max_height_minus1 indicating the maximum height of the subpicture in CVS in units of CTU are signalled in the SPS. Moreover, the subpicture ID mapping information is signalled in the SPS with syntax as illustrated in A of FIG. 3.

That is, the encoding side apparatus may signal the subpicture reference pixel position information, the subpicture maximum resolution information, and the subpicture ID mapping information for each sequence. Furthermore, the decoding side apparatus may analyze the subpicture reference pixel position information, the subpicture maximum resolution information, and the subpicture ID mapping information signalled for each sequence, decode the coded data on the basis of the analyzed subpicture reference pixel position information, the subpicture maximum resolution information, and the subpicture ID mapping information, and generate the image with the resolution of the fixed subpicture. The decoding side apparatus can specify the fixed subpicture in which the position of the reference pixel does not change on the basis of the subpicture reference pixel position information and the subpicture ID mapping information. That is, the decoding side apparatus can control the resolution of the fixed subpicture. Furthermore, the decoding side apparatus can control the resolution of the fixed subpicture within a range of equal to or less than the maximum resolution on the basis of the subpicture maximum resolution information.

Note that, in order to fix the subpicture ID mapping information in the CVS, the following rule may be added so that the subpicture ID mapping information is always signalled in the SPS.

That is, the SPS subpicture ID presence flag (sps_subpic_id_present_flag) is set to false (value “0”) (sps_subpic_id_present_flag=0), or the SPS subpicture signalling presence flag (sps_subpic_id_signalling_present_flag) is set to true (value “1”) (sps_subpic_id_signalling_present_flag=1).

The SPS subpicture ID presence flag indicates that no signalling of the subpicture ID is present in either the SPS or the PPS. In this case, the subpicture mapping index is the subpicture ID. The SPS subpicture signalling presence flag is flag information indicating whether a subpicture ID to be signalled is present in the SPS.

Furthermore, it may be explicitly indicated that the subpicture ID mapping information is fixed (not changed) in the CVS. For example, the encoding side apparatus may signal a subpicture ID fixing flag that is flag information indicating whether the subpicture ID mapping information that is a list of the identification information of the subpictures is not changed in the sequence. Furthermore, the decoding side apparatus may analyze the signalled subpicture ID fixed flag, decode the coded data on the basis of the analyzed subpicture ID fixed flag, and generate the image with the resolution of the fixed subpicture.

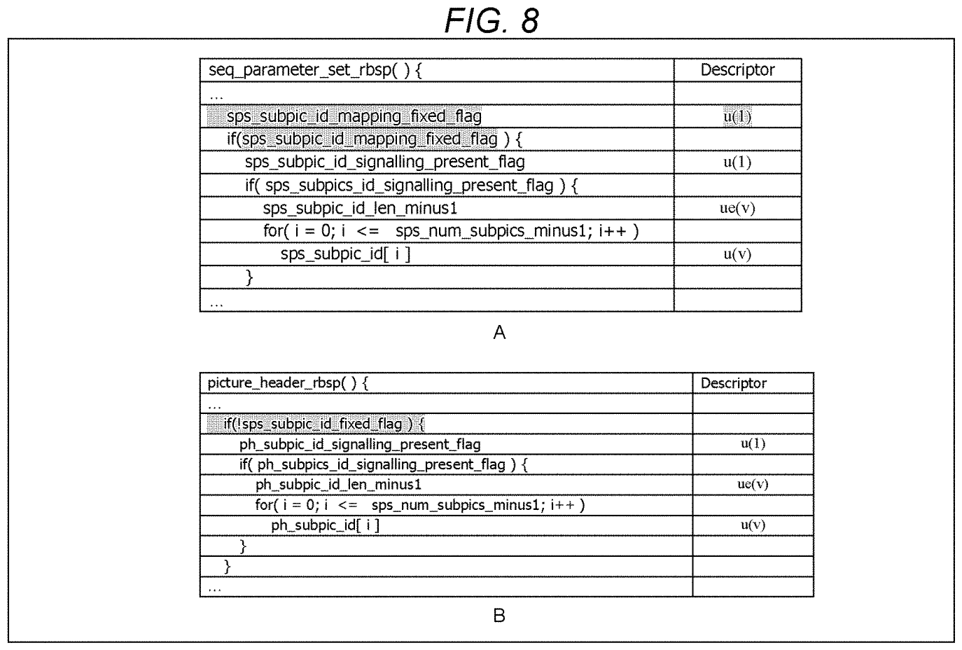

A of FIG. 8 illustrates an example of the SPS. Furthermore, B of FIG. 8 illustrates an example of the PPS. In the SPS illustrated in A of FIG. 8, sps_subpic_id_mapping_fixed_flag is signalled as the subpicture ID fixed flag. In a case where sps_subpic_id_mapping_fixed_flag is true (value “1”), it indicates that the subpicture ID is fixed (not changed) in the CVS. Furthermore, in a case where sps_subpic_id_mapping_fixed_flag is false (value “0”), it indicates that the subpicture ID is variable in the CVS.

Then, in the SPS illustrated in A of FIG. 8, in a case where sps_subpic_id_mapping_fixed_flag is true, it is indicated that the subpicture ID mapping information is signalled in the SPS. Furthermore, in the PH illustrated in B of FIG. 8, in a case where sps_subpic_id_mapping_fixed_flag is false, it is indicated that the subpicture ID mapping information is signalled in the PPS.

For example, in a case where the subpicture ID fixed flag is true, since the subpicture mapping information is fixed in the CVS, the decoding side apparatus can omit analysis of the subpicture ID mapping information for each picture. As a result, an increase in the load of the decoding processing can be suppressed.

For example, the encoding side apparatus may signal a non-subpicture area existence flag that is flag information indicating whether a non-subpicture area that is an area not included in a subpicture exists in the picture. Furthermore, the decoding side apparatus may analyze the signalled non-subpicture area existence flag, decode the coded data on the basis of the analyzed non-subpicture area existence flag, and generate the image with the resolution of the fixed subpicture.

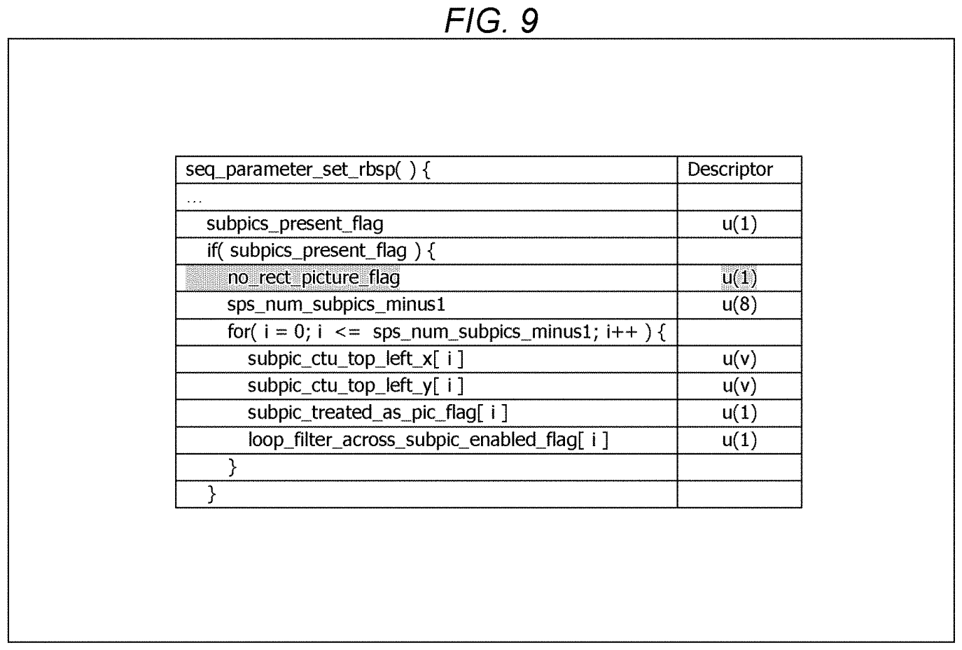

FIG. 9 illustrates an example of the SPS. In the SPS illustrated in FIG. 9, no_rect_picture_flag is signalled as the non-subpicture area existence flag. In a case where no_rect_picture_flag is true (value “1”), it indicates that an area not included in the subpicture may be present in the picture when the picture is generated from the indicated subpicture. In a case of false (value “0”), it indicates that there is no area not included in the subpicture in the picture.

Note that signalling of the subpicture maximum resolution information may be omitted. In that case, in a use case of merging a plurality of pictures (or subpictures), when determining the subpicture mapping information, it is necessary to search for a maximum resolution in the CVS of each picture (or subpicture).

<Method 1-1-1>

For example, as illustrated in the fourth row from the top of the table in FIG. 5, effective area information that is information indicating an area (effective area) of a decoded picture in which pixel data is present may be defined as the subpicture rendering information, and may be signalled in Supplemental Enhancement Information (SEI) (Method 1-1-1).

For example, the encoding side apparatus may signal effective area information that is information regarding an effective area that is an area in which pixel data is present of a picture. Furthermore, the decoding side apparatus may analyze the signalled effective area information, render image data of the decoded effective area on the basis of the analyzed effective area information, and generate a display image.

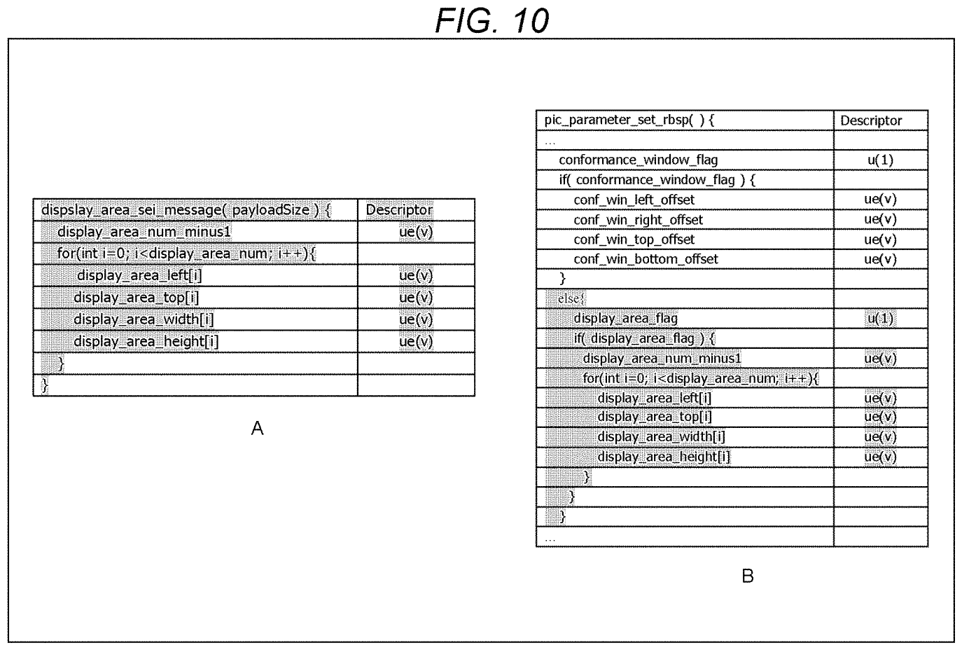

A of FIG. 10 illustrates an example of syntax of the effective area information. The effective area is indicated by a set of rectangular effective areas. display_area_num_minus1 is a parameter indicating the number of rectangular effective areas. display_area_*** is a parameter indicating upper left coordinates, a height, and a width of each rectangular effective area.

However, in a case of conformance_window_flag=1 of the PPS, the area is not allowed to present.

Note that the effective area information may be stored in the PPS. B of FIG. 10 illustrates an example of syntax of the PPS in that case. In a case where display_area_flag is true (value “1”), it indicates that the effective area information is present. By using this flag information, it is possible to explicitly perform exclusive processing with the conformance window.

Furthermore, not the effective area but the ineffective area may be signalled. As in the example of FIG. 6, the ineffective area is an area where pixel data is not present (a black filled area in FIG. 6) generated in a case where the resolution of the image of the subpicture is reduced. This information may be stored in the SEI or the PPS.

Moreover, a signalling may be performed so that the effective area and the ineffective area can be selected and indicated. For example, flag information indicating whether to select the effective area (or flag information indicating whether to select the ineffective area) may be signalled. This information may be stored in the SEI or the PPS.

As described above, by signalling the effective area information, the decoding side apparatus can display only the effective area on the basis of the effective area information. Furthermore, by specifying the effective area on the basis of the effective area information, the decoding side apparatus can determine that the data is damaged data in a case where the data is included in the effective area but is not present.

Note that the effective area may be an area that can be used for display (an area that can be used for rendering) regardless of the presence or absence of pixel data. For example, an area that is not used for display even if pixel data is present may be set as an ineffective area.

<Method 1-1-2>

For example, as illustrated in the fifth row from the top of the table in FIG. 5, an uncoded area existence flag that is flag information indicating whether an uncoded area including pixels having no coded data exists in a picture may be signalled as the subpicture RPR information (Method 1-1-2).

For example, the encoding side apparatus may signal the uncoded area existence flag that is flag information indicating whether an uncoded area including pixels having no coded data exists in a picture. Furthermore, the decoding side apparatus may analyze the signalled uncoded area existence flag, decode the coded data on the basis of the analyzed uncoded area existence flag, and generate the image of the fixed subpicture.

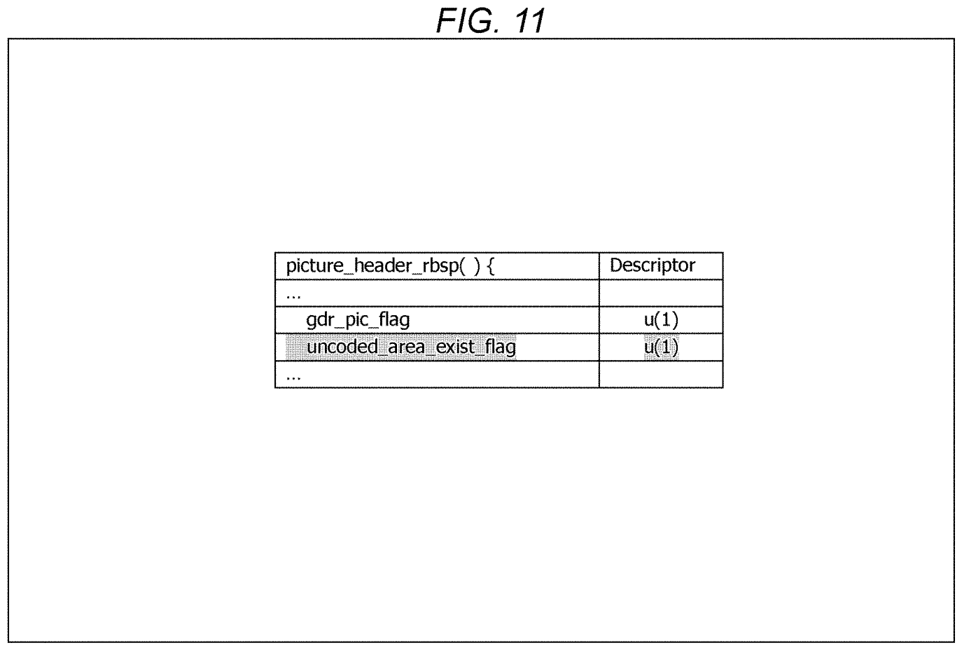

This uncoded area existence flag may be signalled in the PH, for example. FIG. 11 illustrates an example of syntax of a picture header in that case. uncoded_area_exist_flag illustrated in FIG. 11 is the uncoded area existence flag. In a case where this flag is true (value “1”), it indicates that there may be an uncoded area including pixels having no coded data in a picture. In a case where this flag is false (value “0”), there is no uncoded area. Considering a case where a pixel having no coded data is referred to in the decoding processing, the pixel is set to a sample value indicated by 8.3.4.2 Generation of one unavailable picture of Non-Patent Document 1 (JVET-P2001).

In a case where there is a pixel (uncoded area) having no coded data in a picture, an error generally occurs in the uncoded area. However, in a case of the resolution control of the image of the subpicture as described above, the decoding side apparatus can specify the area where the pixel data exists by the subpicture resolution information or the like, and thus, can decode only the area. Therefore, by signalling the uncoded area existence flag as described above, the decoding side apparatus can easily grasp whether or not decoding is possible (whether or not decoding is to be performed) with reference to the uncoded area existence flag. That is, by signalling the uncoded area existence flag, it is possible to explicitly indicate whether or not the decoding side apparatus can decode a picture (whether or not to decode the picture) even if the picture has an uncoded area.

Therefore, by signalling the uncoded area existence flag, when a picture having an uncoded are is encoded, it is not necessary to pad a pixel in the uncoded area with some value, and thus, it is possible to suppress an increase in the encoding amount.

Note that this uncoded are existence flag can also be applied to a picture that is not divided into subpictures.

Furthermore, this uncoded area existence flag may be signalled in the SPS. However, in that case, the fact that the uncoded area existence flag is true means that a picture having a pixel having no coded data exists in a part of pictures included in the CVS. That is, it is not possible to determine whether there is a pixel having no coded data for each picture.

<Method 1-1-2-1>

For example, as illustrated in the sixth row from the top of the table in FIG. 5, an uncoded area existence flag may be signalled for each subpicture as the subpicture RPR information. That is, it may be indicated whether or not an uncoded area exists in each subpicture (Method 1-1-2-1).

For example, the encoding side apparatus may signal the non-encoding area existence flag that is flag information indicating whether a non-encoding area including pixels having no coded data exists in a subpicture. Furthermore, the decoding side apparatus may analyze the signalled uncoded area existence flag, decode the coded data on the basis of the analyzed uncoded area existence flag, and generate the image of the fixed subpicture.

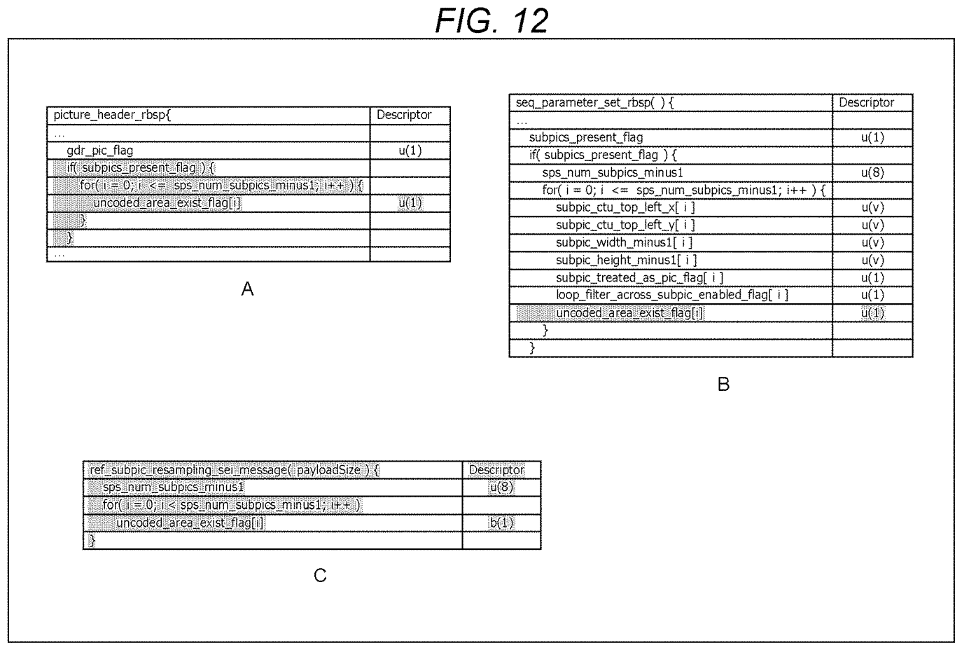

The uncoded area existence flag in this case may be signalled in the PH, for example. A of FIG. 12 illustrates an example of syntax of a picture header in that case. uncoded_area_exist_flag[i] illustrated in A of FIG. 12 is the uncoded area existence flag. In a case where this flag is true (value “1”), it indicates that there is an uncoded area including pixels having no coded data in the i-th subpicture. In a case where this flag is false (value “0”), it indicates that there is no uncoded area in the subpicture.

By referring to such an uncoded area existence flag, the decoding side apparatus can easily grasp whether or not each subpicture can be decoded (whether or not to decode each subpicture). For example, it is possible to correctly set the uncoded area existence flag described above in <Method 1-1-2> for a picture formed by merging a plurality of pictures or subpictures.

Note that this uncoded area existence flag may be signalled in the SPS. B of FIG. 12 illustrates an example of syntax of the SPS in that case. However, in that case, the fact that the uncoded area existence flag is true means that a picture having a pixel having no coded data exists in a part of subpictures included in the CVS. That is, it is not possible to determine whether there is a pixel having no coded data in a subpicture for each picture.

Furthermore, this uncoded area existence flag may be signalled in the SEI. C of FIG. 12 illustrates an example of syntax of the SEI in that case. In that case, the SEI may be signalled for each picture, or the SEI may be signalled for each CVS. Moreover, which one of the two may be explicitly indicated by a flag.

In a case where there is common information in the CVS (that is, in a case where a signalling is performed in the CVS as described above), in a case where an obtained image is encoded and the generated coded data is immediately transmitted as in live distribution or the like, it may be difficult to rewrite the SPS as illustrated in B of FIG. 11. In that case, the uncoded area existence flag is only required to be signalled in the SEI.

<Method 1-2>

For example, as illustrated in the seventh row from the top of the table in FIG. 5, the ineffective area may be made to be a subpicture. Then, as the subpicture RPR information, the subpicture mapping information may be variable in the time direction in the sequence (method 1-2).

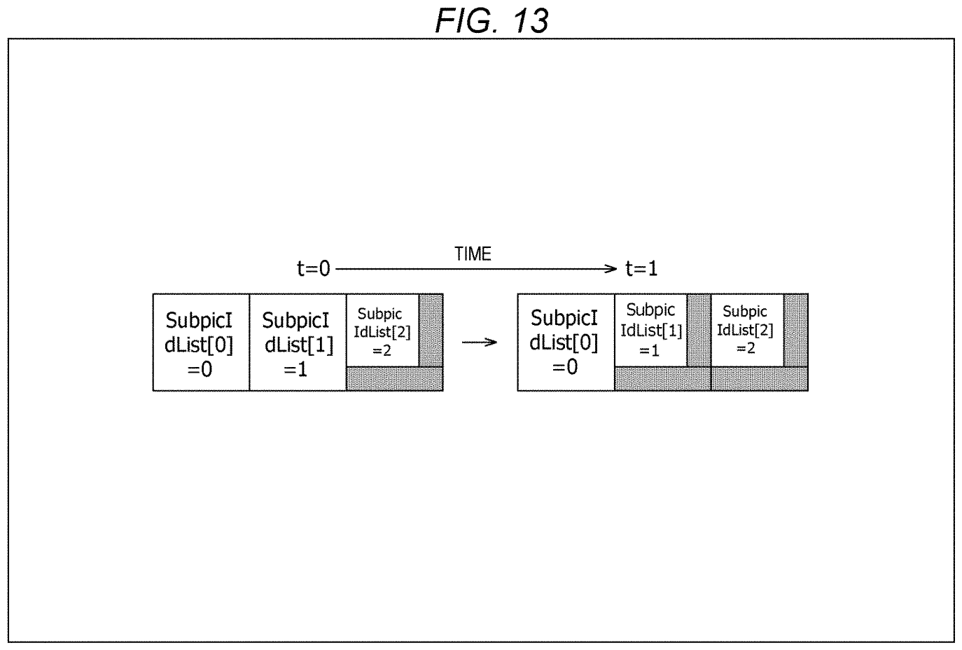

For example, as illustrated in FIG. 13, in a picture at each time point, a subpicture including only an ineffective area having no pixel data, which is illustrated in gray, is newly formed. That is, in this case, the ineffective area and the effective area are assigned to different subpictures.

That is, in this case, as illustrated in FIG. 13, the layout of the subpicture may change in the time direction. That is, in the sequence, the subpicture mapping information is variable in the time direction. Therefore, such information regarding a subpicture variable in the sequence of the subpicture mapping information is signalled in the PPS. The fixed information in the sequence may be signalled in the SPS.

For example, the encoding side apparatus may signal the subpicture reference pixel position information indicating the position of the reference pixel of the subpicture variable in the time direction for each picture. Furthermore, the decoding side apparatus may analyze the subpicture reference pixel position information and decode the coded data on the basis of the analysis result.

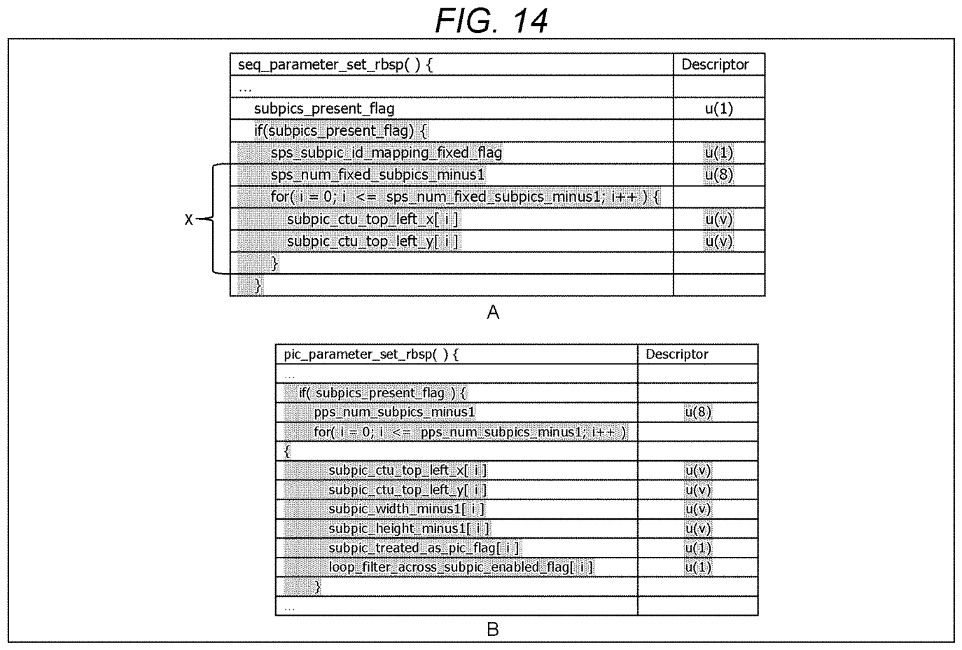

A of FIG. 14 illustrates an example of syntax of the SPS in that case, and B of FIG. 14 illustrates an example of syntax of the PPS. In the SPS, subpicture mapping information for a fixed subpicture having fixed coordinates of a reference pixel (a pixel at an upper left end) is signalled. For example, subpicture reference pixel position information of a fixed subpicture is signalled in the SPS (part X in A of FIG. 14). Furthermore, in the SPS, the subpicture ID fixed flag (sps_subpic_id_mapping_fixed_flag) is signalled. In a case where the subpicture ID fixed flag (sps_subpic_id_mapping_fixed_flag) is true (value “1”), it indicates that the subpicture ID of the fixed subpicture does not change in the CVS. In a case where this flag is false (value “0”), it indicates that the subpicture ID of the fixed subpicture may change.

On the other hand, the information variable in the time direction is signalled in the PPS (B of FIG. 14). For example, subpicture mapping information for a subpicture (also referred to as a variable subpicture) or the like that is not a fixed subpicture is signalled in the PPS. For example, in a case where a subpicture including only the ineffective area is formed as described above, there is a possibility that the number of the subpictures increases or decreases in the time direction or the position of the reference pixel changes due to the resolution control of the subpicture (change in the resolution of the subpicture). Therefore, information regarding such a variable subpicture is signalled in the PPS. In the PPS, existing semantics are the same as the subpicture mapping information.

As a result, a similar effect to that described above in <Method 1-1> can be obtained.

<Method 1-2-1>

For example, as illustrated in the eighth row from the top of the table in FIG. 5, the effective area information may be signalled by the SEI (Method 1-2-1). As a result, a similar effect to that described above in <Method 1-1-1> can be obtained.

<Method 1-2-2>

For example, as illustrated in the ninth row from the top of the table in FIG. 5, an uncoded area existence flag may be signalled for each picture (Method 1-2-2). As a result, a similar effect to that described above in <Method 1-1-2> can be obtained.

<Method 1-2-3>

For example, as illustrated in the tenth row from the top of the table in FIG. 5, as the subpicture RPR information, a no-slice data flag that is flag information indicating that it is a subpicture having no coded data in all pixels may be signalled. This no-slice data flag may be signalled in the PPS, for example (Method 1-2-3).

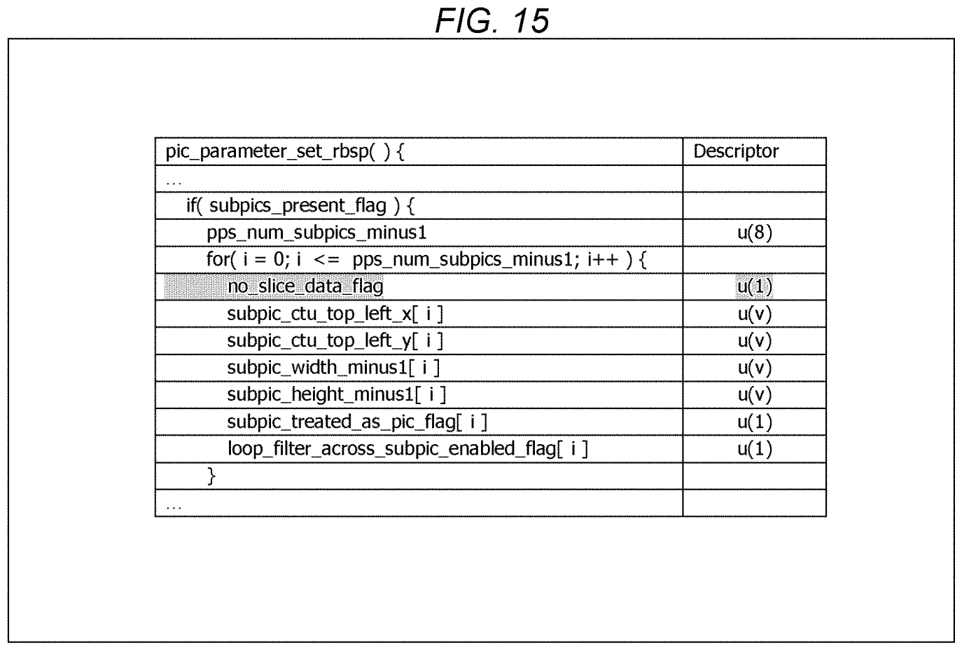

FIG. 15 illustrates an example of syntax of the PPS in that case. In FIG. 15, no)_slice_data_flag is a no-slice data flag, and in a case where this flag is true (value “1”), it indicates that a subpicture corresponding to this flag is a subpicture having no coded data in all pixels. Furthermore, in a case where this flag is false (value “0”), it indicates that the subpicture corresponding to the flag is a subpicture in which coded data exists.

For example, the encoding side apparatus may signal such a no-slice data flag. Furthermore, the decoding side apparatus may analyze the signalled no-slice data flag and decode the coded data on the basis of the analysis result.

As a result, the decoding side apparatus can easily grasp whether or not coded data exists in each subpicture, and can more accurately identify whether or not to decode each subpicture. For example, the decoding side apparatus can easily specify the subpicture having no coded data in all the pixels on the basis of the no-slice data flag, and omit (skip) the decoding processing of the subpicture. As a result, an increase in the load of the decoding processing can be suppressed.

Method 2

For example, as illustrated in the eleventh row from the top of the table in FIG. 5, an RPR-applied subpicture enable flag that is flag information indicating whether a fixed subpicture (that is, a subpicture to which the RPR is applied) is included may be signalled as the subpicture RPR information (Method 2).

For example, the encoding side apparatus signals an RPR-applied subpicture enable flag that is flag information indicating whether a fixed subpicture is included. The encoding side apparatus signals the RPR-applied subpicture enable flag, for example, in the SPS. That is, in this case, the RPR-applied subpicture enable flag indicates whether the fixed subpicture is included in the sequence.

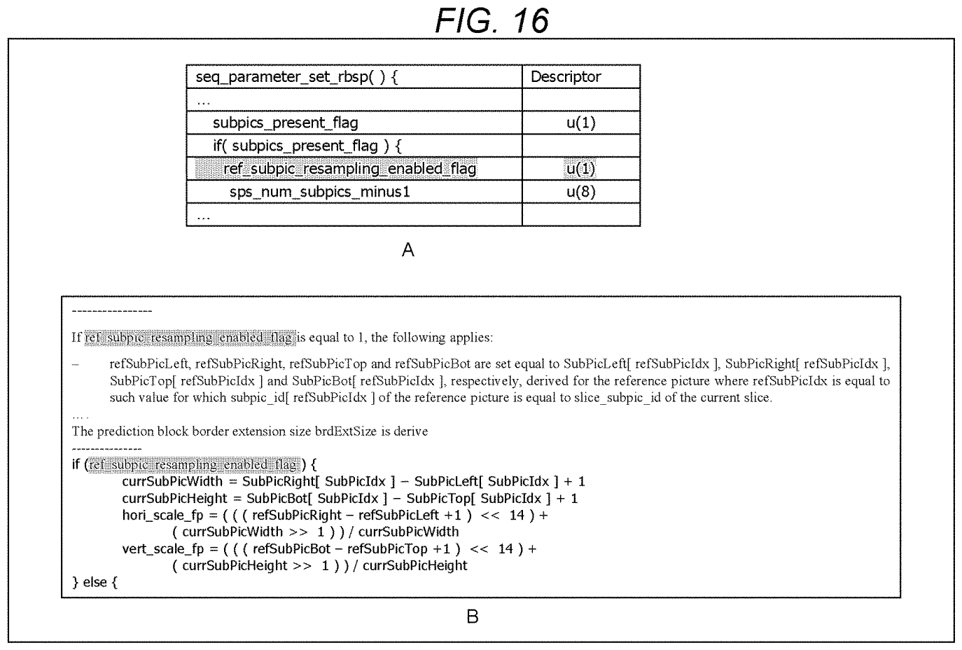

A of FIG. 16 illustrates an example of syntax of the SPS in that case. In the example of FIG. 16, ref_subpic_resampling_enabled_flag is signalled as the above-described RPR-applied subpicture enable flag. In a case where this flag is true (value “1”), it indicates that there may be a subpicture to which the RPR is applied. Furthermore, in a case where this flag is false (value “0”), it indicates that there is no subpicture to which the RPR is applied.

The decoding side apparatus analyzes the RPR-applied subpicture enable flag, and decodes the coded data on the basis of the analysis result. That is, as illustrated in B of FIG. 16, in a case where the RPR-applied subpicture enable flag is true, the decoding side apparatus applies the RPR processing for each subpicture. That is, the decoding side apparatus performs decoding processing for each subpicture. Furthermore, in a case where the RPR-applied subpicture enable flag is false, the decoding side apparatus does not need to apply the RPR processing (the RPR processing can be omitted (skipped)). That is, the decoding side apparatus may perform decoding processing as a picture, or may perform decoding processing for each subpicture.

As a result, the decoding side apparatus can easily determine whether or not the RPR processing is necessary in units of subpictures on the basis of the RPR-applied subpicture enable flag.

Note that the RPR-applied subpicture enable flag may be signalled for each picture. In that case, the

RPR-applied subpicture enable flag may be signalled in the PH.

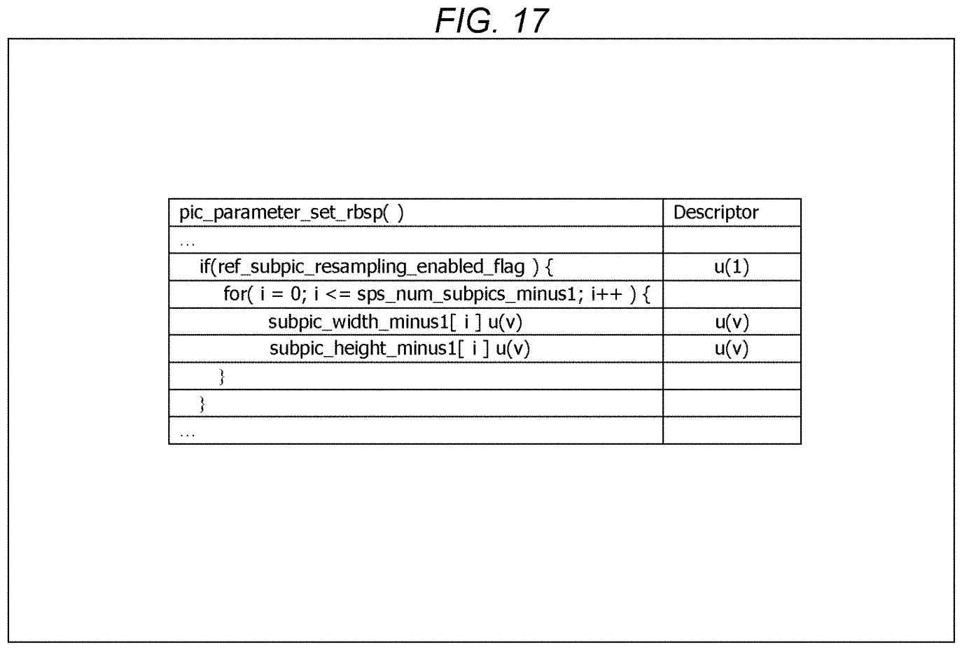

Furthermore, in a case where the RPR-applied subpicture enable flag is false, the signalling of the subpicture RPR information in the PPS may be omitted (skipped). For example, in a case of the example in B of FIG. 7, it has been described that subpic_width_minus1 and subpic_height_minus1 are signalled in the PPS, but as illustrated in FIG. 17, in a case where the RPR-applied subpicture enable flag is false, signalling of these pieces of information may be skipped.

As a result, the signalling of the PPS can be skipped in a case where resampling is not used for each subpicture, and an increase in the encoding amount can be suppressed.

<Method 2-1>

For example, as illustrated at the bottom of the table in FIG. 5, whether a fixed subpicture is included may be indicated for each subpicture. That is, the RPR-applied subpicture enable flag may be signalled for each subpicture (Method 2-1).

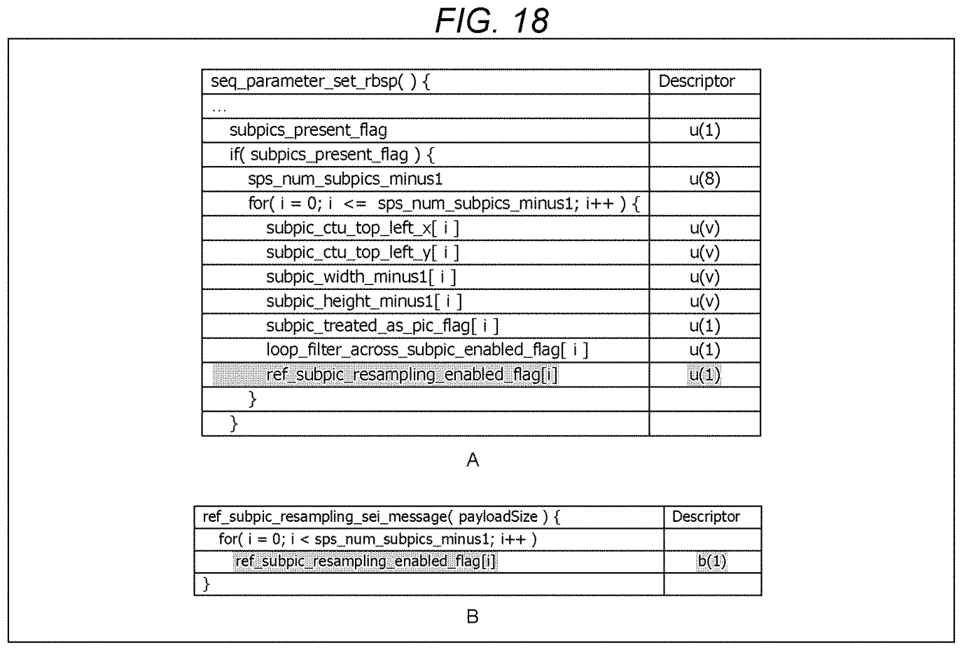

FIG. 18 illustrates an example of syntax of the SPS in that case. In the example of FIG. 18, ref_subpic_resampling_enabled_flag[i] is signalled for each subpicture as the RPR-applied subpicture enable flag. In a case where ref_subpic_resampling_enabled_flag[i] is true (value “1”), it indicates that the RPR is applied to the subpicture (that is, the subpicture is a fixed subpicture). Furthermore, in a case where ref_subpic_resampling_enabled_flag[i] is false (value “0”), it indicates that the RPR is not applied to the subpicture (that is, the subpicture is not a fixed subpicture).

Note that the RPR-applied subpicture enable flag in this case also may be signalled for each picture. In that case, the RPR-applied subpicture enable flag may be signalled in the PH.

Furthermore, the RPR-applied subpicture enable flag in this case may be signalled in the SEI. An example of syntax of the SEI in that case is illustrated in B of FIG. 18. In a case where there is common information in the CVS (that is, in a case where a signalling is performed in the CVS as described above), in a case where an obtained image is encoded and the generated coded data is immediately transmitted as in live distribution or the like, it may be difficult to rewrite the SPS as illustrated in A of FIG. 18. In that case, the RPR-applied subpicture enable flag is only required to be signalled in the PH or SEI.

### 2. First Embodiment

<Image Coding Apparatus>

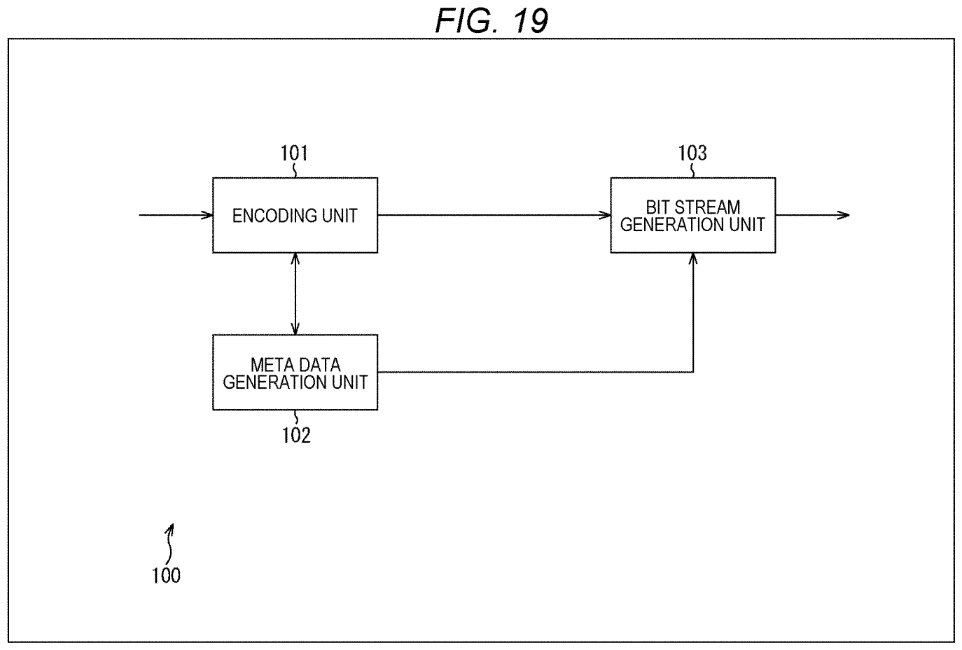

Various methods (Method 1, Method 1-1, Method 1-1-1, Method 1-1-2, Method 1-1-2-1, Method 1-2, Method 1-2-1, Method 1-2-2, Method 1-2-3, Method 2, Method 2-1, and modifications and applications of each method, and the like) of the present technology described in <1. Resolution control 1 of image of subpicture> can be applied to any apparatus. For example, the methods can be applied to an encoding side apparatus. FIG. 19 is a block diagram illustrating an example of a configuration of an image coding apparatus that is a mode of an image processing apparatus to which the present technology is applied. An image coding apparatus 100 illustrated in FIG. 19 is an example of an encoding side apparatus, and is an apparatus that encodes an image. The image coding apparatus 100 performs encoding by applying an encoding method conforming to VVC described in Non-Patent Document 1, for example.

Then, the image coding apparatus 100 performs encoding by applying the various methods of the present technology described with reference to FIG. 5 and the like. That is, the image coding apparatus 100 performs the RPR processing in the subpicture in which the position of the reference pixel is fixed in the time direction.

Note that, in FIG. 19, main processing units, data flows, and the like are illustrated, and those illustrated in FIG. 19 are not necessarily all. That is, in the image coding apparatus 100, there may be a processing unit not illustrated as a block in FIG. 19, or there may be processing or a data flow not illustrated as an arrow or the like in FIG. 19.

As illustrated in FIG. 19, the image coding apparatus 100 includes an encoding unit 101, a metadata generation unit 102, and a bit stream generation unit 103.

The encoding unit 101 performs processing related to image encoding. For example, the encoding unit 101 acquires pictures of a moving image input to the image coding apparatus 100. The encoding unit 101 encodes an acquired picture by applying an encoding scheme conforming to the VVC described in Non-Patent Document 1, for example. At that time, the encoding unit 101 applies the various methods of the present technology described with reference to FIG. 5 and the like, and performs the RPR processing in the subpicture in which the position of the reference pixel is fixed in the time direction. That is, the encoding unit 101 encodes the image of the fixed subpicture with a resolution variable in the time direction to generate coded data. Note that the fixed subpicture is a subpicture in which the position of the reference pixel is fixed in the time direction. A subpicture is a partial area obtained by dividing a picture.

The encoding unit 101 supplies coded data generated by encoding an image to the bit stream generation unit 103. Furthermore, the encoding unit 101 can appropriately transmit and receive arbitrary information to and from the metadata generation unit 102 at the time of encoding.

The metadata generation unit 102 performs processing related to generation of metadata. For example, the metadata generation unit 102 transmits and receives arbitrary information to and from the encoding unit 101, and generates metadata. For example, the metadata generation unit 102 can generate subpicture RPR information and subpicture rendering information as metadata.

The subpicture RPR information and the subpicture rendering information may include various types of information described in <1. Resolution control 1 of image of subpicture>. For example, the metadata generation unit 102 can generate information such as subpicture resolution information, subpicture reference pixel position information, subpicture maximum resolution information, subpicture ID mapping information, a subpicture ID fixed flag, a non-subpicture area existence flag, effective area information, an uncoded area existence flag, a no-slice data flag, and an RPR-applied subpicture enable flag. Of course, the information generated by the metadata generation unit 102 is arbitrary, and is not limited to these examples. For example, the metadata generation unit 102 can also generate metadata described in Non-Patent Document 2, such as subpicture mapping information. The metadata generation unit 102 supplies the generated metadata to the bit stream generation unit 103.

The bit stream generation unit 103 performs processing related to generation of a bit stream. For example, the bit stream generation unit 103 acquires the coded data supplied from the encoding unit 101. Furthermore, the bit stream generation unit 103 acquires the metadata supplied from the metadata generation unit 102. The bit stream generation unit 103 generates a bit stream including the acquired coded data and metadata. The bit stream generation unit 103 outputs the bit stream to the outside of the image coding apparatus 100.

The bit stream is supplied to the decoding side apparatus via, for example, a storage medium or a communication medium. That is, various types of information described in <1. Resolution control 1 of image of subpicture> are signalled.

Therefore, the decoding side apparatus can perform decoding processing on the basis of the signalled information. As a result, an effect similar to that described in <1. Resolution control 1 of image of subpicture> can be obtained.

For example, the decoding side apparatus can more easily perform the RPR processing for each subpicture. Furthermore, the decoding side apparatus can more easily render the image of the decoded subpicture on the basis of the signalled information.

Furthermore, since the image coding apparatus 100 performs the RPR processing in the subpicture in which the position of the reference pixel is fixed in the time direction, the position of the subpicture to which the RPR processing is applied does not change significantly. Therefore, it is possible to suppress an increase in load of encoding processing and decoding processing for performing the RPR processing for each subpicture.

<Flow of Encoding Processing>

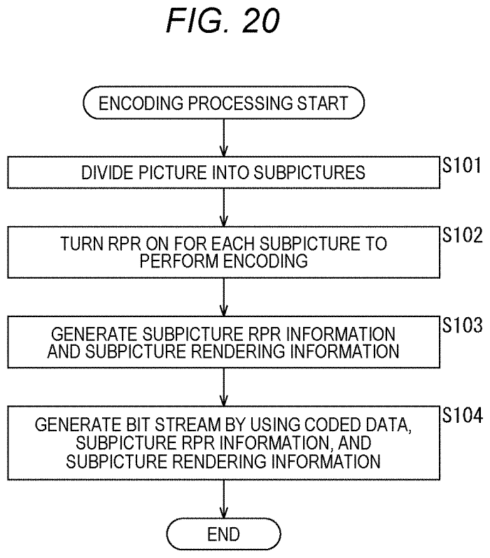

Next, an example of a flow of encoding processing performed by the image coding apparatus 100 will be described with reference to a flowchart in FIG. 20.

When the encoding processing is started, in step S101, the encoding unit 101 of the image coding apparatus 100 divides the picture into subpictures.

In step S102, the encoding unit 101 turns on the RPR for each subpicture and performs encoding. At that time, the encoding unit 101 applies the present technology described in <1. Resolution control 1 of image of subpicture>, and performs the RPR processing in the subpicture in which the position of the reference pixel is fixed in the time direction.

In step S103, the metadata generation unit 102 generates the subpicture RPR information and the subpicture rendering information. At that time, the metadata generation unit 102 performs processing by applying the present technology. That is, as described above, the metadata generation unit 102 can generate various types of information described in <1. Resolution control 1 of image of subpicture>.

In step S104, the bit stream generation unit 103 generates a bit stream by using the coded data generated in step S102 and the subpicture RPR information and the subpicture rendering information generated in step S103. That is, the bit stream generation unit 103 generates a bit stream including these pieces of information.

When the bit stream is generated, the encoding processing ends.

By performing the encoding processing as described above, various types of information described in <1. Resolution control 1 of image of subpicture> are signalled.

Therefore, the decoding side apparatus can perform decoding processing on the basis of the signalled information. As a result, an effect similar to that described in <1. Resolution control 1 of image of subpicture> can be obtained.

For example, the decoding side apparatus can more easily perform the RPR processing for each subpicture. Furthermore, the decoding side apparatus can more easily render the image of the decoded subpicture on the basis of the signalled information.

Furthermore, since the RPR processing is performed in the subpicture in which the position of the reference pixel is fixed in the time direction in step S102, the position of the subpicture to which the RPR processing is applied does not change significantly. Therefore, it is possible to suppress an increase in load of encoding processing and decoding processing for performing the RPR processing for each subpicture.

### <3. Second Embodiment

<Image Decoding Apparatus>

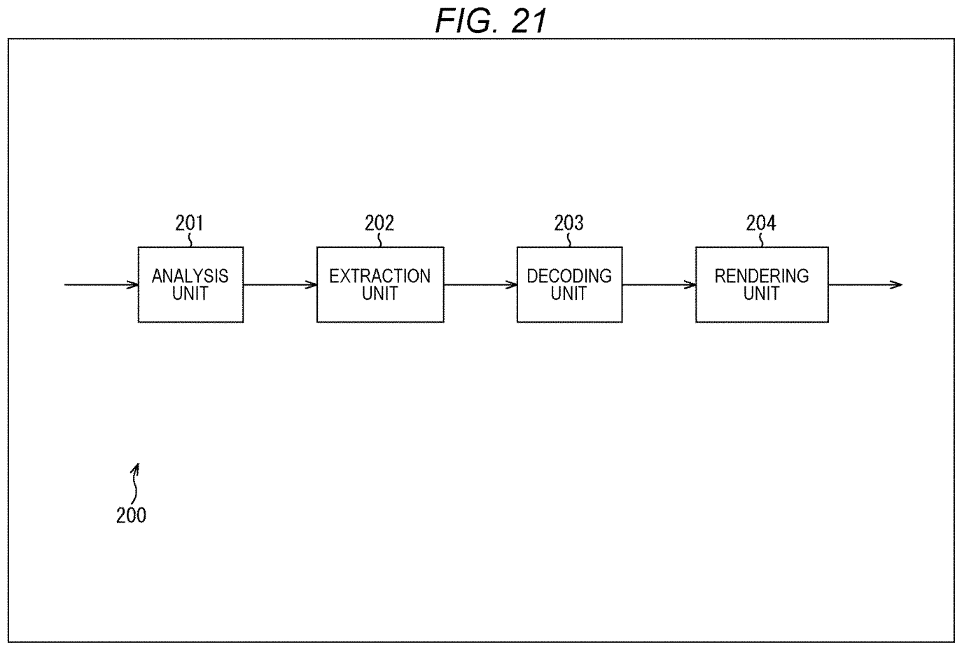

The present technology can also be applied to a decoding side apparatus. FIG. 21 is a block diagram illustrating an example of a configuration of an image decoding apparatus that is a mode of an image processing apparatus to which the present technology is applied. An image decoding apparatus 200 illustrated in FIG. 21 is an example of a decoding side apparatus, and is an apparatus that decodes coded data and generates an image. The image decoding apparatus 200 performs decoding by applying a decoding method conforming to VVC described in Non-Patent Document 1, for example.

Then, the image decoding apparatus 200 performs decoding by applying the various methods of the present technology described with reference to FIG. 5 and the like. That is, the image decoding apparatus 200 performs the RPR processing in the subpicture in which the position of the reference pixel is fixed in the time direction. For example, the image decoding apparatus 200 decodes a bit stream generated by the image coding apparatus 100.

Note that, in FIG. 21, main processing units, data flows, and the like are illustrated, and those illustrated in FIG. 21 are not necessarily all. That is, in the image decoding apparatus 200, there may be a processing unit not illustrated as a block in FIG. 21, or there may be processing or a data flow not illustrated as an arrow or the like in FIG. 21.

As illustrated in FIG. 21, the image decoding apparatus 200 includes an analysis unit 201, an extraction unit 202, a decoding unit 203, and a rendering unit 204.

The analysis unit 201 performs processing related to analysis of metadata. For example, the analysis unit 201 acquires a bit stream input to the image decoding apparatus 200. The analysis unit 201 analyzes the metadata included in the bit stream. For example, the analysis unit 201 can analyze the subpicture RPR information and the subpicture rendering information as metadata by applying the present technology described in <1. Resolution control 1 of image of subpicture>.

The subpicture RPR information and the subpicture rendering information may include various types of information described in <1. Resolution control 1 of image of subpicture>. For example, the analysis unit 201 can analyze information such as subpicture resolution information, subpicture reference pixel position information, subpicture maximum resolution information, subpicture ID mapping information, a subpicture ID fixed flag, a non-subpicture area existence flag, effective area information, an uncoded area existence flag, a no-slice data flag, and an RPR-applied subpicture enable flag. Of course, the information analyzed by the analysis unit 201 is arbitrary, and is not limited to these examples. For example, the analysis unit 201 can also analyze metadata described in Non-Patent Document 2, such as subpicture mapping information. The analysis unit 201 supplies the analysis result of the metadata and the bit stream to the extraction unit 202.

The extraction unit 202 extracts desired information from the bit stream supplied from the analysis unit 201 on the basis of the analysis result supplied from the analysis unit 201. For example, the extraction unit 202 extracts coded data of an image, subpicture RPR information, subpicture rendering information, and the like from the bit stream. The subpicture RPR information and the subpicture rendering information may include various types of information analyzed by the analysis unit 201. The extraction unit 202 supplies information or the like extracted from the bit stream to the decoding unit 203.

The decoding unit 203 performs processing related to decoding. For example, the decoding unit 203 acquires the information supplied from the extraction unit 202. The decoding unit 203 decodes the acquired coded data on the basis of the acquired metadata to generate a picture. At that time, the decoding unit 203 can appropriately apply the various methods of the present technology described with reference to FIG. 5 and the like, and perform the RPR processing in the subpicture in which the position of the reference pixel is fixed in the time direction. That is, the decoding unit 203 generates an image of each subpicture on the basis of the subpicture RPR information that can include various types of information described in <1. Resolution control 1 of image of subpicture>. The decoding unit 203 supplies the generated picture (image of each subpicture) to the rendering unit 204. Furthermore, the decoding unit 203 can supply the subpicture rendering information to the rendering unit 204.

The rendering unit 204 performs processing related to rendering. For example, the rendering unit 204 acquires the picture and the subpicture rendering information supplied from the decoding unit 203. The rendering unit 204 renders a desired subpicture in the picture on the basis of the subpicture rendering information, and generates a display image. That is, the rendering unit 204 performs rendering on the basis of the subpicture rendering information that can include various types of information described in <1. Resolution control 1 of image of subpicture>. The rendering unit 204 outputs the generated display image to the outside of the image decoding apparatus 200. The display image is supplied to and displayed on an image display device (not illustrated) via an arbitrary storage medium, communication medium, or the like.

As described above, the image decoding apparatus 200 analyzes various types of information described in <1. Resolution control 1 of image of subpicture> signalled from the encoding side apparatus, and performs decoding processing on the basis of the information. That is, the image decoding apparatus 200 can apply the present technology described in <1. Resolution control 1 of image of subpicture>, and perform the RPR processing in the subpicture in which the position of the reference pixel is fixed in the time direction. As a result, an effect similar to that described in <1. Resolution control 1 of image of subpicture> can be obtained.

For example, the image decoding apparatus 200 can more easily perform the RPR processing for each subpicture. Furthermore, the image decoding apparatus 200 can more easily render the image of the decoded subpicture on the basis of the signalled information.

Furthermore, since the encoding side apparatus performs the RPR processing in the subpicture in which the position of the reference pixel is fixed in the time direction, the position of the subpicture to which the RPR processing is applied does not change significantly. Therefore, the image decoding apparatus 200 can suppress an increase in load of decoding processing for performing the RPR processing for each subpicture.

<Flow of Decoding Processing>

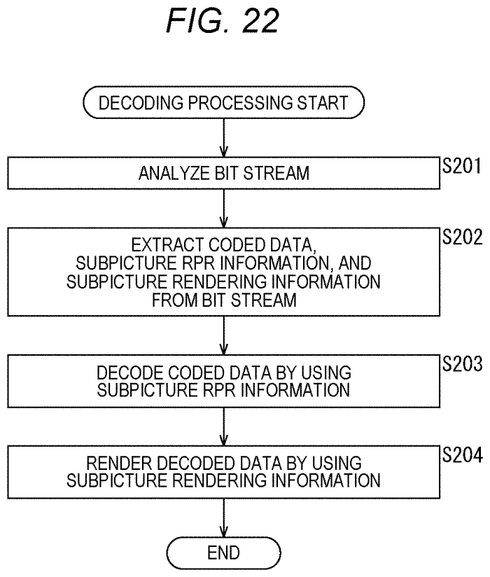

Next, an example of a flow of decoding processing performed by the image decoding apparatus 200 will be described with reference to a flowchart in FIG. 22.

When the decoding process is started, in step S201, the analysis unit 201 of the image decoding apparatus 200 analyzes the metadata included in the bit stream. At that time, the analysis unit 201 applies the present technology described in <1. Resolution control 1 of image of subpicture>, and analyzes various types of information described in <1. Resolution control 1 of image of subpicture> included in the metadata.

In step S202, the extraction unit 202 extracts coded data, subpicture RPR information, and subpicture rendering information from the bit stream on the basis of the analysis result of step S201. The subpicture RPR information may include various types of information described in <1. Resolution control 1 of image of subpicture>. Furthermore, the subpicture rendering information may include various types of information described in <1. Resolution control 1 of image of subpicture>.

In step S203, the decoding unit 203 decodes the coded data extracted from the bit stream in step S202 using the subpicture RPR information extracted from the bit stream in step S202, and generates a picture (each subpicture included in the picture). At that time, the decoding unit 203 applies the present technology described in <1. Resolution control 1 of image of subpicture>. That is, the decoding unit 203 performs the RPR processing in the subpicture in which the position of the reference pixel is fixed in the time direction on the basis of various types of information described in <1. Resolution control 1 of image of subpicture>.

In step S204, the rendering unit 204 uses the subpicture rendering information extracted from the bit stream in step S202 to render decoded data of the picture (or subpicture) generated in step S203, and generates a display image. At that time, the rendering unit 204 applies the present technology described in <1. Resolution control 1 of image of subpicture>. That is, the rendering unit 204 performs rendering on the basis of the various types of information described in <1. Resolution control 1 of image of subpicture>.

When the display image is generated, the decoding processing ends.

By performing the decoding processing as described above, decoding and rendering are performed on the basis of the signalled various types of information described in <1. Resolution control 1 of image of subpicture>. Accordingly, in the image decoding apparatus 200, an effect similar to that described in <1. Resolution control 1 of image of subpicture> can be obtained.

For example, the image decoding apparatus 200 can more easily perform the RPR processing for each subpicture. Furthermore, the image decoding apparatus 200 can more easily render the image of the decoded subpicture on the basis of the signalled information.

Furthermore, since the RPR processing is performed in the subpicture in which the position of the reference pixel is fixed in the time direction in the encoding side apparatus, the position of the subpicture to which the RPR processing is applied does not change significantly. Therefore, the image decoding apparatus 200 can suppress an increase in load of decoding processing for performing the RPR processing for each subpicture.

### <4. Resolution control 2 of image of subpicture>

<Method 3>

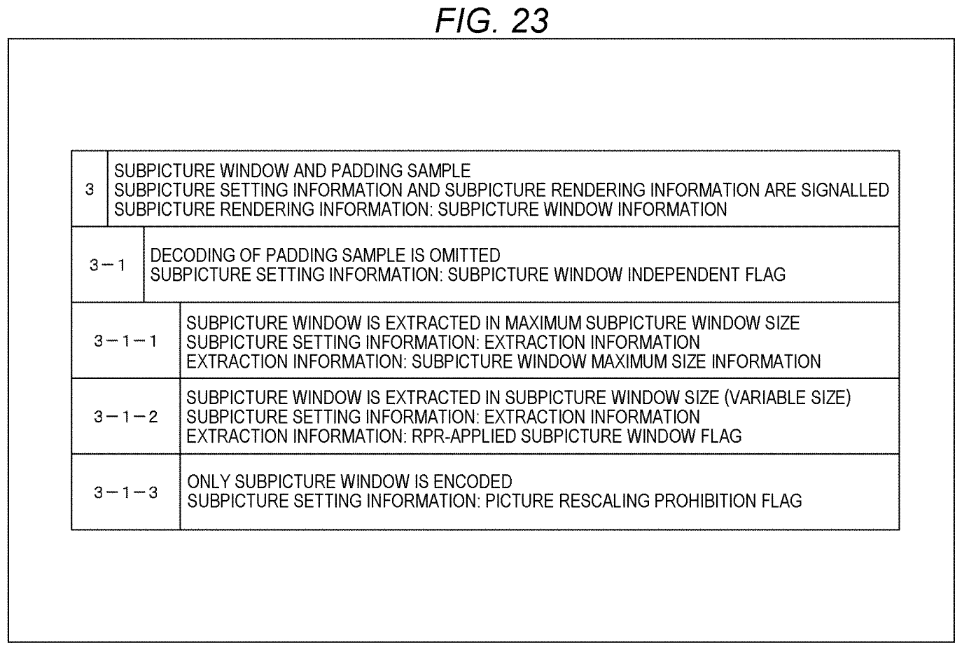

In <1. Resolution control 1 of image of subpicture>, it has been described that the size of the subpicture is changed according to the resolution control of the image of the subpicture. However, as illustrated in the uppermost row of the table in FIG. 23, the subpicture may include an image area (subpicture window) having a resolution lower than the size of the subpicture and a padding sample that is a non-display area other than the image area (Method 3).

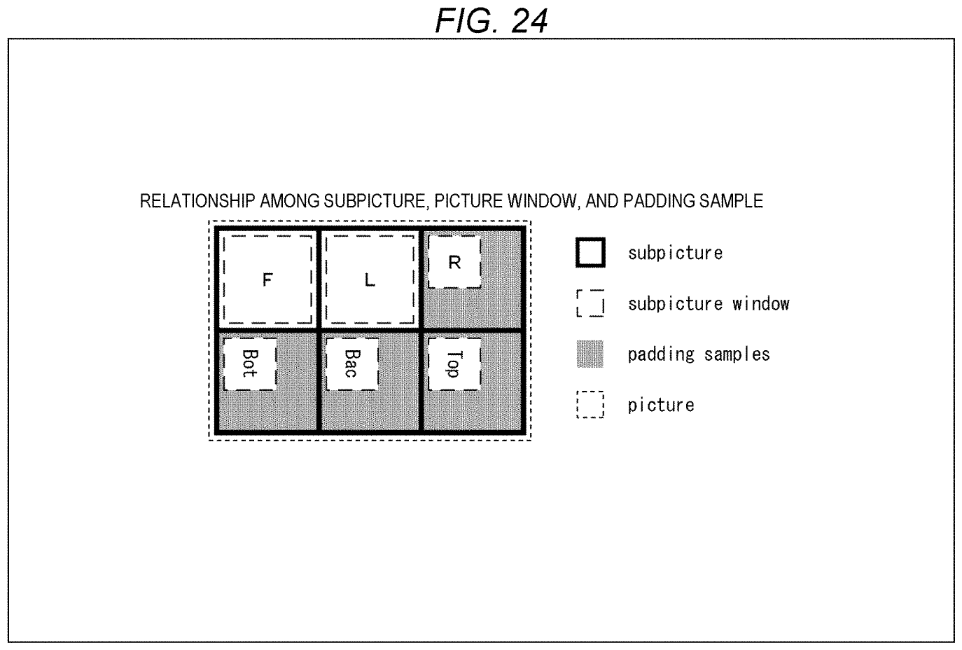

That is, as illustrated in FIG. 24, even in a case where the resolution of the image of the subpicture is reduced to be smaller than the size of the subpicture, the size of the subpicture is not adjusted to the resolution of the image as in the example of FIG. 6. For example, the subpicture mapping information is fixed in the CVS so as not to change in the time direction. That is, the position and size of each subpicture are fixed. Then, an area of the image of the subsample (an area surrounded by a dotted line in FIG. 24) is managed as a subpicture window (display area).

As described above, when the resolution of the image of the subpicture is made smaller than the size of the subpicture, as illustrated in FIG. 24, a non-display area (an area indicated by gray in FIG. 24) other than the subpicture window is generated in the subpicture. In that case, a padding sample is inserted into the pixel in the non-display area. The padding sample is optional. For example, the same color such as black, which improves the compression efficiency, may be used.

For example, the subpicture mapping information is signalled in the SPS similarly to the method described in Non-Patent Document 2. Then, separately, as the subpicture rendering information, subpicture window information that is information regarding the subpicture window is signalled for each picture. Furthermore, subpicture setting information that is information regarding setting of a subpicture is signalled.

For example, the encoding side apparatus signals subpicture window information that is information regarding a subpicture window that is an area of an image with a resolution of a fixed subpicture. The decoding side apparatus analyzes the subpicture window information, renders an image of a fixed subpicture on the basis of the analyzed subpicture window information, and generates a display image.

As a result, the resolution of the subpicture can be changed in the CVS in the form of a subpicture window. Therefore, it is possible to increase the compression efficiency as compared with the case where the resolution of the subpicture is not changed.

The subpicture window information may be signalled in the PPS. Furthermore, the content of the subpicture window information may be any information as long as it relates to the subpicture window. For example, an in-picture subpicture window existence flag that is flag information indicating whether or not a subpicture in which the subpicture window exists can exist in the picture may be included in the subpicture window information. Furthermore, a subpicture window existence flag that is flag information signalled for each subpicture and indicating whether or not a subpicture window can exist in the subpicture may be included in the subpicture window information. Moreover, subpicture window size information that is information regarding the size of the subpicture window may be included in the subpicture window information. For example, subpicture window width information that is information indicating the width of the subpicture window may be included in the subpicture window size information. Furthermore, subpicture window height information that is information indicating the height of the subpicture window may be included in the subpicture window size information.

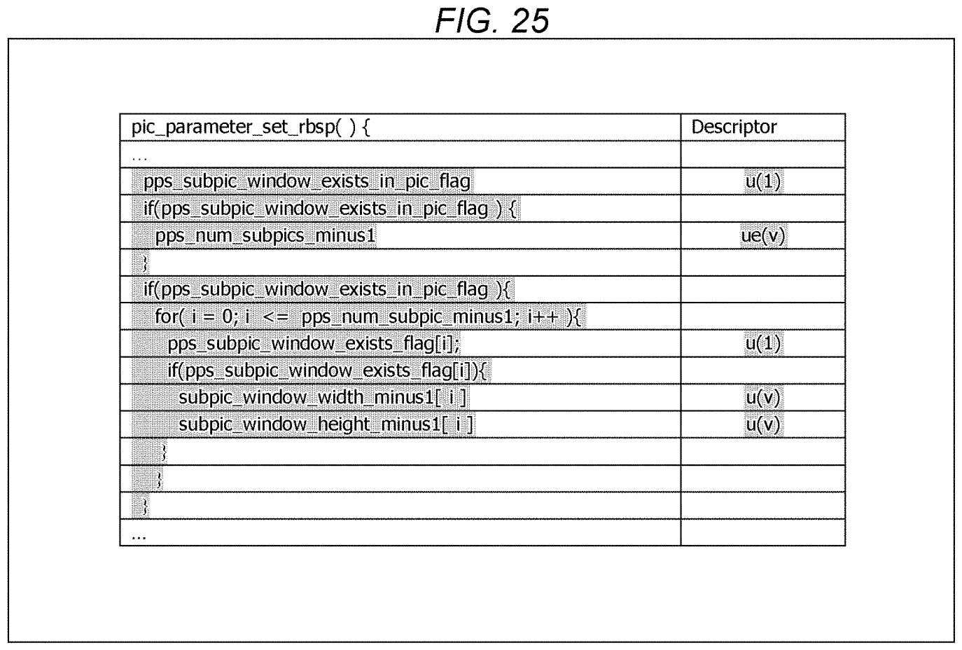

FIG. 25 illustrates an example of syntax of the PPS signalling the subpicture window information. In the example of FIG. 25, pps_subpic_window_exists_in_pic_flag is signalled as the in-picture subpicture window existence flag. In a case where this flag is true (value “1”), it indicates that there may be a subpicture in which a subpicture window exists in the picture. Furthermore, in a case where this flag is false (value “0”), it indicates that there is no subpicture in which a subpicture window exists in the picture.

Furthermore, pps_subpic_window_exists_flag[i] is signalled as the subpicture window existence flag. In a case where this flag is true (value “1”), it indicates that a subpicture window may exist in the i-th subpicture. Furthermore, in a case where this flag is false (value “0”), it indicates that there is no subpicture window in the i-th subpicture.

Moreover, subpic_window_width_minus1[i] is signalled as the subpicture window width information. This information indicates the width of the i-th subpicture in units of CTU. Furthermore, subpic_window_height_minus1[i] is signalled as the subpicture window height information. This information indicates the height of the i-th subpicture in units of CTU.

As described above, a variety of subpicture rendering information regarding the subpicture window can be signalled.

Note that the subpicture window size information may indicate the width and height of the subpicture window in sample units (may be indicated in any unit other than CTU units). This makes it possible to change the resolution without depending on the CTU unit.

Furthermore, the position of the reference pixel of the subpicture window may not coincide with the position of the reference pixel of the subpicture storing the subpicture window. In that case, both the reference pixel position information of the subpicture window and the subpicture reference pixel position information are only required to be signalled.

Moreover, the above-described subpicture window information may be signalled in the SEI.

<Method 3-1>

As illustrated in the second row from the top of the table in FIG. 23, decoding processing of padding samples unnecessary for display may be omitted (skipped) (Method 3-1). For example, in encoding, a boundary of a subpicture window and a boundary of a slice are matched, and only the subpicture window can be decoded. The padding sample is set to black. Then, only the subpicture window is decoded, and flag information indicating that decoding is not necessary for other areas is signalled to the SPS. In the decoding, the padding sample is processed as black without being decoded, and only the subpicture window is decoded.

For example, the encoding side apparatus signals, as the subpicture setting information, a subpicture window decoding control flag that is flag information regarding decoding control of the coded data of the subpicture window. The decoding side apparatus analyzes the subpicture window decoding control flag, and decodes the coded data on the basis of the analysis result.

As a result, unnecessary decoding processing, that is, decoding of the padding sample can be omitted (skipped). Accordingly, an increase in the load of the decoding processing can be suppressed.

The subpicture setting information is arbitrary as long as it is information regarding setting of a subpicture. For example, a subpicture window decoding control flag that is flag information related to decoding control of the coded data of the subpicture window may be included in the subpicture setting information.

The subpicture window decoding control flag is arbitrary as long as it is flag information regarding decoding control of the coded data of the subpicture window. For example, an in-picture subpicture window existence flag that is flag information indicating whether or not a subpicture window can exist in a picture may be included in the subpicture window decoding control flag. Furthermore, a subpicture window independent flag that is flag information indicating whether or not the subpicture window is independent may be included in the subpicture window decoding control flag. Moreover, a subpicture window existence flag that is flag information indicating whether or not a subpicture window exists in the i-th subpicture may be included in the subpicture window decoding control flag. Furthermore, a subpicture window reference control flag that is flag information regarding control of the reference relationship of the subpicture window may be included in the subpicture window decoding control flag. Moreover, a subpicture window loop filter control flag that is flag information regarding control of the loop filter of the subpicture window may be included in the subpicture window decoding control flag.

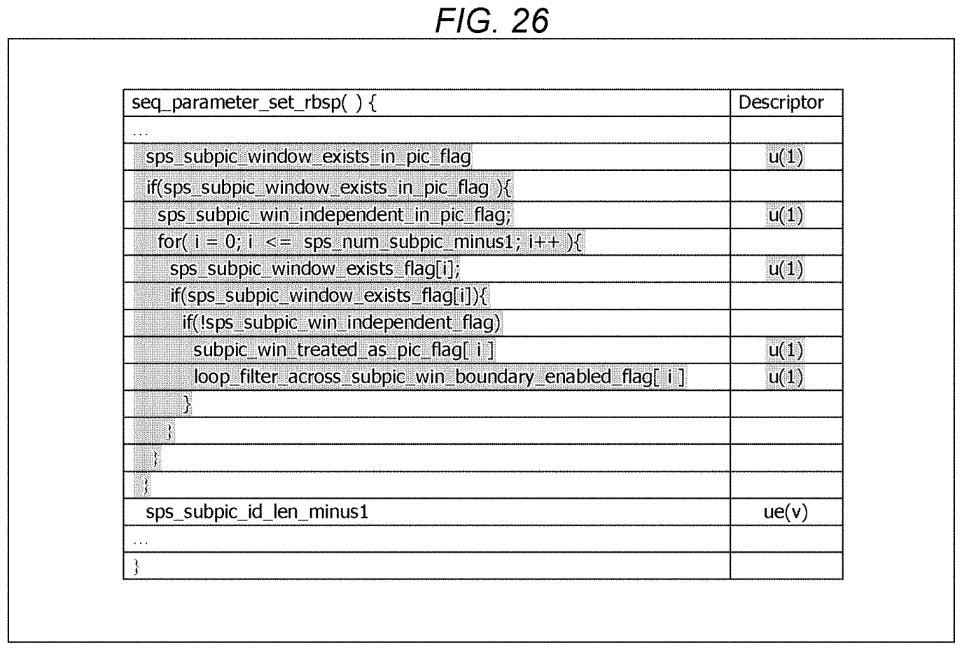

The subpicture window decoding control flag may be signalled in the SPS, for example. FIG. 26 is a diagram illustrating an example of syntax of the SPS in that case. In the example of FIG. 26, sps_subpic_window_exists_in_pic_flag is signalled as the in-picture subpicture window existence flag. In a case where this flag is true (value “1”), it indicates that a subpicture window may exist in the sequence. Furthermore, in a case where this flag is false (value “0”), it indicates that there is no subpicture window in the sequence. Accordingly, the decoding side apparatus may skip, on the basis of this flag, the RPR processing in the subpicture in which the position of the reference pixel is fixed in the time direction with respect to the sequence having no subpicture window. Accordingly, an increase in the load of the decoding processing can be suppressed.

Furthermore, sps_subpic_win_independent_in_pic_flag is signalled as the subpicture window independent flag. In a case where this flag is true (value “1”), it indicates that the subpicture window is independent.

That is, the subpicture window can be handled equivalent to a picture, and the loop filter is not applied at the boundary of the subpicture window. Furthermore, in a case where this flag is false (value “0”), it indicates that the subpicture window may not be independent.

Moreover, sps_subpic_window_exists_flag[i] is signalled as the subpicture window existence flag. In a case where this flag is true (value “1”), it indicates that a subpicture window exists in the i-th subpicture. Furthermore, in a case where this flag is false (value “0”), it indicates that there is no subpicture window in the i-th subpicture. The decoding side apparatus can skip the RPR processing on the subpicture having no subpicture window on the basis of the flag information. Accordingly, an increase in the load of the decoding processing can be suppressed.

Furthermore, subpic_win_treated_as_pic_flag[i] is signalled as the subpicture window reference control flag. In a case where this flag is true (value “1”), it indicates that the subpicture can be handled equivalent to a picture. For example, inter prediction beyond the boundary of the reference subpicture window is prohibited. Furthermore, inter prediction and intra prediction beyond the boundary of the subpicture window are prohibited. Furthermore, in a case where this flag is false (value “0”), it indicates that the subpicture window alone cannot be decoded.

Moreover, oop_filter_across_subpic_win_boundary_enabled_flag[i] is signalled as the subpicture window loop filter control flag. In a case where this flag is true (value “1”), it indicates that a loop filter is applied at the boundary of the subpicture window. Furthermore, in a case where this flag is false (value “0”), it indicates that the loop filter is not applied at the boundary of the subpicture window.

For example, in a case where the subpicture window decoding control flag as described above satisfies one of the following two conditions, only the subpicture window can be decoded in the i-th subpicture.

1. sps_subpic_win_independent_in_pic_flag=0

2. subpic_win_treated_as_pic_flag [i]=1 and loop_filter_across_subpic_win_boundary_enabled_flag [i]=0

As described above, the decoding side apparatus can skip unnecessary processing by controlling the decoding processing on the basis of the subpicture window decoding control flag. Accordingly, an increase in the load of the decoding processing can be suppressed.

Note that, in the SPS, flag information indicating whether or not a decoding unnecessary slice exists may be signalled, and flag information indicating whether or not decoding is unnecessary for each slice may be signalled in a slice header. Furthermore, information specifying the color of the padding sample may be signalled in the SPS.

<Method 3-1-1>

As illustrated in the third row from the top of the table in FIG. 23, in a case where a subpicture is extracted into another bit stream, the subpicture may be extracted with the largest subpicture window in the CVS (Method 3-1-1). That is, the subpicture in the CVS may be encoded so as to enable such extraction. Then, the resolution information of the maximum subpicture window may be signalled in the SPS. Then, the decoding side apparatus may extract only the slice data included in the maximum subpicture window.

For example, the encoding side apparatus signals subpicture window maximum size information that is information indicating the maximum size of the subpicture window. The decoding side apparatus analyzes the subpicture window maximum size information, and decodes the coded data on the basis of the analysis result.

The subpicture setting information is arbitrary as long as it is information regarding setting of a subpicture. For example, the subpicture setting information may include extraction information that is information regarding extraction of a subpicture.

The extraction information is arbitrary as long as it is information regarding extraction of a subpicture. For example, the extraction information may include the in-picture subpicture window existence flag, the subpicture window existence flag, and the subpicture window maximum size information that is information indicating the maximum size of the subpicture window in the CVS. Note that the in-picture subpicture window existence flag and the subpicture window existence flag are information as described in <Method 3-1>. The subpicture window maximum size information may include subpicture window maximum width information that is information indicating the maximum width of the subpicture window in the CVS, and subpicture window maximum height information that is information indicating the maximum height of the subpicture window in the CVS.

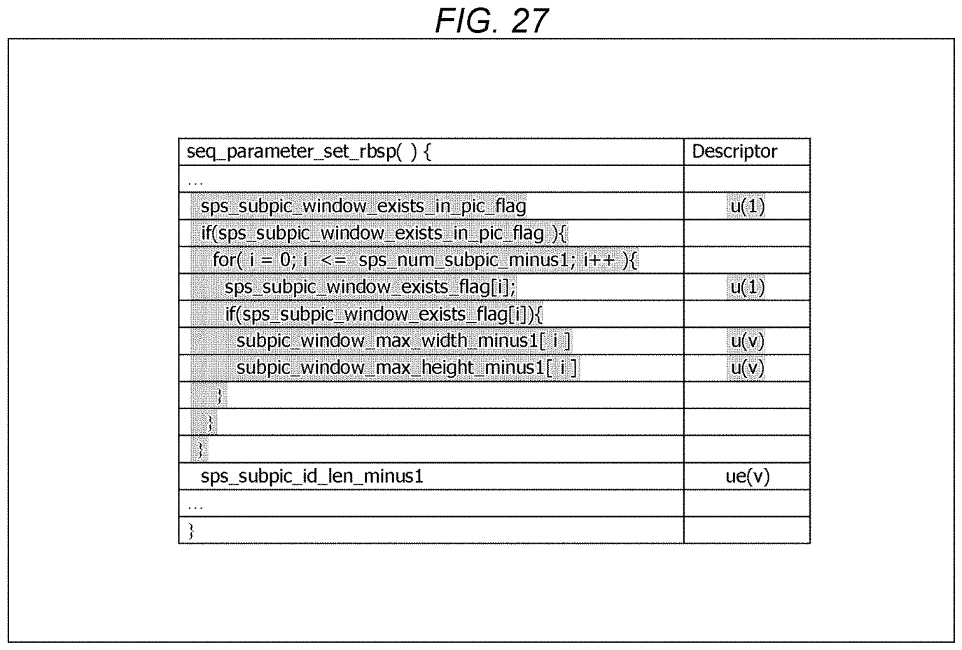

The extraction information may be signalled in the SPS, for example. FIG. 27 is a diagram illustrating an example of syntax of the SPS in that case. In the example of FIG. 27, sps_subpic_window_exists_in_pic_flag is signalled as the in-picture subpicture window existence flag. Furthermore, sps_subpic_window_exists_flag[i] is signalled as the subpicture window existence flag. These flags are as described in <Method 3-1>.

Moreover, subpic_window_max_width_minus1 [i] is signalled as the subpicture window maximum width information. This information is information indicating the maximum width of the subpicture window of the i-th subpicture in units of CTUs. Furthermore, subpic_window_max_height_minus1 [i] is signalled as the subpicture window maximum height information. This information is information indicating the maximum height of the subpicture window of the i-th subpicture in units of CTUs.

The decoding side apparatus can generate a bit stream that does not include unnecessary data as much as possible by extracting subpictures on the basis of the extraction information.

Note that flag information indicating whether or not the subpicture window maximum size information (subpic_window_max_width_minus1 [i], subpic_window_max_height_minus1 [i]) exists in syntax may be signalled. Furthermore, in a case where the signalling of the subpicture window maximum size information is omitted, the maximum values of the width and height of the subpicture window may be equivalent to the size of the subpicture. As the signalling of the subpicture window maximum size information can be omitted as described above, an increase in the encoding amount can be suppressed.

Furthermore, information indicating that the bit stream can be extracted without the need to recreate the bit stream may be signalled. For example, flag information indicating whether or not it is not necessary to correct the slice data or flag information indicating whether or not the area indicated by the maximum value can be handled equivalent to a picture may be signalled.

<Method 3-1-2>

As illustrated in the fourth row from the top of the table in FIG. 23, in a case where a subpicture is extracted into another bit stream, the subpicture window may be enabled to be extracted with the subpicture window size. That is, only the subpicture window may be enabled to be extracted (Method 3-1-2).

The encoding side apparatus may encode the subpicture in the CVS so as to enable such extraction. That is, the encoding side apparatus performs encoding using the RPR function on the subpicture window. Then, the extraction information indicating whether or not the RPR processing is necessary in the decoding processing of the subpicture window is signalled in the SPS. In this case, the decoding side apparatus necessarily performs decoding in units of subpictures. That is, the decoding side apparatus can extract slice data of only the subpicture window on the basis of the extraction information, and can set the extracted bit stream as a bit stream of a picture using the RPR function.

That is, the encoding side apparatus signals, as the extraction information, reference subpicture window resampling information that is information regarding a subpicture window that requires resampling of the reference subpicture window. The decoding side apparatus analyzes the reference subpicture window resampling information, and decodes the coded data on the basis of the analysis result.

The extraction information is arbitrary as long as it is information regarding extraction of a subpicture. For example, the extraction information may include reference subpicture resampling information that is information regarding resampling processing of the reference subpicture window.

The content of the reference subpicture resampling information is arbitrary as long as the reference subpicture resampling information is information regarding resampling processing of the reference subpicture window. For example, the reference subpicture resampling information may include a reference subpicture window resampling existence flag that is flag information indicating whether or not a subpicture window that requires resampling processing of the reference subpicture window may exist. Furthermore, the reference subpicture resampling information may include a reference subpicture resampling flag that is flag information indicating whether or not the subpicture window of the i-th subpicture requires resampling processing of the reference subpicture window.

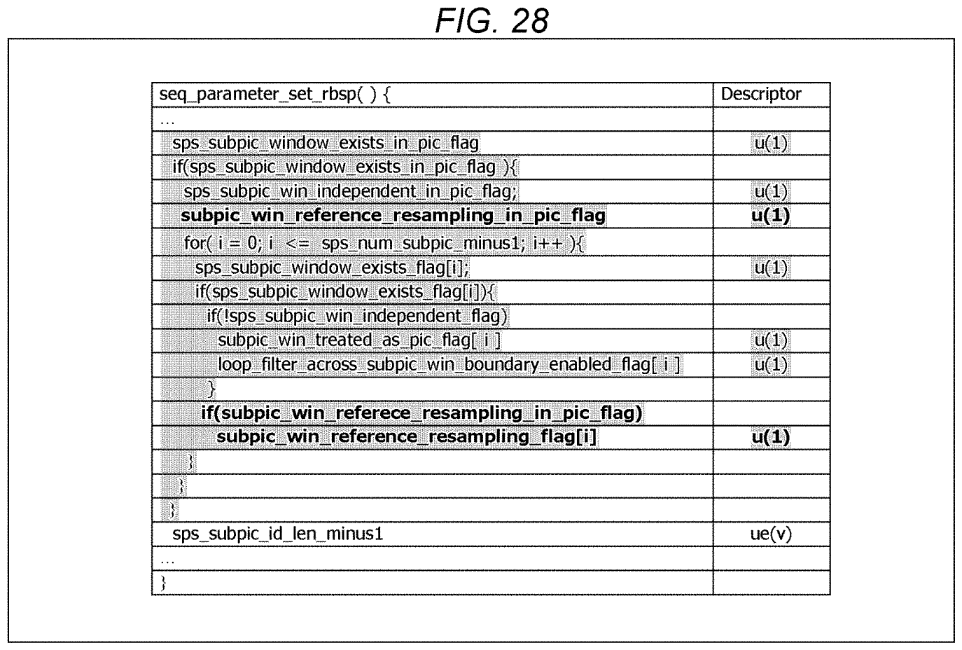

The extraction information may be signalled in the SPS, for example. FIG. 28 is a diagram illustrating an example of syntax of the SPS in that case. In the example of FIG. 28, subpic_win_reference_resampling_in_pic_flag is signalled as the reference subpicture window resampling existence flag. In a case where this flag is true (value “1”), it indicates that a subpicture window that requires resampling processing of the reference subpicture window may exist. In a case where this flag is false (value “0”), it indicates that there is no subpicture window that requires resampling processing of the reference subpicture window.

Furthermore, subpic_win_reference_resampling_flag[i] is signalled as the reference subpicture resampling flag. In a case where this flag is true (value “1”), the subpicture window of the i-th subpicture indicates that resampling processing of the reference subpicture window is necessary. In a case where this flag is false (value “0”), the subpicture window of the i-th subpicture indicates that resampling processing of the reference subpicture window is unnecessary.

The decoding side apparatus can generate a bit stream that does not include unnecessary data by extracting subpictures on the basis of the extraction information. Note that the decoding processing in this case needs to be performed in units of subpictures.

<Method 3-1-3>

In a case where a subpicture is extracted into another bit stream, only the subpicture window may be extracted. That is, as illustrated in the lowermost row of the table in FIG. 23, only the subpictures may be encoded (Method 3-1-3).

Therefore, the encoding side apparatus performs encoding so as to be decodable only in the subpicture window. The decoding side apparatus extracts slice data of only the subpicture window from the bit stream.

However, the bit stream from which only the subpicture window is extracted does not use the RPR function, but the resolution of the picture may change for each frame. Therefore, the decoding side apparatus signals flag information indicating whether or not the picture does not change for each frame but does not use the RPR function. That is, the decoding side apparatus sets such flag information for the extracted bit stream. As a result, the decoding side apparatus can generate a bit stream of only the extracted data.

A decoding side apparatus that decodes a bit stream of only the extracted data analyzes a rescaling prohibition flag that is flag information indicating whether or not rescaling of the resolution of the reference picture is prohibited, and decodes the bit stream on the basis of the analysis result.

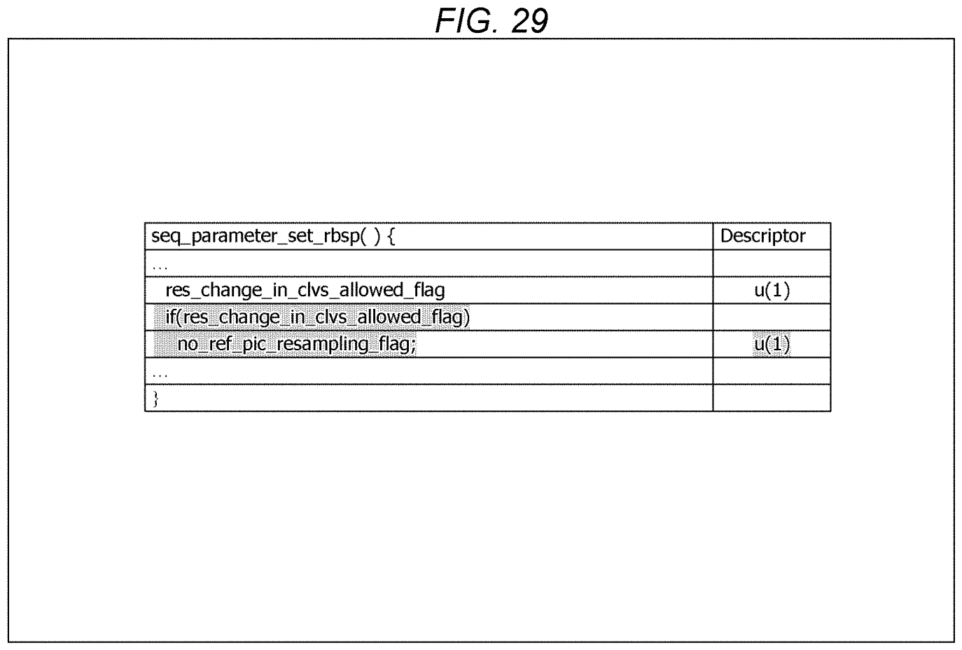

This flag information may be signalled in the SPS, for example. FIG. 29 is a diagram illustrating an example of syntax of the SPS in that case. In the example of FIG. 29, no_ref_pic_rescaling_flag is signalled as the rescaling prohibition flag. In a case where this flag is true (value “1”), it indicates that the rescaling for making the resolution of the reference picture the same as the resolution of the current picture is prohibited even if the resolution of the picture changes. In a case where this flag is false (value “0”), it indicates that the resolution of the reference picture needs to be rescaled to be the same as that of the current picture according to the resolution change of the picture.

By performing such signalling, it is possible to generate a bit stream that does not include unnecessary data when extracting a subpicture.

### 5. Third Embodiment

<Image Coding Apparatus>

Various methods (Method 3, Method 3-1, Method 3-1-1, Method 3-1-2, Method 3-1-3, and modifications and applications of each method, and the like) of the present technology described in <4. Resolution control 2 of image of subpicture> can be applied to any apparatus. For example, the methods can be applied to the image coding apparatus 100 (encoding side apparatus) described with reference to FIG. 19.

In this case, the image coding apparatus 100 performs encoding by applying the various methods of the present technology described with reference to FIG. 23 and the like. That is, the image coding apparatus 100 performs the RPR processing in the subpicture in which the position of the reference pixel is fixed in the time direction.

In this case, the encoding unit 101 encodes an acquired picture by applying an encoding scheme conforming to the VVC described in Non-Patent Document 1, for example. At that time, the encoding unit 101 applies the various methods of the present technology described with reference to FIG. 23 and the like, and performs the RPR processing in the subpicture in which the position of the reference pixel is fixed in the time direction.

The metadata generation unit 102 can generate subpicture setting information and subpicture rendering information as metadata.

The subpicture setting information and the subpicture rendering information may include various types of information described in <4. Resolution control 2 of image of subpicture>. For example, the metadata generation unit 102 can generate information such as the in-picture subpicture window existence flag, the subpicture window existence flag, the subpicture window width information, the subpicture window height information, the in-picture subpicture window existence flag, the subpicture window independence flag, the subpicture window existence flag, the subpicture window reference control flag, the subpicture window loop filter control flag, the subpicture window maximum width information, the subpicture window maximum height information, the reference subpicture window resampling existence flag, the reference subpicture resampling flag, and the rescaling prohibition flag. Of course, the information generated by the metadata generation unit 102 is arbitrary, and is not limited to these examples. For example, the metadata generation unit 102 can also generate metadata described in Non-Patent Document 2, such as subpicture mapping information.

Then, the bit stream generation unit 103 generates a bit stream including the metadata including these pieces of information and the coded data. The bit stream is supplied to the decoding side apparatus via, for example, a storage medium or a communication medium. That is, various types of information described in <4. Resolution control 2 of image of subpicture> are signalled.

Therefore, the decoding side apparatus can perform decoding processing on the basis of the signalled information. As a result, an effect similar to that described in <4. Resolution control 2 of image of subpicture> can be obtained.

For example, the decoding side apparatus can change the resolution of the subpicture in the CVS in the form of a subpicture window. Therefore, it is possible to increase the compression efficiency as compared with the case where the resolution of the subpicture is not changed. Furthermore, the decoding side apparatus can more easily render the image of the decoded subpicture on the basis of the signalled information.

<Flow of Encoding Processing>

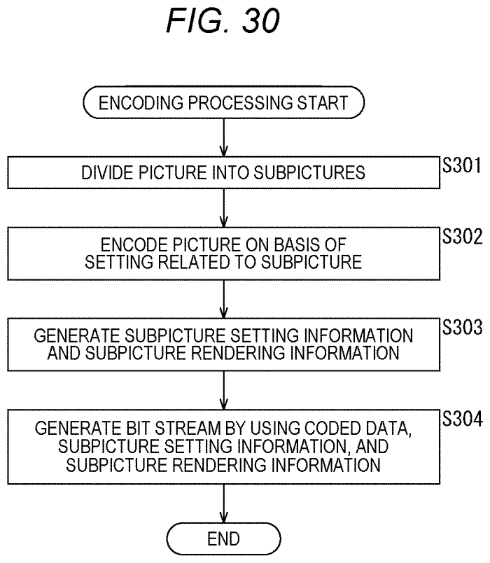

Next, an example of a flow of encoding processing performed by the image coding apparatus 100 in this case will be described with reference to a flowchart in FIG. 30.

When the encoding processing is started, in step S301, the encoding unit 101 of the image coding apparatus 100 divides the picture into subpictures.

In step S302, the encoding unit 101 encodes the picture on the basis of the setting related to the subpicture. At that time, the encoding unit 101 applies the present technology described in <4. Resolution control 2 of image of subpicture>, and performs the RPR processing in the subpicture in which the position of the reference pixel is fixed in the time direction.

In step S303, the metadata generation unit 102 generates the subpicture setting information and the subpicture rendering information. At that time, the metadata generation unit 102 performs processing by applying the present technology. That is, as described above, the metadata generation unit 102 can generate various types of information described in <4. Resolution control 2 of image of subpicture>.

In step S304, the bit stream generation unit 103 generates a bit stream by using the coded data generated in step S302 and the subpicture setting information and the subpicture rendering information generated in step 5303. That is, the bit stream generation unit 103 generates a bit stream including these pieces of information.

When the bit stream is generated, the encoding processing ends.

By performing the encoding processing as described above, various types of information described in <4. Resolution control 2 of image of subpicture> are signalled.

Therefore, the decoding side apparatus can perform decoding processing on the basis of the signalled information. As a result, an effect similar to that described in <4. Resolution control 2 of image of subpicture> can be obtained.

For example, the decoding side apparatus can change the resolution of the subpicture in the CVS in the form of a subpicture window. Therefore, it is possible to increase the compression efficiency as compared with the case where the resolution of the subpicture is not changed. Furthermore, the decoding side apparatus can more easily render the image of the decoded subpicture on the basis of the signalled information.

### <6. Fourth Embodiment

<Image Decoding Apparatus>

Various methods (Method 3, Method 3-1, Method 3-1-1, Method 3-1-2, Method 3-1-3, and modifications and applications of each method, and the like) of the present technology described in <4. Resolution control 2 of image of subpicture> can be applied to the image decoding apparatus 200 (decoding side apparatus) described with reference to FIG. 21, for example.

In this case, the image decoding apparatus 200 performs decoding by applying the various methods of the present technology described with reference to FIG. 23 and the like. That is, the image decoding apparatus 200 performs the RPR processing in the subpicture in which the position of the reference pixel is fixed in the time direction. For example, the image decoding apparatus 200 decodes a bit stream generated by the image coding apparatus 100.

In this case, the analysis unit 201 analyzes the metadata included in the bit stream. For example, the analysis unit 201 can analyze the subpicture setting information and the subpicture rendering information as metadata by applying the present technology described in <4. Resolution control 2 of image of subpicture>.

The subpicture setting information and the subpicture rendering information may include various types of information described in <4. Resolution control 2 of image of subpicture>. For example, the metadata generation unit 102 can generate information such as the in-picture subpicture window existence flag, the subpicture window existence flag, the subpicture window width information, the subpicture window height information, the in-picture subpicture window existence flag, the subpicture window independence flag, the subpicture window existence flag, the subpicture window reference control flag, the subpicture window loop filter control flag, the subpicture window maximum width information, the subpicture window maximum height information, the reference subpicture window resampling existence flag, the reference subpicture resampling flag, and the rescaling prohibition flag. Of course, the information analyzed by the analysis unit 201 is arbitrary, and is not limited to these examples. For example, the analysis unit 201 can also analyze metadata described in Non-Patent Document 2, such as subpicture mapping information.

The extraction unit 202 extracts desired information from the bit stream supplied from the analysis unit 201 on the basis of the analysis result supplied from the analysis unit 201. For example, the extraction unit 202 extracts coded data of an image, subpicture setting information, subpicture rendering information, and the like from the bit stream. The subpicture setting information and the subpicture rendering information may include various types of information analyzed by the analysis unit 201. The extraction unit 202 supplies information or the like extracted from the bit stream to the decoding unit 203.

The decoding unit 203 decodes the coded data on the basis of the metadata to generate a picture. At that time, the decoding unit 203 can appropriately apply the various methods of the present technology described with reference to FIG. 23 and the like, and perform the RPR processing in the subpicture in which the position of the reference pixel is fixed in the time direction. That is, the decoding unit 203 generates an image of each subpicture on the basis of the subpicture setting information that can include various types of information described in <4. Resolution control 2 of image of subpicture>.

The rendering unit 204 performs rendering on the basis of the subpicture rendering information that can include various types of information described in <4. Resolution control 2 of image of subpicture>. The rendering unit 204 outputs the generated display image to the outside of the image decoding apparatus 200. The display image is supplied to and displayed on an image display device (not illustrated) via an arbitrary storage medium, communication medium, or the like.

As described above, the image decoding apparatus 200 analyzes various types of information described in <4. Resolution control 2 of image of subpicture> signalled from the encoding side apparatus, and performs decoding processing on the basis of the information. That is, the image decoding apparatus 200 can apply the present technology described in <4. Resolution control 2 of image of subpicture>, and perform the RPR processing in the subpicture in which the position of the reference pixel is fixed in the time direction. As a result, an effect similar to that described in <4. Resolution control 2 of image of subpicture> can be obtained.

For example, the image decoding apparatus 200 can change the resolution of the subpicture in the CVS in the form of a subpicture window. Therefore, it is possible to increase the compression efficiency as compared with the case where the resolution of the subpicture is not changed. Furthermore, the image decoding apparatus 200 can more easily render the image of the decoded subpicture on the basis of the signalled information.

<Flow of Decoding Processing>

Next, an example of a flow of decoding processing performed by the image decoding apparatus 200 will be described with reference to a flowchart in FIG. 22.

When the decoding process is started, in step S401, the analysis unit 201 of the image decoding apparatus 200 analyzes the metadata included in the bit stream. At that time, the analysis unit 201 applies the present technology described in <4. Resolution control 2 of image of subpicture>, and analyzes various types of information described in <4. Resolution control 2 of image of subpicture> included in the metadata.

In step S402, the extraction unit 202 extracts coded data, subpicture setting information, and subpicture rendering information from the bit stream on the basis of the analysis result of step S401. The subpicture setting information may include various types of information described in <4. Resolution control 2 of image of subpicture>. Furthermore, the subpicture rendering information may include various types of information described in <4. Resolution control 2 of image of subpicture>.

In step S403, the decoding unit 203 decodes the coded data extracted from the bit stream in step S402 using the subpicture setting information extracted from the bit stream in step S402, and generates a picture (each subpicture included in the picture). At that time, the decoding unit 203 applies the present technology described in <4. Resolution control 2 of image of subpicture>. That is, the decoding unit 203 performs the RPR processing in the subpicture in which the position of the reference pixel is fixed in the time direction on the basis of various types of information described in <4. Resolution control 2 of image of subpicture>.

In step S404, the rendering unit 204 uses the subpicture rendering information extracted from the bit stream in step S402 to render decoded data of the picture (or subpicture) generated in step S403, and generates a display image. At that time, the rendering unit 204 applies the present technology described in <4. Resolution control 2 of image of subpicture>. That is, the rendering unit 204 performs rendering on the basis of the various types of information described in <4. Resolution control 2 of image of subpicture>.

When the display image is generated, the decoding processing ends.

By performing the decoding processing as described above, decoding and rendering are performed on the basis of the signalled various types of information described in <4. Resolution control 2 of image of subpicture>. Accordingly, in the image decoding apparatus 200, an effect similar to that described in <4. Resolution control 2 of image of subpicture> can be obtained.

For example, the image decoding apparatus 200 can change the resolution of the subpicture in the CVS in the form of a subpicture window. Therefore, it is possible to increase the compression efficiency as compared with the case where the resolution of the subpicture is not changed. Furthermore, the image decoding apparatus 200 can more easily render the image of the decoded subpicture on the basis of the signalled information.

### <7. Resolution Control 3 of Image of Subpicture>

<ISOBMFF>

Non-Patent Document 5 defines a method of storing a VVC bit stream in an international organization for standardization base media file format (ISOBMFF). In this file format, codingname‘vvc1’ or ‘vvi1’ is set in VvcSamleEntry, and VvcConfigurationBox, which is information for decoding the VVC, is stored.

VvcConfigurationBox includes VvcDecoderConfigurationRecord, and information such as a profile, a tier, or a level is signalled. Moreover, parameter sets, SEIs, and the like can also be signalled.

In a case where an encoder of VVC is implemented, metadata and image data are input to the encoder, and a bit stream is output from the encoder. Whether the metadata is stored in the bit stream depends on the implementation of the encoder. The SEI may be information that does not directly affect encoding, and may not be implemented by an encoder and may not be included in a bit stream. For example, there is an encoder that does not store metadata in SEI on the assumption that a bit stream is stored in a container format.

In a case where a VVC decoder is implemented, a bit stream is input to the decoder, and a decoded image is output from the decoder and input to a renderer. The renderer performs rendering using the decoded image to generate and output a display image.

At that time, if the decoder outputs the metadata signalled from the encoder and supplies the metadata to the renderer, the renderer can perform rendering using the metadata. That is, rendering can be controlled from the encoder side.

However, there is no regulation related to the metadata output from the decoder. For example, whether or not the decoder has an interface that provides information included in a parameter set such as image size information of a decoded image or SEI depends on implementation of the decoder.

Therefore, there is a possibility that the renderer cannot acquire metadata necessary for rendering from the decoder. For example, in a case of implementing an encoder that cannot create a bit stream including specific metadata or a decoder that does not have an interface for outputting metadata, there is a possibility that the renderer cannot acquire information necessary for display. For example, in <1. Resolution control 1 of image of subpicture> and <4. Resolution control 2 of image of subpicture>, it has been described that the subpicture rendering information can be signalled, but there is a possibility that the renderer cannot acquire the subpicture rendering information for the above-described reason.

<Method 4>

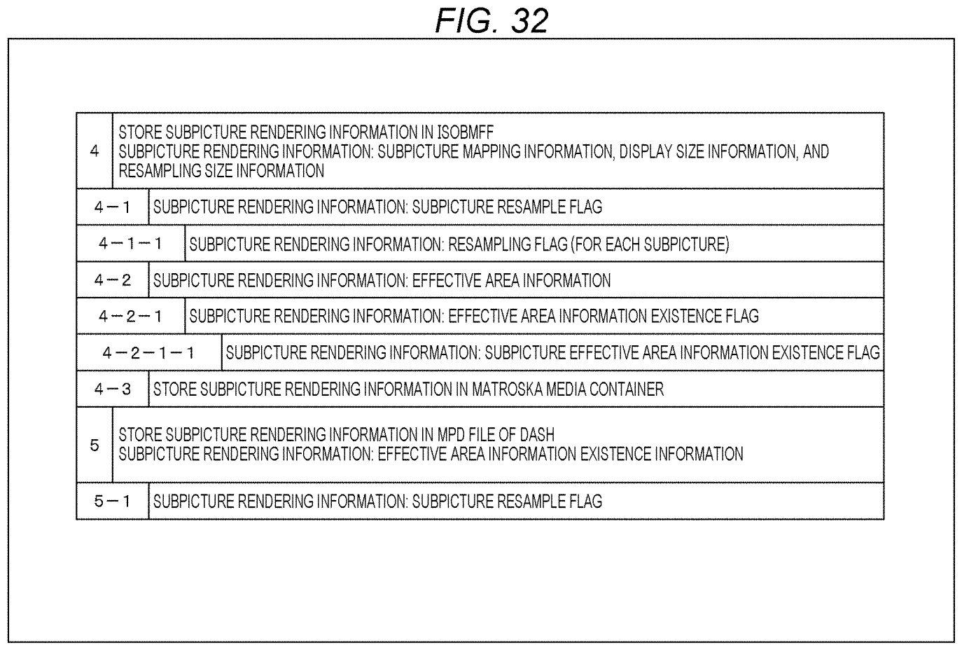

Therefore, a bit stream generated by applying the present technology described in <1. Resolution control 1 of image of subpicture> to <6. Fourth embodiment> is stored in the ISOBMFF using the technology described in Non-Patent Document 5. Then, as illustrated in the uppermost row of the table in FIG. 32, the subpicture rendering information to be used for rendering is signalled in the ISOBMFF (Method 4). For example, as the subpicture rendering information, subpicture mapping information, display size information at the time of rendering, resampled size information, and the like are signalled in the ISOBMFF.

For example, the encoding side apparatus stores coded data and subpicture rendering information that is information regarding rendering of a subpicture in a file. The decoding side apparatus extracts coded data and subpicture rendering information from the file, renders the decoded image on the basis of the subpicture rendering information, and generates a display image.

SubpictureMappingBox(‘sbpm’) may be defined as fixed information (information that does not change) in the sequence, and the subpicture mapping information and the display size information at the time of rendering may be stored in Sample Entry. Furthermore, the resampled size information may be stored in SubpictureSizeEntry of Sample Group so that a signal can be performed for each sample. Then, at the time of rendering, the pixel indicated by the resampled size information may be displayed in accordance with the display size information at the time of rendering.

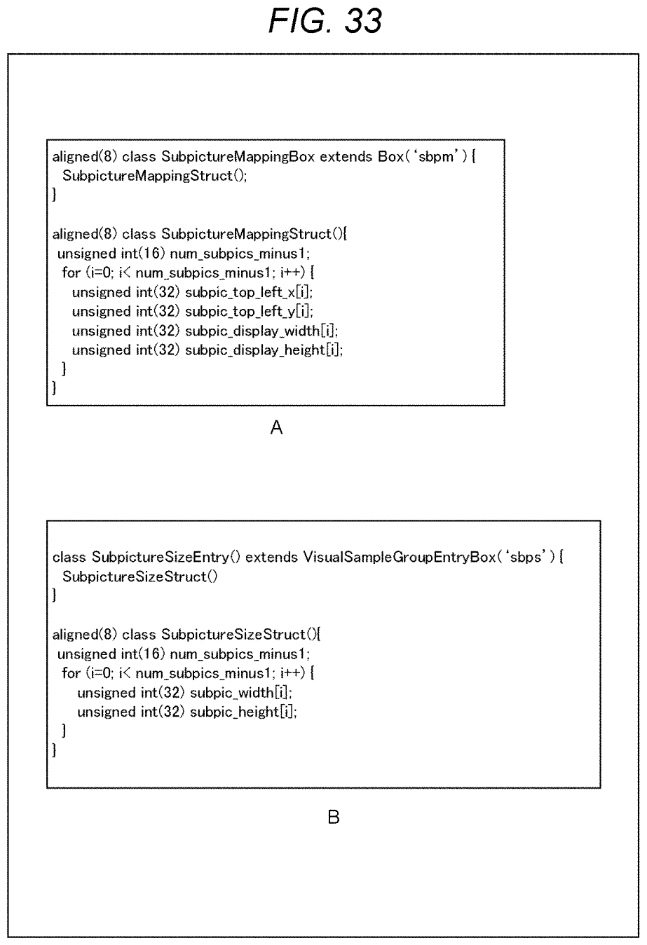

For example, as illustrated in A of FIG. 33, mapping information of a subpicture and display size information at the time of rendering may be signalled in Sample Entry. In SubpictureMappingBox(‘sbpm’) of Sample Entry, the parameter num_subpics_minus1 indicates the number of subpictures−1. Furthermore, the parameter subpic_top_left_x indicates the X coordinate of the pixel at the upper left end of the subpicture, and the parameter subpic_top_left_y indicates the Y coordinate of the pixel at the upper left end of the subpicture. Moreover, the parameter subpic_display_width indicates the width of the display size of the subpicture, and the parameter subpic_display_height indicates the height of the display size of the subpicture.

Furthermore, as illustrated in B of FIG. 33, the resampled size information of the subpicture may be signalled in Sample Group. In this example, the paramete num_subpics_minus1 indicates the number of subpictures−1, subpic_width indicates the width of the resampled size, and subpic_height indicates the height of the resampled size.

As a result, even in a case where the resizing information of the subpicture cannot be acquired from the decoder, the renderer can acquire the information from the ISOBMFF, and can resize and perform rendering. Furthermore, for example, in a case where num_subpics_minus1=0 is set, this can also be applied to a case of RPR processing on a picture.

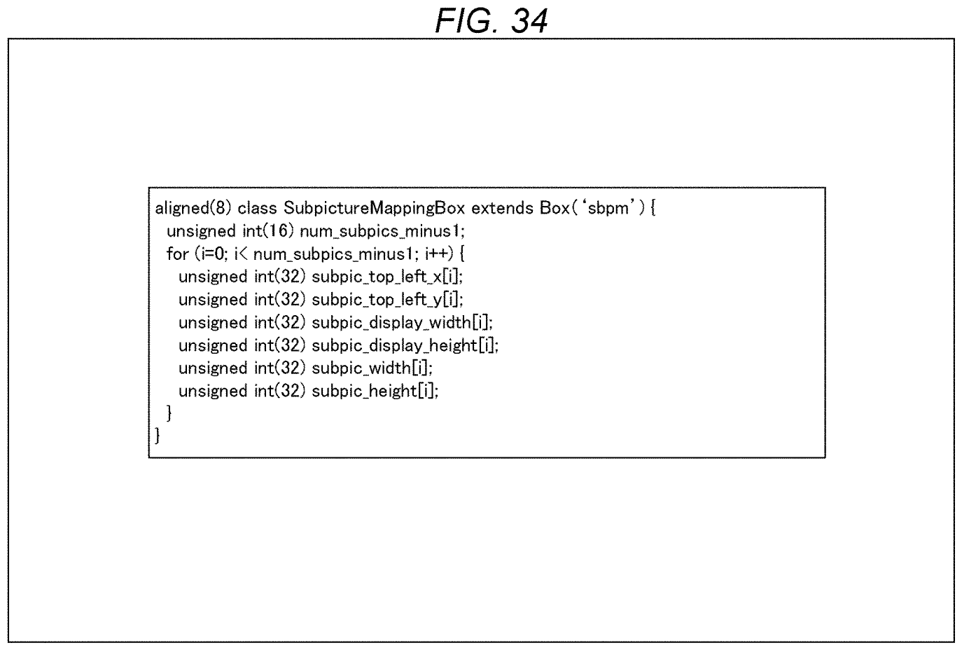

Furthermore, the subpicture mapping information, the resampled size information, and the display size information at the time of rendering may be stored in SubpictureMappingBox, and the SubpictureMappingBox may be stored in Scheme Information Box of rinf (a first modification of Method 4). FIG. 34 illustrates an example of syntax of SubpictureMappingBox in that case. This signalling may reduce the data size signalled in a case where the subpicture mapping information, the resampled size information, and the display size information at the time of rendering are fixed in a time direction. This is available in a case where resampled size information changes frequently. However, it is necessary to generate and store the Sample Entry information including the Scheme Information Box at the changing timing, and as a result, unnecessary data is included.

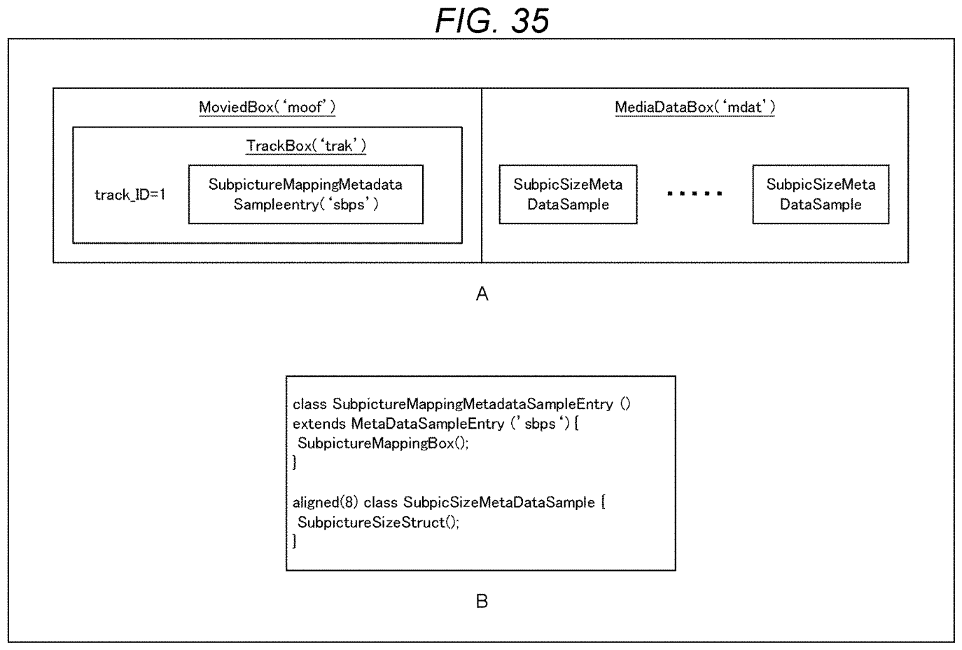

Furthermore, a timed metadata track may be used for signalling (a second modification of Method 4). In that case, codingname and initial value information of Sample Entry, and the structure of the sample are newly defined. For example, as in the file structure illustrated in A of FIG. 35, SubpictureMappingMetadataSampleEntry(‘sbps’) is provided in TrackBox of MoviedBox. Furthermore, SubPicSizeMetaDataSample is provided in MediaDataBox. B of FIG. 35 illustrates an example of syntax of SubpictureMappingMetadataSampleEntry. The subpicture mapping information and the display size information at the time of rendering are stored in the initial value information, and the resampled size information is stored in the sample. The SubpictureMappingBox( )in A of FIG. 33 is the same as that in FIG. 34. SubpictureSizeStruct( )in B of FIG. 35 is the same as that in B of FIG. 33. timed metadata track may be associated with the VVC track by using track_reference.

As a result, even in a case where the resizing information of the subpicture cannot be acquired from the decoder, the renderer can acquire the information from the ISOBMFF, and can resize and perform rendering. Furthermore, for example, in a case where the VVC bit stream includes the meta information and the decoding side apparatus does not use the information of the ISOBMFF, this track may not be acquired.

<Method 4-1>

As illustrated in the second row from the top of the table in FIG. 32, a subpicture resample flag may be signalled in the ISOBMFF as subpicture rendering information (Method 4-1). The subpicture resample flag is flag information indicating whether or not a part of the decoded picture needs to be resized. For example, this subpicture resample flag may be signalled in VvcDecoderConfigurationRecord.

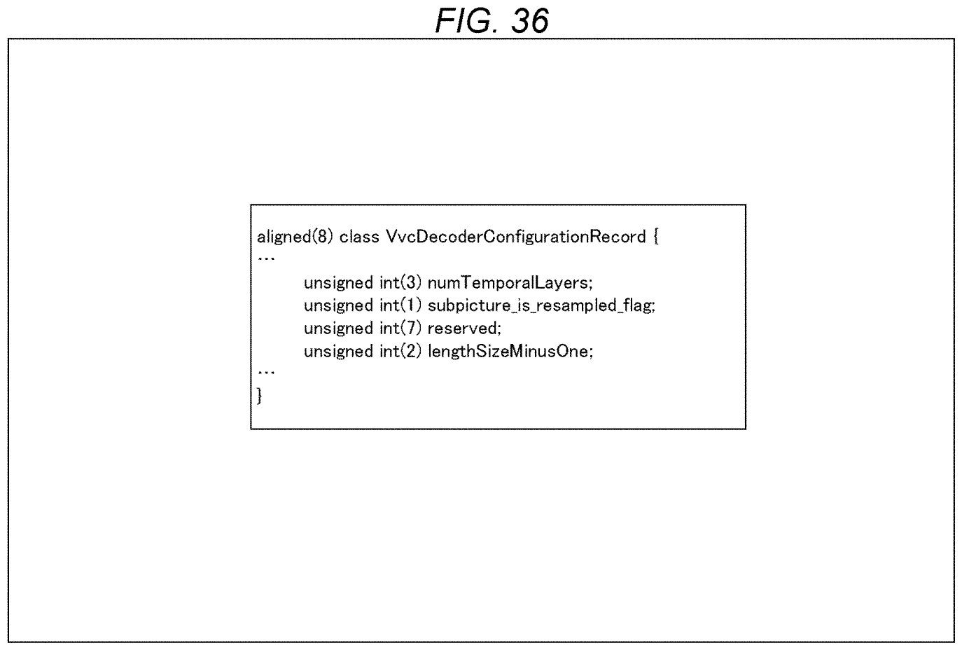

FIG. 36 illustrates an example of syntax of VvcDecoderConfigurationRecord in that case. In FIG. 36, in a case where subpicture_is_resampled_flag signalled as a subpicture resample flag is true (value “1”), it indicates that there may be a resized subpicture. Furthermore, in a case where this flag is false (value “0”), it indicates that there is no resized subpicture to which the RPR is applied.

By signalling the subpicture resample flag in the ISOBMFF as described above, the renderer of the decoding side apparatus can acquire the subpicture resample flag. Accordingly, the renderer can easily grasp whether or not partial resizing is necessary for the picture associated with Sample Entry. As a result, the renderer can more easily identify whether or not the decoded image can be reproduced, for example.

Note that, in SubpictureMappingStruct illustrated in A of FIG. 33 or SubpictureMappingBox illustrated in FIG. 34, this subpicture resample flag may be signalled. In this case, it is possible to signal that resizing is necessary for a part of the picture for each picture.

<Method 4-1-1>

As illustrated in the third row from the top of the table in FIG. 32, a resampling flag may be signalled in the ISOBMFF as subpicture rendering information (Method 4-1-1). This resampling flag is flag information indicating whether or not the subpicture needs to be resized. For example, in SubpictureMappingStruct illustrated in A of FIG. 33 or SubpictureMappingBox illustrated in FIG. 34, the resample flag may be signalled.

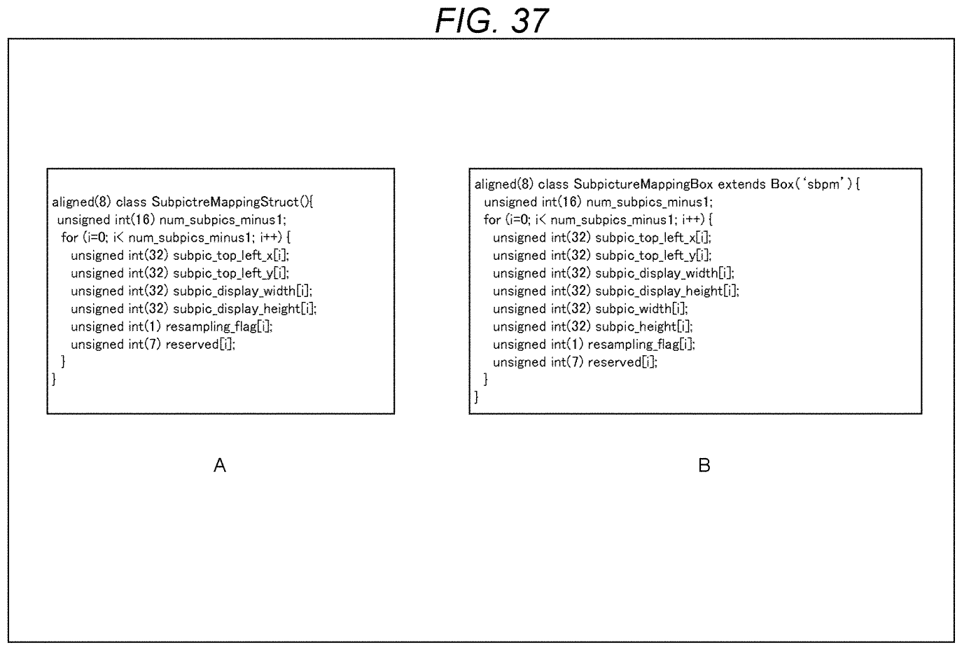

A of FIG. 37 illustrates an example of syntax of SubpictureMappingStruct in that case. Furthermore, B of FIG. 37 illustrates an example of syntax of SubpictureMappingBox in that case. resampling_flag[i] signalled as the resampling flag is a flag indicating whether or not the i-th subpicture needs to be resized. For example, in a case where this flag is true (value “1”), it indicates that resizing is necessary. That is, it is indicated that the subpicture is resampled and a size change may occur. Furthermore, in a case where this flag is false (value “0”), it is indicated that a size change does not occur in the subpicture, and resizing is unnecessary.

As described above, by signalling the resampling flag in the ISOBMFF, the renderer can acquire the resampling flag. Accordingly, in a case where some subpictures are reproduced, the renderer can more easily grasp whether or not the subpictures need to be resized. That is, the renderer can more easily identify whether or not the subpicture can be reproduced on the basis of the resampling flag.

Moreover, signalling the resampling flag in the ISOBMFF allows the renderer to more easily set the above-described subpicture resample flag when merging a plurality of subpictures or pictures into one picture.

<Method 4-2>

As illustrated in the fourth row from the top of the table in FIG. 32, an effective area information may be signalled in the ISOBMFF as subpicture rendering information (Method 4-2). The effective area information is information regarding the effective area. For example, the renderer performs rendering so as not to draw an area (ineffective area) not included in the effective area information. As a result, the renderer can hide a portion that does not originally include pixel information or a portion that includes pixel information but is unnecessary in the decoded image. This effective area information may be signalled for information after resizing.

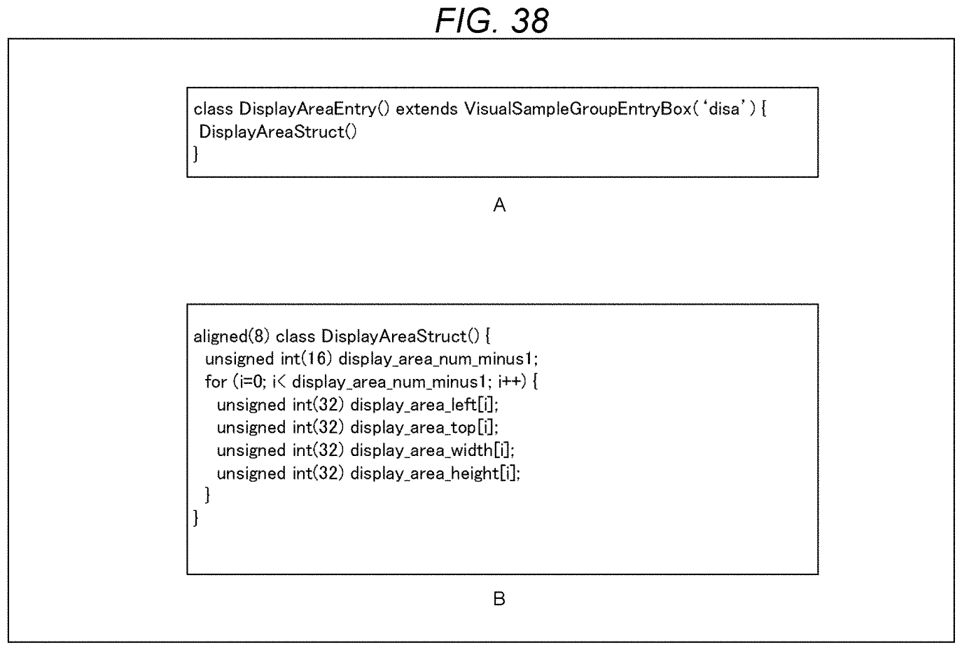

The effective area information may be signalled, for example, in Sample Group DisplayAreaEntry. For example, as illustrated in A of FIG. 38, DisplayAreaStruct may be defined in VisualSampleGroupEntryBox, and as illustrated in B of FIG. 38, the effective area information may be signalled in the DisplayAreaStruct.

In this DisplayAreaStruct, the effective area is expressed as a group of a plurality of rectangles. display_area_num_minus1 is a parameter indicating the number of effective areas−1. display area left and display area top are parameters indicating position information (coordinates) of a pixel at the upper left end of the effective area. display_area_width is a parameter indicating the width of the effective area, and display_area_height is a parameter indicating the height of the effective area.

Note that not the effective area but the ineffective area may be signalled. Furthermore, a signal target may be selected from an ineffective area and an effective area. Moreover, the effective area or the ineffective area may be information before resizing. Furthermore, the information may be either information before resizing or information after resizing. In that case, flag information indicating whether the effective area or the ineffective area is information before resizing or information after resizing may be signalled.

By signalling such effective area information in the ISOBMFF, the renderer can acquire the effective area information from the ISOBMFF even in a case where the effective area information cannot be acquired from the decoder. Accordingly, the renderer can perform rendering so as to display only the effective area. Furthermore, by combining with the effective area information described above in <1. Resolution control 1 of image of subpicture>, the renderer can also obtain the effective area information for each subpicture.

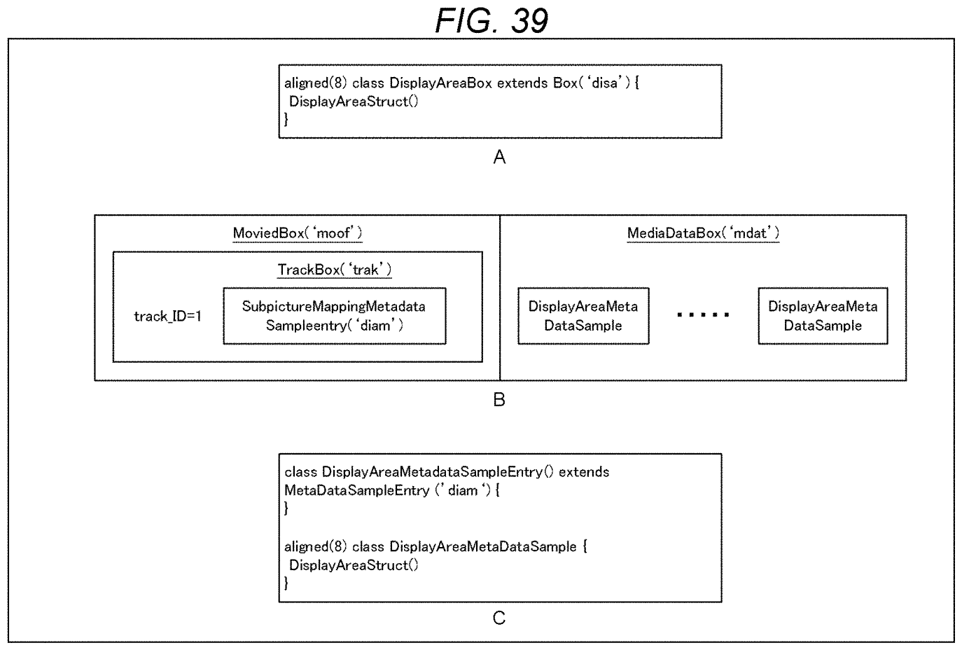

Note that DisplayAreaBox including the effective area information may be stored in Scheme Information Box of rinf. A of FIG. 39 illustrates an example of syntax of the DisplayAreaBox in that case. This DisplayAreaStruct may be defined as illustrated in B of FIG. 38. This signalling is effective in a case where the effective area information is fixed in the time direction. This signalling can be used even in a case where the effective area information changes frequently. However, it is necessary to generate and store the Sample Entry information including the Scheme Information Box at the changing timing, and as a result, unnecessary data is included.

Furthermore, the effective area information may be signalled using timed metadata track. In that case, codingname of Sample Entry and the structure of the sample are newly defined. For example, as in the file structure illustrated in B of FIG. 39, DisplayAreaMetadataSampleEntry(‘diam’) is provided in TrackBox of MoviedBox. Furthermore, DisplayAreaMetaDataSample is provided in MediaDataBox. C of FIG. 39 illustrates an example of syntax of DisplayAreaMetadataSampleEntry. The effective area information is stored in the sample. This DisplayAreaStruct may be defined as illustrated in B of FIG. 38.

As a result, the renderer can acquire the effective area information from the ISOBMFF even in a case where the effective area information cannot be acquired from the decoder. Accordingly, the renderer can perform rendering so as to display only the effective area. Furthermore, for example, in a case where the VVC bit stream includes the meta information and the decoding side apparatus does not use the information of the ISOBMFF, this track may not be acquired.

<Method 4-2-1>

As illustrated in the fifth row from the top of the table in FIG. 32, an effective area information existence flag may be signalled in the ISOBMFF as subpicture rendering information (Method 4-2-1). The effective area information existence flag is flag information indicating whether or not the effective area information exists. For example, this effective area information existence flag may be signalled in VvcDecoderConfigurationRecord.

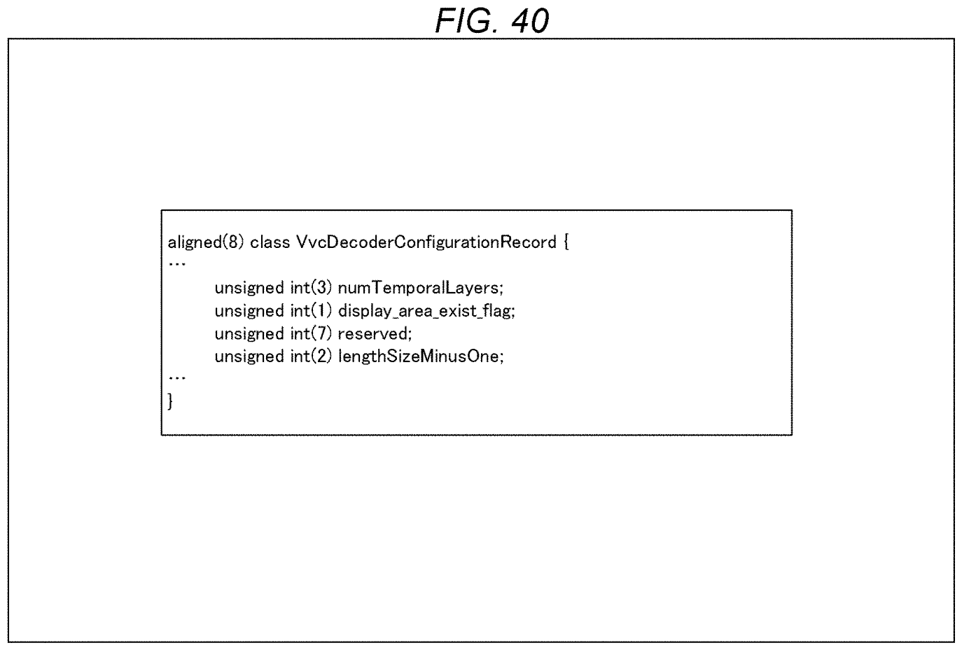

FIG. 40 illustrates an example of syntax of VvcDecoderConfigurationRecord in that case. In the example of FIG. 40, in a case where display area exist flag signalled as the effective area information existence flag is true (value “1”), it indicates that the display area information (effective area information) may exist. Furthermore, in a case where this flag is false (value “0”), it indicates that there is no display area information (effective area information). In that case, the decoded picture can be displayed as it is.

Note that the effective area information existence flag may be signalled in SubpictureMappingStruct illustrated in A of FIG. 33 or the SubpictureMappingBox illustrated in FIG. 34. In this case, it is possible to signal whether or not the display area information (effective area information) exists for each picture.

Note that, instead of the effective area information existence flag, an ineffective area information existence flag indicating whether or not an ineffective area may exist may be signalled.

Furthermore, a target to be signalled may be selected from the effective area information existence flag and the ineffective area information existence flag. Moreover, the effective area or the ineffective area may be information before resizing. Furthermore, the information may be either information before resizing or information after resizing. In that case, flag information indicating whether the effective area or the ineffective area is information before resizing or information after resizing may be signalled.

<Method 4-2-1-1>

As illustrated in the sixth row from the top of the table in FIG. 32, a subpicture effective area information existence flag may be signalled in the ISOBMFF as subpicture rendering information (Method 4-2-1-1). This subpicture effective area information existence flag is flag information indicating whether or not the effective area information exists for each subpicture. This subpicture effective area information existence flag may be signalled, for example, in SubpictureMappingStruct illustrated in A of FIG. 33 or SubpictureMappingBox illustrated in FIG. 34.

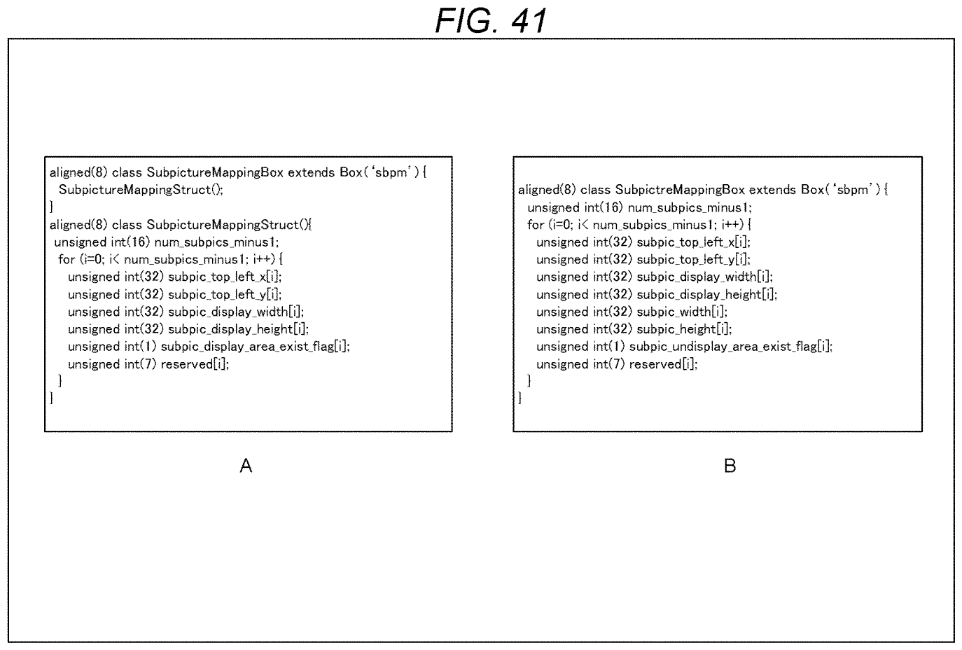

A of FIG. 41 illustrates an example of syntax of SubpictureMappingStruct in that case. Furthermore, B of FIG. 41 illustrates an example of syntax of SubpictureMappingBox in that case.

In a case where subpic_display_area_exist_flag signalled as the subpicture effective area information existence flag is true (value “1”), it indicates that the display area information (effective area information) may exist in the subpicture. In a case where this flag is false (value “0”), there is no display area information (effective area information) in the subpicture. In this case, the decoded subpicture can be displayed as it is.

By signalling the subpicture effective area information existence flag in the ISOBMFF as described above, the renderer can easily set the effective area information existence flag when merging a plurality of subpictures or pictures into one picture.

Note that, instead of the subpicture effective area information existence flag, a subpicture ineffective area information existence flag indicating whether or not an ineffective area may exist for each subpicture may be signalled. Furthermore, a target to be signalled may be selected from the subpicture effective area information existence flag and the subpicture ineffective area information existence flag. Moreover, the effective area or the ineffective area may be information before resizing. Furthermore, the information may be either information before resizing or information after resizing. In that case, flag information indicating whether the effective area or the ineffective area is information before resizing or information after resizing may be signalled.

<Method 4-3>

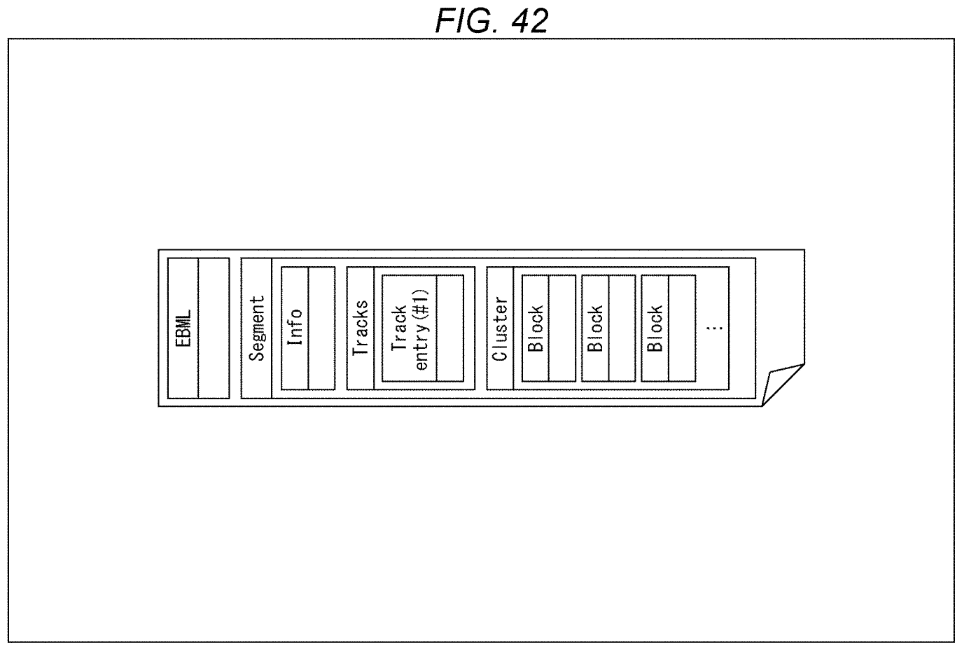

The file format of the file for signalling the subpicture rendering information is arbitrary, and is not limited to the ISOBMFF. The subpicture rendering information can be signalled in a file of any file format. For example, as illustrated in the seventh row from the top of the table in FIG. 32, the subpicture rendering information may be stored in a Matroska media container (Method 4-3). The Matroska media container is a file format described in Non-Patent Document 7. FIG. 42 is a diagram illustrating a main configuration example of The Matroska media container.

In the case of Method 4, the first modification of Method 4, and Method 4-1 described above, SubpictureMappingBox signals the Track Entry element as a new SubpictureMapping element. Furthermore, SubpictureSizeEntry is newly signalled as SubpictureSizeEntry element in the Track Entry element.

In the case of the second modification of Method 4 described above, in addition to SubpictureMapping element described above, codingname signals with CodeclD and CodecName of Track Entry element, and SubpicSizeMetaDataSample is stored as block data.

Also in the above-described Method 4-2, Method 4-2-1, and Method 4-2-1-1, Track Entry element, CodeclD and

CodecName of Track Entry element, and the block data can be defined and stored in a similar manner to that in the above-described case.

<Method 5>

Furthermore, as illustrated in the eighth row from the top of the table in FIG. 32, the subpicture rendering information may be stored in a media presentation description (MPD) file of Moving Picture Experts Group phase Dynamic Adaptive Streaming over HTTP (MPEG DASH) using the technology described in Non-Patent Document 6 (Method 5).

For example, the effective area information existence information is defined, and is signalled in

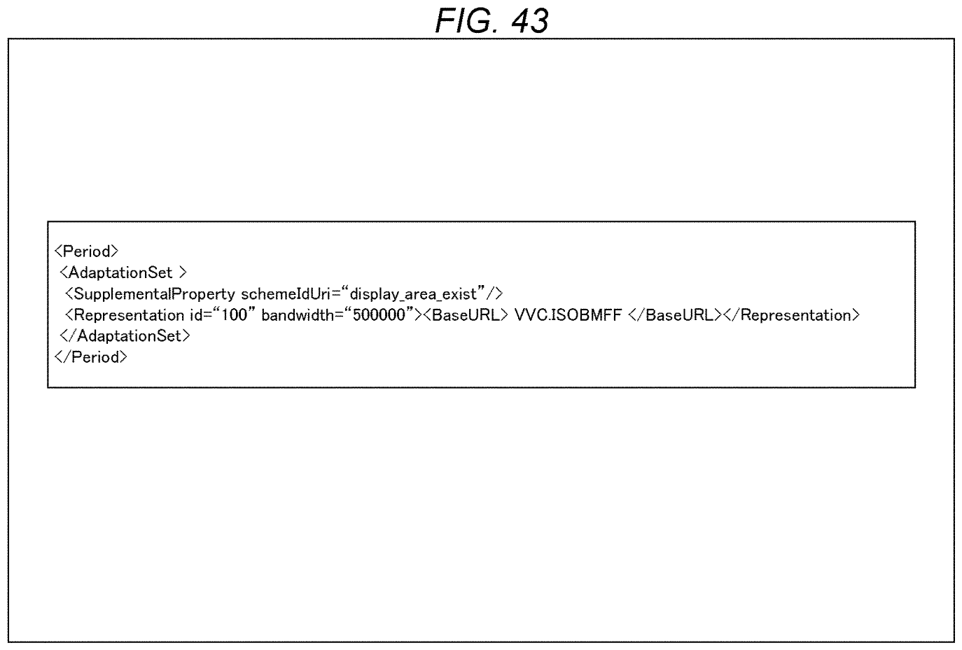

SupplementalProperty of an MPD file. The effective area information existence information is information indicating whether or not the effective area information is included in a DASH segment file. FIG. 43 illustrates a description example of the MPD file. As illustrated in FIG. 43, SupplementalProperty schemeldUri=“display_area_exist” is set, and signalled in AdaptationSet. In a case where this SupplementalProperty exists, it means that the effective area information is included in the segment file.

As a result, in a case where the effective area information cannot be used at the time of selecting the segment file, the decoding side apparatus can exclude the effective area information from the selection candidates.

Note that, instead of AdaptationSet, the effective area information existence information may be signalled in Representation or SubRepresentation.

Furthermore, signalling may be performed using @codecs signalled in AdaptationSet or the like. In this case, a brand of the ISOBMFF including use of the effective area information, for example, “disp” is defined, and is signalled as @codecs=‘resv.disp.vvc1’ or the like. Furthermore, a video profile including the effective area information, for example, “pdsp” may be defined, and signalled as @mimeType=‘video/mp4profiles=“pdsp”’.

<Method 5-1>

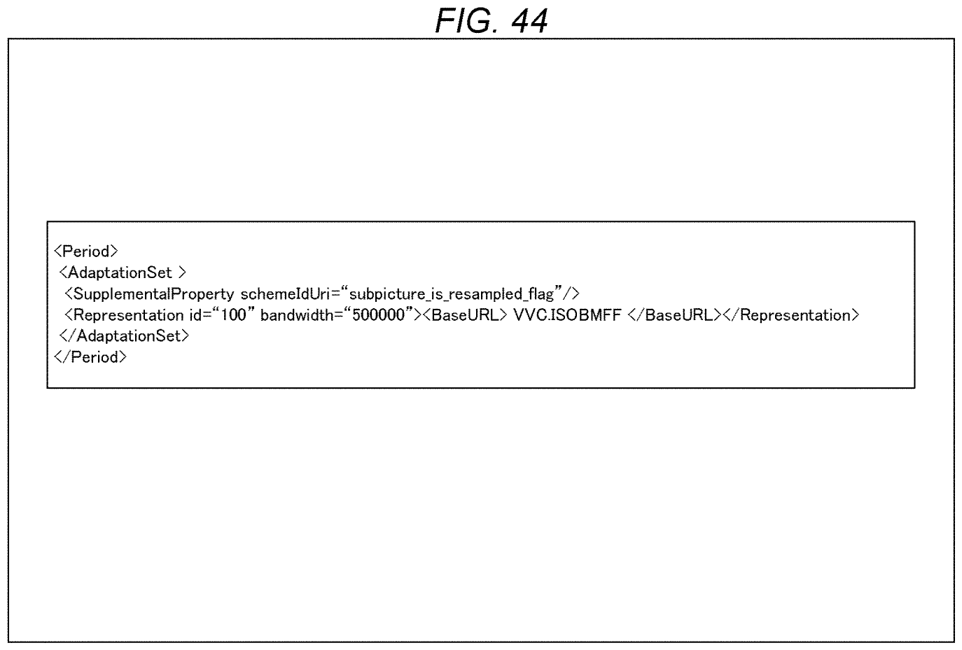

Furthermore, as illustrated in the lowermost row of the table in FIG. 32, the subpicture resample flag may be signalled as the subpicture rendering information in the MPD file (Method 5-1). The subpicture resample flag is flag information indicating whether or not the resizing information is included in the DASH segment file. For example, a subpicture resample flag is defined, and is signalled in SupplementalProperty of the MPD file. FIG. 44 illustrates a description example of the MPD file. As illustrated in FIG. 44, schemeIdUri=“subpicture_is_resampled_flag” of SupplementalProperty is set, and signalled in AdaptationSet. In a case where this SupplementalProperty exists, it means that it is necessary to resize a part of the picture included in the segment file.

As a result, in a case where resizing cannot be performed at the time of selecting the segment file, the decoding side apparatus can exclude the effective area information from the selection candidates.

Note that, instead of AdaptationSet, a subpicture resample flag may be signalled in Representation or SubRepresentation.

Furthermore, signalling may be performed using @codecs signalled in AdaptationSet or the like. In this case, a brand of the ISOBMFF including use of the resizing information, for example, “disp” is defined, and is signalled as @codecs=‘resv.disp.vvc1’ or the like. Furthermore, a video profile including the resizing information, for example, “pdsp” may be defined, and signalled as @mimeType=‘video/mp4profiles=“pdsp”’.

### 8. Fifth Embodiment

<Image Processing System>

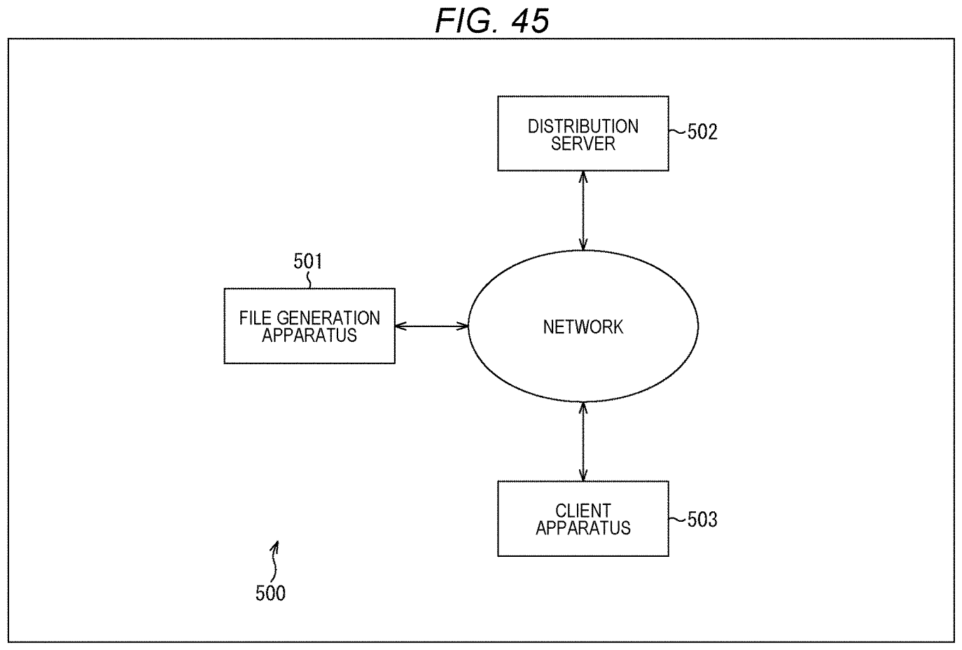

Various methods (Method 4, Method 4-1, Method 4-1-1, Method 4-2, Method 4-2-1, Method 4-2-1-1, Method 4-3, Method 5, Method 5-1, and modifications and applications of each method, and the like) of the present technology described in <7. Resolution control 3 of image of subpicture> can be applied to any apparatus. For example, the methods can be applied to an image processing system. FIG. 45 is a block diagram illustrating an example of a configuration of one aspect of an image processing system to which the present technology is applied.

An image processing system 500 illustrated in FIG. 45 is a system that distributes image data. In the image processing system 500, the image data is encoded by dividing a picture into subpictures using a moving image encoding method such as the VVC described in Non-Patent Document 1, for example, and the bit stream is stored in a file of a distribution file format such as the ISOBMFF and distributed. Furthermore, a distribution technology such as MPEG DASH can also be applied to the distribution of this bit stream.

As illustrated in FIG. 45, the image processing system 500 includes a file generation apparatus 501, a distribution server 502, and a client apparatus 503. The file generation apparatus 501, the distribution server 502, and the client apparatus 503 are communicably connected to each other via a network 504.

The file generation apparatus 501 is an example of an encoding side apparatus, encodes image data, and generates a file that stores the bit stream. The file generation apparatus 501 supplies the generated file to the distribution server 502 via the network 504.

The distribution server 502 performs processing related to distribution of the file. For example, the distribution server 502 acquires and stores the file supplied from the file generation apparatus 501. In addition, the distribution server 502 receives a distribution request from the client apparatus 503. Upon receiving the distribution request, the distribution server 502 reads the requested file and supplies the file to the client apparatus 503 as a request source via the network 504.

The client apparatus 503 is an example of a decoding side apparatus, accesses the distribution server 502 via the network 504, and requests a desired file from among the files accumulated in the distribution server 502. When the distribution server 502 distributes a file in response to the distribution request, the client apparatus 503 acquires and decodes the file, performs rendering, and displays an image.

The network 504 is an arbitrary communication medium. For example, the network 504 may include the Internet or a LAN. Furthermore, the network 504 may be configured by a wired communication network, a wireless communication network, or a combination of a wired communication network and a wireless communication network.

Note that FIG. 45 illustrates one file generation apparatus 501, one distribution server 502, and one client apparatus 503 as a configuration example of the image processing system 500, but the number of these apparatuses is arbitrary. The image processing system 500 may include a plurality of file generation apparatuses 501, a plurality of distribution servers 502, and a plurality of client apparatuses 503. Furthermore, the number of the file generation apparatuses 501, the number of the distribution servers 502, and the number of the client apparatuses 503 may be the same or may be different from each other. Furthermore, the image processing system 500 may include an apparatus other than the file generation apparatus 501, the distribution server 502, and the client apparatus 503.

<File Feneration Apparatus>

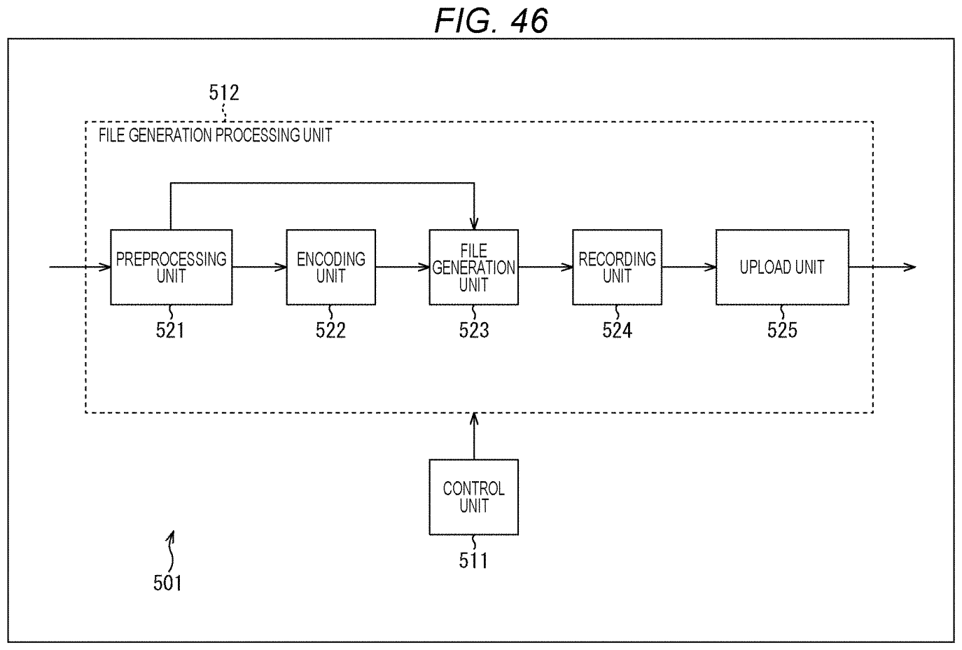

FIG. 46 is a block diagram illustrating a main configuration example of the file generation apparatus 501. As illustrated in FIG. 46, the file generation apparatus 501 includes a control unit 511 and a file generation processing unit 512. The control unit 511 controls the file generation processing unit 512 to perform control related to file generation. The file generation processing unit 512 performs processing related to file generation.

The file generation processing unit 512 includes a preprocessing unit 521, an encoding unit 522, a file generation unit 523, a storage unit 524, and an upload unit 525.

The preprocessing unit 521 generates subpicture rendering information to be signalled in the file on the basis of the image data input to the file generation apparatus 501. At that time, the preprocessing unit 521 generates the various types of information described above in <7. Resolution control 3 of image of subpicture> as the subpicture rendering information. For example, the preprocessing unit 521 can generate subpicture mapping information, display size information at the time of rendering, resampled size information, a subpicture resample flag, a resampling flag, effective area information, an effective area information existence flag, a subpicture effective area information existence flag, and the like.

The preprocessing unit 521 supplies the generated subpicture rendering information to the file generation unit 523. Furthermore, the preprocessing unit 521 supplies the image data and the like to the encoding unit 522.

The encoding unit 522 encodes the image data supplied from the preprocessing unit 521 to generate a bit stream. The encoding unit 522 can perform this encoding by applying the various methods of the present technology described above in <1. Resolution control 1 of image of subpicture> to <6. Fourth embodiment>. That is, the image coding apparatus 100 (FIG. 19) can be applied to the encoding unit 522. In other words, the encoding unit 522 has a configuration similar to that of the image coding apparatus 100, and can perform similar processing. The encoding unit 522 supplies the generated bit stream to the file generation unit 523. The file generation unit 523 stores the bit stream supplied from the encoding unit 522 in the file of the distribution file format. For example, the file generation unit 523 generates an ISOBMFF file that stores the bit stream. Moreover, the file generation unit 523 generates a file by applying the present technology described above in <7. Resolution control 3 of image of subpicture>. That is, the file generation unit 523 stores the subpicture rendering information supplied from the preprocessing unit 521 in the file. That is, the file generation unit 523 signals the above-described various types of information generated by the preprocessing unit 521 in the file. The file generation unit 523 supplies the generated file to the storage unit 524.

The storage unit 524 stores the file supplied from the file generation unit 523. The upload unit 525 acquires a file from the storage unit 524 at a predetermined timing, and supplies (uploads) the file to the distribution server 502.

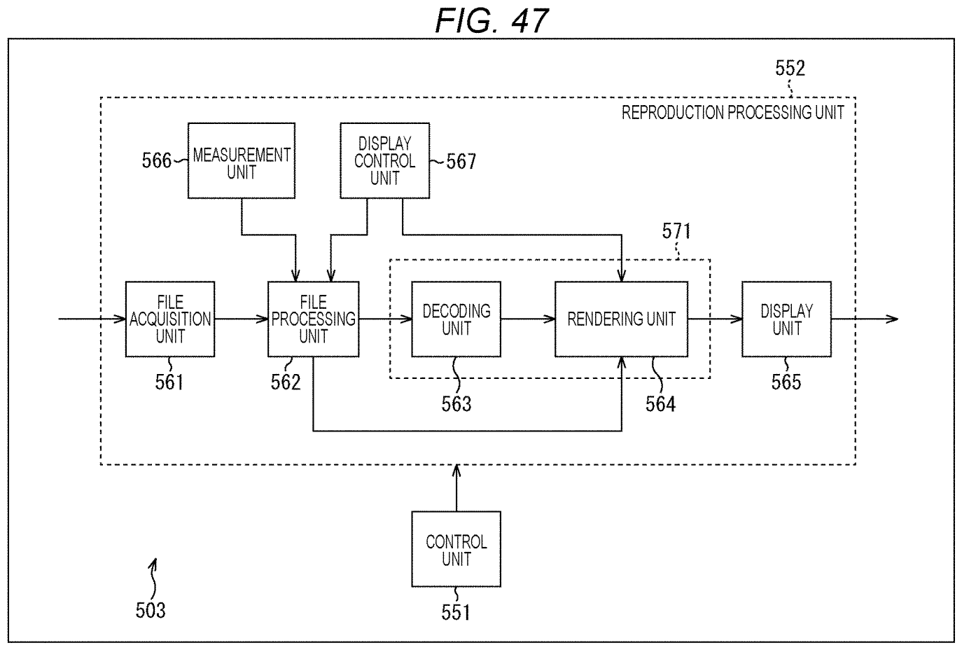

As described above, the file generation apparatus 501 causes the subpicture rendering information to be signalled in the file. Accordingly, the client apparatus 503 that is a decoding side apparatus can acquire the subpicture rendering information from the file and use the subpicture rendering information for rendering. Accordingly, since the rendering can be controlled from the file generation apparatus 501, the client apparatus 503 can perform rendering more appropriately. For example, the client apparatus 503 can generate a display image with higher image quality. In other words, the file generation apparatus 501 can suppress an increase in the encoding amount for generating the display image with the same party's image quality.

<Client Apparatus>FIG. 47 is a block diagram illustrating a main configuration example of the client apparatus 503. The client apparatus 503 includes a control unit 551 and a reproduction processing unit 552. The control unit 551 controls the reproduction processing unit 552 to perform control related to reproduction of a moving image. The reproduction processing unit 552 performs processing related to reproduction of a moving image.

The reproduction processing unit 552 includes a file acquisition unit 561, a file processing unit 562, a decoding unit 563, a rendering unit 564, a display unit 565, a measurement unit 566, and a display control unit 567.

The file acquisition unit 561 performs processing related to acquisition of the file distributed from the distribution server 502. For example, the file acquisition unit 561 requests the distribution server 502 to distribute a desired file on the basis of the control of the control unit 551. Furthermore, the file acquisition unit 561 acquires the file distributed in response to the request and supplies the file to the file processing unit 562.

The file processing unit 562 performs processing related to a file. For example, the file processing unit 562 acquires the file supplied from the file acquisition unit 561. This file is a file generated by the file generation apparatus 501. That is, this file stores a bit stream including coded data of image data. The file processing unit 562 extracts the bit stream from the file and supplies the bit stream to the decoding unit 563.

Furthermore, this file is, for example, a file of a distribution file format such as the ISOBMFF, and the subpicture rendering information is signalled. The file processing unit 562 performs processing by applying the present technology described above in <7. Resolution control 3 of image of subpicture>, and extracts the subpicture rendering information from the file. For example, the file processing unit 562 extracts the various types of information described above in <7. Resolution control 3 of image of subpicture> as the subpicture rendering information. For example, the file processing unit 562 can extract subpicture mapping information, display size information at the time of rendering, resampled size information, a subpicture resample flag, a resampling flag, effective area information, an effective area information existence flag, a subpicture effective area information existence flag, and the like. The file processing unit 562 supplies the extracted subpicture rendering information to the rendering unit 564. The decoding unit 563 decodes the bit stream supplied from the file processing unit 562 to generate a decoded image. At that time, the decoding unit 563 can perform this decoding by applying the various methods of the present technology described above in <1. Resolution control 1 of image of subpicture> to <6. Fourth embodiment>. The decoding unit 563 supplies the generated decoded image to the rendering unit 564.

The rendering unit 564 performs rendering using the decoded image supplied from the decoding unit 563 to generate a display image. At that time, the rendering unit 564 can perform processing by applying the present technology described above in <7. Resolution control 3 of image of subpicture>. That is, the rendering unit 564 can perform rendering by using the subpicture rendering information supplied from the file processing unit 562. For example, the rendering unit 564 can perform rendering using the various types of information described above in <7. Resolution control 3 of image of subpicture> as the subpicture rendering information. For example, the rendering unit 564 can perform rendering by using subpicture mapping information, display size information at the time of rendering, resampled size information, a subpicture resample flag, a resampling flag, effective area information, an effective area information existence flag, a subpicture effective area information existence flag, and the like. The rendering unit 564 supplies the display image generated by such rendering to the display unit 565.

The display unit 565 includes a monitor that displays an image, and displays a display image supplied from the rendering unit 564 on the monitor. The measurement unit 566 measures an arbitrary parameter such as time, for example, and supplies a measurement result to the file processing unit 562. The display control unit 567 controls image display by the display unit 565 by controlling the file processing unit and the rendering unit 54.

The image decoding apparatus 200 (FIG. 21) can be applied to the decoding unit 563 and the rendering unit 564 surrounded by a dotted line 571. The decoding unit 563 and the rendering unit 564 have similar configuration to that of the image decoding apparatus 200, and can perform similar processing. That is, the rendering unit 564 can perform rendering by using the subpicture rendering information extracted by the file processing unit 562, or can acquire the subpicture rendering information included in the bit stream from the decoding unit 563 and perform rendering by using the subpicture rendering information.

As described above, the client apparatus 503 can perform rendering by using the subpicture rendering information signalled in the file. Accordingly, since the rendering can be controlled from the file generation apparatus 501, the client apparatus 503 can perform rendering more appropriately. For example, the client apparatus 503 can generate a display image with higher image quality. In other words, the file generation apparatus 501 can suppress an increase in the encoding amount for generating the display image with the same party's image quality.

<Flow of File Generation Processing>

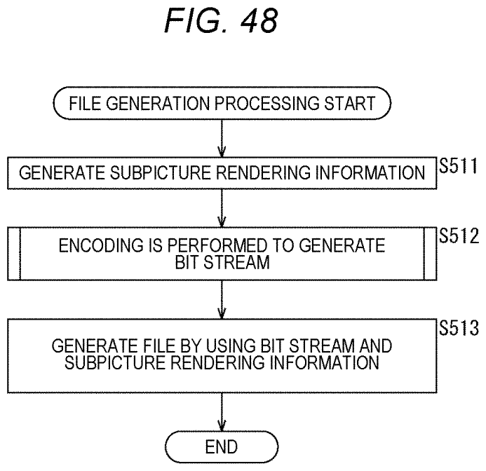

Next, an example of a flow of file generation processing performed by the file generation apparatus 501 will be described with reference to a flowchart of FIG. 48.

When the file generation processing is started, in step S511, the preprocessing unit 521 of the file generation apparatus 501 generates the various types of information described above in <7. Resolution control 3 of image of subpicture> as the subpicture rendering information.

In step S512, the encoding unit 522 encodes the image data to generate a bit stream. The encoding unit 522 performs this encoding by applying the various methods of the present technology described above in <1. Resolution control 1 of image of subpicture> to <6. Fourth embodiment>. That is, the encoding unit 522 performs the encoding processing of FIG. 20 or the encoding processing of FIG. 30 to generate a bit stream.

In step S513, the file generation unit 523 generates a file using the bit stream and the subpicture rendering information. The file generation unit 523 generates a file by applying the present technology described above in <7. Resolution control 3 of image of subpicture>. That is, the file generation unit 523 stores the subpicture rendering information supplied from the preprocessing unit 521 in the file.

When step S513 ends, the file generation processing ends.

By performing pieces of processing as described above, the file generation apparatus 501 causes the subpicture rendering information to be signalled in the file. Accordingly, the client apparatus 503 that is a decoding side apparatus can acquire the subpicture rendering information from the file and use the subpicture rendering information for rendering. Accordingly, since the rendering can be controlled from the file generation apparatus 501, the client apparatus 503 can perform rendering more appropriately. For example, the client apparatus 503 can generate a display image with higher image quality. In other words, the file generation apparatus 501 can suppress an increase in the encoding amount for generating the display image with the same party's image quality.

<Flow of Reproduction Processing>

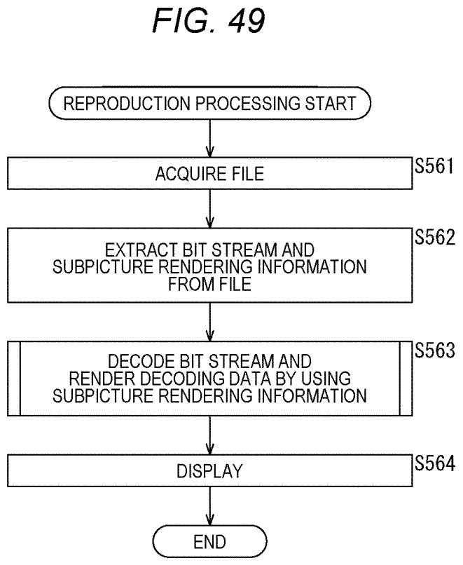

Next, an example of a flow of reproduction processing performed by the client apparatus 503 will be described with reference to the flowchart of FIG. 49.

When the reproduction processing is started, in step S561, the file acquisition unit 561 of the client apparatus 503 acquires the file from the distribution server 502.

In step S562, the file processing unit 562 extracts the bit stream and the subpicture rendering information from the file acquired in step S561. The file processing unit 562 performs processing by applying the present technology described above in <7. Resolution control 3 of image of subpicture>, and extracts the subpicture rendering information from the file. For example, the file processing unit 562 extracts the various types of information described above in <7. Resolution control 3 of image of subpicture> as the subpicture rendering information.

In step S563, the decoding unit 563 decodes the bit stream. At that time, the decoding unit 563 can perform this decoding by applying the various methods of the present technology described above in <1. Resolution control 1 of image of subpicture> to <6. Fourth embodiment>. Furthermore, the rendering unit 564 renders the decoded data using the subpicture rendering information to generate a display image. At that time, the rendering unit 564 can perform processing by applying the present technology described above in <7. Resolution control 3 of image of subpicture>.

In step S564, the display unit 565 displays the display image generated by the processing in step S563.

When step S564 ends, the reproduction processing ends.

By performing pieces of processing as described above, the client apparatus 503 can acquire the subpicture rendering information from the signalled file and use the subpicture rendering information for rendering. Accordingly, the client apparatus 503 can perform rendering more appropriately. For example, the client apparatus 503 can generate a display image with higher image quality. In other words, the file generation apparatus 501 can suppress an increase in the encoding amount for generating the display image with the same party's image quality.

### <9. Supplementary Note>

<Computer>

The series of processing described above can be also executed by hardware or can be executed by software. In a case where a series of processing is executed by software, a program constituting the software is installed in a computer. Here, the computer includes a computer incorporated in dedicated hardware and a general-purpose personal computer capable of executing various functions by installing various programs, for example, and the like.

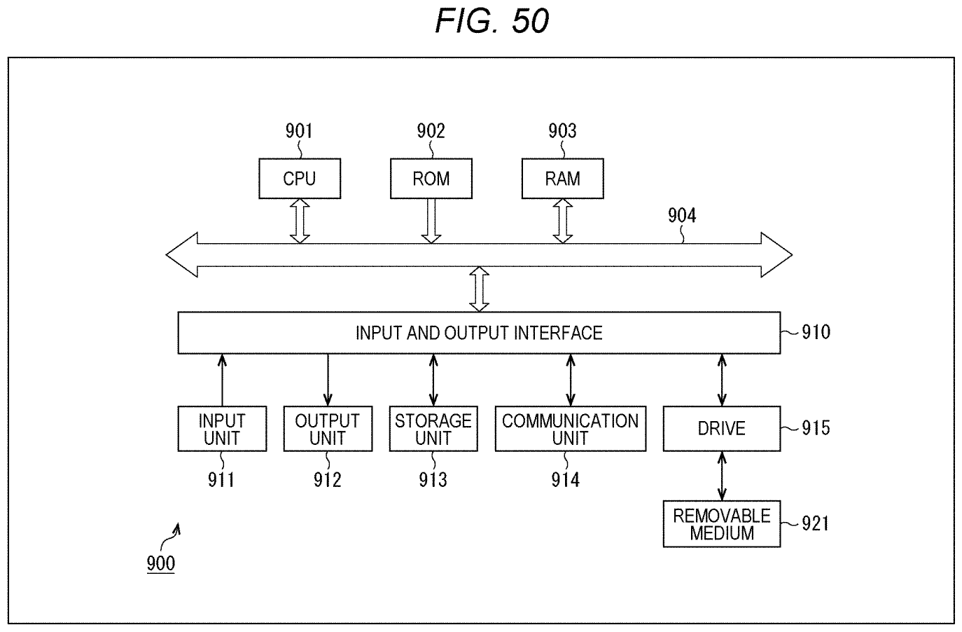

FIG. 50 is a block diagram showing a configuration example of a hardware configuration of a computer that executes the above-described series of processing by a program.

In a computer 900 illustrated in FIG. 50, a central processing unit (CPU) 901, a read only memory (ROM) 902, and a random access memory (RAM) 903 are mutually connected by a bus 904.

An input and output interface 910 is also connected to the bus 904. An input unit 911, an output unit 912, a storage unit 913, a communication unit 914, and a drive 915 are connected to the input and output interface 910.

The input unit 911 includes, for example, a keyboard, a mouse, a microphone, a touch panel, an input terminal, and the like. The output unit 912 includes, for example, a display, a speaker, an output terminal, and the like. The storage unit 913 includes, for example, a hard disk, a RAM disk, a nonvolatile memory, and the like. The communication unit 914 includes, for example, a network interface. The drive 915 drives a removable medium 921 such as a magnetic disk, an optical disk, a magneto-optical disk, or a semiconductor memory.

In the computer configured as described above, for example, the CPU 901 loads the program stored in the storage unit 913 into the RAM 903 via the input and output interface 910 and the bus 904, and executes the program, so that the above-described series of processing is performed. Furthermore, the RAM 903 appropriately stores also data or the like necessary for the CPU 901 to execute various processing.

The program executed by the computer can be applied by being recorded on the removable medium 921 as a package medium or the like, for example. In that case, a program can be installed in the storage unit 913 via the input and output interface 910 by mounting the removable medium 921 to the drive 915.

Furthermore, the program can be provided via a wired or wireless transmission medium such as a local area network, the Internet, or digital satellite broadcasting. In that case, the program can be received by the communication unit 914 and installed in the storage unit 913.

In addition, this program can be installed in the ROM 902 or the storage unit 913 in advance.

<Application Target of the Present Technology>

The present technology can be applied to any image encoding/decoding method. That is, as long as there is no contradiction with the present technology described above, specifications of various processes related to image encoding/decoding such as transformation (inverse transformation), quantization (inverse quantization), encoding (decoding), and prediction are arbitrary, and are not limited to the examples described above. Furthermore, as long as there is no contradiction with the present technology described above, some of these processes may be omitted.

Furthermore, the present technology can be applied to a multi-view image encoding/decoding system that encodes/decodes a multi-view image including images of a plurality of viewpoints (views). In that case, it is sufficient that the present technology is applied to encoding/decoding of each viewpoint (view).

Moreover, the present technology can be applied to a hierarchical image encoding (scalable encoding)/decoding system that encodes/decodes a hierarchical image layered (hierarchized) so as to have a scalability function for a predetermined parameter. In that case, it is sufficient that the present technology is applied to encoding/decoding of each layer.

Furthermore, in the above description, the image coding apparatus 100, the image decoding apparatus 200, and the image processing system 500 (the file generation apparatus 501 and the client apparatus 503) have been described as application examples of the present technology, but the present technology can be applied to an arbitrary configuration.

For example, the present technology can be applied to various electronic devices such as a transmitter and a receiver (for example, a television receiver and a mobile phone) in satellite broadcasting, cable broadcasting such as cable TV, distribution on the Internet, and distribution to a terminal by cellular communication, or a device (for example, a hard disk recorder and a camera) that records an image on a medium such as an optical disk, a magnetic disk, and a flash memory, or reproduces an image from the storage medium.

Furthermore, for example, the present technology can also be implemented as a partial configuration of an apparatus, such as a processor (for example, a video processor) as a system large scale integration (LSI) or the like, a module (for example, a video module) using a plurality of processors or the like, a unit (for example, a video unit) using a plurality of modules or the like, or a set (for example, a video set) obtained by further adding other functions to a unit.

Furthermore, for example, the present technology can also be applied to a network system including a plurality of apparatuses. For example, the present technology may be implemented as cloud computing in which a plurality of apparatuses performs sharing and collaborative processing via a network. For example, the present technology may be implemented in a cloud service that provides a service related to an image (moving image) to an arbitrary terminal such as a computer, an audio visual (AV) device, a portable information processing terminal, or an Internet of Things (IoT) device.

Note that, in this specification, a system means a set of a plurality of constituent elements (devices, modules (parts), or the like), and it does not matter whether or not all constituent elements are in the same casing. Therefore, a plurality of devices that is housed in separate housings and is connected via a network, and one device in which a plurality of modules is housed in one housing are both systems.

<Field and Application to which Present Technology is Applicable>

The system, the apparatus, the processing unit, and the like to which the present technology is applied can be used in arbitrary fields such as traffic, medical care, crime prevention, agriculture, livestock industry, mining, beauty, factory, home appliance, weather, and natural environment monitoring. Furthermore, the application of the present technology is also arbitrary.

For example, the present technology can be applied to a system or a device provided for providing content for appreciation or the like. Furthermore, for example, the present technology can also be applied to a system or a device provided for traffic, such as traffic condition supervision and automatic driving control. Moreover, for example, the present technology can also be applied to a system or a device provided for security. Furthermore, for example, the present technology can be applied to a system or a device provided for automatic control of a machine or the like. Moreover, for example, the present technology can also be applied to a system or a device provided for agriculture and livestock industry. Furthermore, for example, the present technology can also be applied to a system or a device that monitor natural environment states such as volcanoes, forests, and oceans, wildlife, and the like. Moreover, for example, the present technology can also be applied to systems and devices provided for sports. <Others>

Note that, in the present specification, the “flag” is information for identifying a plurality of states, and includes not only information used for identifying two states of true (1) and false (0) but also information capable of identifying three or more states. Therefore, the value that can be taken by the “flag” may be, for example, a binary of 1/0 or a ternary or more. That is, the number of bits constituting this “flag” is arbitrary, and may be one bit or a plurality of bits. Furthermore, since the identification information (including the flag) is assumed to include not only the identification information in the bit stream but also the difference information of the identification information with respect to certain reference information in the bit stream, in the present specification, the “flag” and the “identification information” include not only the information but also the difference information with respect to the reference information.

Furthermore, various types of information (metadata and the like) related to the coded data (bit stream) may be transmitted or recorded in any form as long as the information is associated with the coded data. Here, the term “associate” means, for example, that one data is enabled to be used (linked) when the other data is processed. That is, the data associated with each other may be collected as one piece of data or may be individual pieces of data. For example, information associated with coded data (image) may be transmitted on a transmission path different from that of the coded data (image). Furthermore, for example, the information associated with the coded data (image) may be recorded in a recording medium (or another recording area of the same recording medium) different from the coded data (image). Note that this “association” may be performed on part of data instead of the entire data. For example, an image and information corresponding to the image may be associated with each other in an arbitrary unit such as a plurality of frames, one frame, or a part in a frame.

Note that, in the present specification, terms such as “combine”, “multiplex”, “add”, “integrate”, “include”, “store”, “insert”, and “insert” mean to combine a plurality of items into one, for example, to combine coded data and metadata into one piece of data, and mean one method of the above-described “associate”.

Furthermore, the embodiments of the present technology are not limited to the above-described embodiments, and various modifications are possible without departing from the gist of the present technology.

For example, the configuration described as one apparatus (or processing unit) may be divided and configured as a plurality of apparatuses (or processing units). On the contrary, in the above, the configuration described as a plurality of apparatuses (or processing units) may be integrated and configured as one apparatus (or processing unit). Furthermore, configurations other than those described above, of course, may be added to the configuration of each apparatus (or each processing unit). Moreover, when the configuration and operation of the system as a whole are substantially the same, a part of the configuration of a certain apparatus (or processing unit) may be included in the configuration of another apparatus (or another processing unit).

Furthermore, for example, the above-described program may be enabled to be executed in any device. In that case, it is sufficient that the apparatus has a necessary function (function block or the like) so that necessary information can be acquired.

Furthermore, for example, each step of one flowchart may be performed by one apparatus, or may be shared and performed by a plurality of apparatuses. Moreover, in a case where a plurality of pieces of processing is included in one step, a plurality of pieces of processing included in the one step can be performed by one apparatus or shared and performed by a plurality of apparatuses. In other words, a plurality of processes included in one step can be performed as a plurality of steps. On the contrary, the processes described as a plurality of steps can be collectively performed as one step.

Furthermore, for example, the program executed by the computer may be configured such that the processes of the steps for writing the program are executed in time series in the order described in this specification, or may be executed individually at a necessary timing such as in parallel or when the calls are made. That is, as long as no contradiction occurs, the processing of each step may be executed in an order different from the order described above. Moreover, the process of the step for writing the program may be executed in parallel with the process of another program, or may be executed in combination with the process of another program.

Furthermore, for example, the plurality of technologies according to the present technology can be implemented independently as a single unit unless a contradiction occurs. Of course, a plurality of arbitrary present technologies can be used in combination. For example, part or all of the present technology described in any of the embodiments can be implemented in combination with part or all of the present technology described in other embodiments. Furthermore, part or all of the present technology described above may be implemented in combination with other technology not described above.

Note that, the present technology can also adopt the following configuration.

(1) An image processing apparatus including

a decoding unit that decodes coded data obtained by encoding an image of a fixed subpicture being a subpicture in which a position of a reference pixel is fixed in a time direction, in subpictures that are partial areas obtained by dividing a picture, with a resolution variable in a time direction to generate the image of the resolution of the fixed subpicture.

(2) The image processing apparatus according to (1), further including an analysis unit that analyzes subpicture

resolution information that is information indicating the resolution and is set for each of the picture,

in which the decoding unit decodes the coded data, and generates the image of the fixed subpicture having the resolution indicated by the subpicture resolution information analyzed by the analysis unit.

(3) The image processing apparatus according to (2),

in which the analysis unit analyzes subpicture reference pixel position information that is information indicating a position of the reference pixel of the subpicture, subpicture maximum resolution information that is information indicating a maximum resolution of the subpicture, and subpicture ID mapping information that is a list of identification information of the subpicture, the subpicture reference pixel position information, the subpicture maximum resolution information, and the subpicture ID mapping information being set for each sequence, and

the decoding unit decodes the coded data on the basis of the subpicture reference pixel position information, the subpicture maximum resolution information, and the subpicture ID mapping information that have been analyzed by the analysis unit, and generates the image having the resolution of the fixed subpicture.

(4) The image processing apparatus according to (2) or (3),

the analysis unit analyzes a subpicture ID fixed flag that is flag information indicating whether subpicture ID mapping information that is a list of identification information of the subpicture is not changed in a sequence, and

the decoding unit decodes the coded data on the basis of the subpicture ID fixed flag analyzed by the analysis unit, and generates the image having the resolution of the fixed subpicture.

(5) The image processing apparatus according to any one of (2) to (4),

in which the analysis unit analyzes a non-subpicture area existence flag that is flag information indicating whether a non-subpicture area that is an area not included in the subpicture exists in any of the picture in the sequence, and

the decoding unit decodes the coded data on the basis of the non-subpicture area existence flag analyzed by the analysis unit, and generates the image having the resolution of the fixed subpicture.

(6) The image processing apparatus according to any one of (2) to (5),

the analysis unit analyzes effective area information that is information regarding an effective area that is an area in which pixel data exists of the picture, and

the image processing apparatus further includes a rendering unit that renders image data of the effective area obtained by the decoding unit on the basis of the effective area information analyzed by the analysis unit and generates a display image.

(7) The image processing apparatus according to any one of (2) to (6),

in which the analysis unit analyzes a uncoded area existence flag that is flag information indicating whether a pixel having no coded data exists in the picture, and

the decoding unit decodes the coded data on the basis of the uncoded area existence flag analyzed by the analysis unit, and generates the image having the resolution of the fixed subpicture.

(8) The image processing apparatus according to any one of (2) to (7),

in which the analysis unit analyzes position information indicating a position of the reference pixel of the subpicture, the position information being set for each of the picture, and

the decoding unit decodes the coded data on the basis of the position information analyzed by the analysis unit, and generates the image having the resolution of the fixed subpicture.

(9) The image processing apparatus according to any one of (2) to (8),

in which the analysis unit analyzes a no-slice data flag that is flag information indicating whether it is the subpicture in which all pixels do not have the coded data, and

the decoding unit decodes the coded data on the basis of the no-slice data flag analyzed by the analysis unit, and generates the image having the resolution of the fixed subpicture.

(10) The image processing apparatus according to any one of (2) to (9),

in which the analysis unit analyzes an RPR-applied subpicture enable flag that is flag information indicating whether the fixed subpicture is included, and

the decoding unit decodes the coded data on the basis of the RPR-applied subpicture enable flag analyzed by the analysis unit, and generates the image having the resolution of the fixed subpicture.

(11) The image processing apparatus according to any one of (2) to (10),

in which the analysis unit analyzes subpicture window information that is information regarding a subpicture window that is an area of the image having the resolution of the fixed subpicture, and

the image processing apparatus further includes a rendering unit that renders the image having the resolution of the fixed subpicture on the basis of the subpicture window information analyzed by the analysis unit and generates a display image. (12) The image processing apparatus according to (11),

in which the subpicture window information includes a subpicture window existence flag that is flag information indicating whether the subpicture window exists.

(13) The image processing apparatus according to (11) or (12),

in which the analysis unit analyzes a subpicture window decoding control flag that is flag information related to decoding control of the coded data of the subpicture window, and

the decoding unit decodes the coded data on the basis of the subpicture window decoding control flag analyzed by the analysis unit, and generates the image having the resolution of the fixed subpicture. (14) The image processing apparatus according to any one of (11) to (13),

in which the analysis unit analyzes subpicture window maximum size information that is information indicating a maximum size of the subpicture window, and

the decoding unit decodes the coded data on the basis of the subpicture window maximum size information analyzed by the analysis unit, and generates the image having the resolution of the fixed subpicture.

(15) The image processing apparatus according to any one of (11) to (14),

in which the analysis unit analyzes reference subpicture window resampling information that is information regarding the subpicture window that requires resampling of a reference subpicture window, and

the decoding unit decodes the coded data on the basis of the reference subpicture window resampling information analyzed by the analysis unit, and generates the image having the resolution of the fixed subpicture.

(16) The image processing apparatus according to any one of (11) to (15),

in which the analysis unit analyzes a rescaling prohibition flag that is flag information indicating whether rescaling of a resolution of a reference picture is prohibited, and

the decoding unit decodes the coded data on the basis of the rescaling prohibition flag analyzed by the analysis unit, and generates the image having the resolution of the fixed subpicture.

(17) The image processing apparatus according to any one of (1) to (16), further including:

an extraction unit that extracts, from a file, the coded data and subpicture rendering information that is information regarding rendering of the subpicture; and

a rendering unit that renders the image having the resolution of the fixed subpicture generated by the decoding unit decoding the coded data extracted from the file by the extraction unit, on the basis of the subpicture rendering information extracted from the file by the extraction unit, and generates a display image.

(18) An image processing method including

decoding coded data obtained by encoding an image of a fixed subpicture being a subpicture in which a position of a reference pixel is fixed in a time direction, in subpictures that are partial areas obtained by dividing a picture, with a resolution variable in a time direction to generate the image of the resolution of the fixed subpicture.

(21) An image processing apparatus including

an encoding unit that encodes an image of a fixed subpicture being a subpicture in which a position of a reference pixel is fixed in a time direction, in subpictures that are partial areas obtained by dividing a picture, with a resolution variable in a time direction to generate coded data. (22) The image processing apparatus according to (21), further including:

a metadata generation unit that generates, as metadata, subpicture resolution information that is information indicating the resolution for each of the picture; and

a bit stream generation unit that generates a bit stream including the coded data generated by the encoding unit and the subpicture resolution information generated by the metadata generation unit.

(23) The image processing apparatus according to (22),

in which the metadata generation unit generates, for each sequence, subpicture reference pixel position information that is information indicating a position of the reference pixel of the subpicture, subpicture maximum resolution information that is information indicating a maximum resolution of the subpicture, and subpicture ID mapping information that is a list of identification information of the subpicture, as the metadata, and

the bit stream generation unit generates the bit stream including the subpicture reference pixel position information, the subpicture maximum resolution information, and the subpicture ID mapping information that have been generated by the metadata generation unit.

(24) The image processing apparatus according to (22) or (23),

in which the metadata generation unit generates, as the metadata, a subpicture ID fixed flag that is flag information indicating whether subpicture ID mapping information that is a list of identification information of the subpicture is not changed in a sequence, and

the bit stream generation unit generates the bit stream including the subpicture ID fixed flag generated by the metadata generation unit.

(25) The image processing apparatus according to any one of (22) to (24),

in which the metadata generation unit generates, as the metadata, a non-subpicture area existence flag that is flag information indicating whether a non-subpicture area that is an area not included in the subpicture exists in any of the picture in the sequence, and

the bit stream generation unit generates the bit stream including the non-subpicture area existence flag generated by the metadata generation unit.

(26) The image processing apparatus according to any one of (22) to (25),

in which the metadata generation unit generates, as the metadata, effective area information that is information regarding an effective area that is an area in which pixel data exists of the picture, and

the bit stream generation unit generates the bit stream including the effective area information generated by the metadata generation unit.

(27) The image processing apparatus according to any one of (22) to (26),

in which the metadata generation unit generates, as the metadata, an uncoded area existence flag that is flag information indicating whether a pixel having no coded data exists in the picture, and

the bit stream generation unit generates the bit stream including the uncoded area existence flag generated by the metadata generation unit.

(28) The image processing apparatus according to any one of (22) to (27),

in which the metadata generation unit generates, as the metadata, position information indicating a position of the reference pixel of the subpicture for each of the picture, and

the bit stream generation unit generates the bit stream including the position information generated by the metadata generation unit.

(29) The image processing apparatus according to any one of (22) to (28),

in which the metadata generation unit generates a no-slice data flag that is flag information indicating whether it is the subpicture in which all pixels do not have the coded data, and

the bit stream generation unit generates the bit stream including the no-slice data flag generated by the metadata generation unit.

(30) The image processing apparatus according to any one of (22) to (29),

in which the metadata generation unit generates an

RPR-applied subpicture enable flag that is flag information indicating whether the fixed subpicture is included, and

the bit stream generation unit generates the bit stream including the RPR-applied subpicture enable flag generated by the metadata generation unit.

(31) The image processing apparatus according to any one of (22) to (30),

in which the metadata generation unit generates subpicture window information that is information regarding a subpicture window that is an area of the image having the resolution of the fixed subpicture, and

the bit stream generation unit generates the bit stream including the subpicture window information generated by the metadata generation unit. (32) The image processing apparatus according to (31),

in which the subpicture window information includes a subpicture window existence flag that is flag information indicating whether the subpicture window exists.

(33) The image processing apparatus according to (31) or (32),

in which the metadata generation unit generates a subpicture window decoding control flag that is flag information related to decoding control of the coded data of the subpicture window, and

the bit stream generation unit generates the bit stream including the subpicture window decoding control flag generated by the metadata generation unit. (34) The image processing apparatus according to any one of (31) to (33),

in which the metadata generation unit generates subpicture window maximum size information that is information indicating a maximum size of the subpicture window, and

the bit stream generation unit generates the bit stream including the subpicture window maximum size information generated by the metadata generation unit.

(35) The image processing apparatus according to any one of (31) to (34),

in which the metadata generation unit generates reference subpicture window resampling information that is information regarding the subpicture window that requires resampling of a reference subpicture window, and

the bit stream generation unit generates the bit stream including the reference subpicture window resampling information generated by the metadata generation unit.

(36) The image processing apparatus according to any one of (31) to (35),

in which the metadata generation unit generates a rescaling prohibition flag that is flag information indicating whether rescaling of a resolution of a reference picture is prohibited, and

the bit stream generation unit generates the bit stream including the rescaling prohibition flag generated by the metadata generation unit.

(37) The image processing apparatus according to any one of (21) to (36), further including:

a preprocessing unit that generates subpicture rendering information that is information regarding rendering of the subpicture; and

a file generation unit that generates a file that stores the subpicture rendering information generated by the preprocessing unit and the coded data generated by the encoding unit.

(38) An image processing method including

encoding an image of a fixed subpicture being a subpicture in which a position of a reference pixel is fixed in a time direction, in subpictures that are partial areas obtained by dividing a picture, with a resolution variable in a time direction to generate coded data.

### REFERENCE SIGNS LIST

100 Image encoding apparatus
101 Encoding unit
102 Metadata generation unit
03 Bit stream generation unit
200 Image decoding apparatus
201 Analysis unit
202 Extraction unit
203 Decoding unit
204 Rendering unit
500 Image processing system
501 File generation unit
502 Distribution server
503 Client apparatus
511 Control unit
512 File generation processing unit
521 Preprocessing unit
522 Encoding unit
523 File generation unit
524 Recording unit
525 Upload unit
551 Control unit
552 Reproduction processing unit
561 File acquisition unit
562 File processing unit
563 Decoding unit
564 Rendering unit
565 Display unit
566 Measurement unit
567 Display control unit

1. An image processing apparatus comprising
an encoding unit that encodes an image of a fixed subpicture being a subpicture in which a position of a reference pixel is fixed in a time direction, in subpictures that are partial areas obtained by dividing a picture, with a resolution variable in a time direction to generate coded data.

2. The image processing apparatus according to claim 1, further comprising:
a metadata generation unit that generates, as metadata, subpicture resolution information that is information indicating the resolution for each of the picture; and
a bit stream generation unit that generates a bit stream including the coded data generated by the encoding unit and the subpicture resolution information generated by the metadata generation unit.

3. The image processing apparatus according to claim 2,
wherein the metadata generation unit generates, for each sequence, subpicture reference pixel position information that is information indicating a position of the reference pixel of the subpicture, subpicture maximum resolution information that is information indicating a maximum resolution of the subpicture, and subpicture ID mapping information that is a list of identification information of the subpicture, as the metadata, and
the bit stream generation unit generates the bit stream including the subpicture reference pixel position information, the subpicture maximum resolution information, and the subpicture ID mapping information that have been generated by the metadata generation unit.

4. The image processing apparatus according to claim 2,
wherein the metadata generation unit generates, as the metadata, a subpicture ID fixed flag that is flag information indicating whether or not subpicture ID mapping information that is a list of identification information of the subpicture is not changed in a sequence, and
the bit stream generation unit generates the bit stream including the subpicture ID fixed flag generated by the metadata generation unit.

5. The image processing apparatus according to claim 2,
wherein the metadata generation unit generates, as the metadata, a non-subpicture area existence flag that is flag information indicating whether a non-subpicture area that is an area not included in the subpicture exists in any of the picture in the sequence, and
the bit stream generation unit generates the bit stream including the non-subpicture area existence flag generated by the metadata generation unit.

6. The image processing apparatus according to claim 2,
wherein the metadata generation unit generates, as the metadata, effective area information that is information regarding an effective area that is an area in which pixel data exists of the picture, and
the bit stream generation unit generates the bit stream including the effective area information generated by the metadata generation unit.

7. The image processing apparatus according to claim 2,
wherein the metadata generation unit generates, as the metadata, an uncoded area existence flag that is flag information indicating whether a pixel having no coded data exists in the picture, and
the bit stream generation unit generates the bit stream including the uncoded area existence flag generated by the metadata generation unit.

8. The image processing apparatus according to claim 2,
wherein the metadata generation unit generates, as the metadata, position information indicating a position of the reference pixel of the subpicture for each of the picture, and
the bit stream generation unit generates the bit stream including the position information generated by the metadata generation unit.

9. The image processing apparatus according to claim 2,
wherein the metadata generation unit generates a no-slice data flag that is flag information indicating whether it is the subpicture in which all pixels do not have the coded data, and
the bit stream generation unit generates the bit stream including the no-slice data flag generated by the metadata generation unit.

10. The image processing apparatus according to claim 2,
wherein the metadata generation unit generates an RPR-applied subpicture enable flag that is flag information indicating whether the fixed subpicture is included, and
the bit stream generation unit generates the bit stream including the RPR-applied subpicture enable flag generated by the metadata generation unit.

11. The image processing apparatus according to claim 2,
wherein the metadata generation unit generates subpicture window information that is information regarding a subpicture window that is an area of the image having the resolution of the fixed subpicture, and
the bit stream generation unit generates the bit stream including the subpicture window information generated by the metadata generation unit.

12. The image processing apparatus according to claim 11,
wherein the subpicture window information includes a subpicture window existence flag that is flag information indicating whether the subpicture window exists.

13. The image processing apparatus according to claim 11,
wherein the metadata generation unit generates a subpicture window decoding control flag that is flag information related to decoding control of the coded data of the subpicture window, and
the bit stream generation unit generates the bit stream including the subpicture window decoding control flag generated by the metadata generation unit.

14. The image processing apparatus according to claim 11,
wherein the metadata generation unit generates subpicture window maximum size information that is information indicating a maximum size of the subpicture window, and
the bit stream generation unit generates the bit stream including the subpicture window maximum size information generated by the metadata generation unit.

15. The image processing apparatus according to claim 11,
wherein the metadata generation unit generates reference subpicture window resampling information that is information regarding the subpicture window that requires resampling of a reference subpicture window, and
the bit stream generation unit generates the bit stream including the reference subpicture window resampling information generated by the metadata generation unit.

16. The image processing apparatus according to claim 11,
wherein the metadata generation unit generates a rescaling prohibition flag that is flag information indicating whether rescaling of a resolution of a reference picture is prohibited, and
the bit stream generation unit generates the bit stream including the rescaling prohibition flag generated by the metadata generation unit.

17. The image processing apparatus according to claim 1, further comprising:
a preprocessing unit that generates subpicture rendering information that is information regarding rendering of the subpicture; and
a file generation unit that generates a file that stores the subpicture rendering information generated by the preprocessing unit and the coded data generated by the encoding unit.

18. An image processing method comprising
encoding an image of a fixed subpicture being a subpicture in which a position of a reference pixel is fixed in a time direction, in subpictures that are partial areas obtained by dividing a picture, with a resolution variable in a time direction to generate coded data.

19. An image processing apparatus comprising
a decoding unit that decodes coded data obtained by encoding an image of a fixed subpicture being a subpicture in which a position of a reference pixel is fixed in a time direction, in subpictures that are partial areas obtained by dividing a picture, with a resolution variable in a time direction to generate the image of the resolution of the fixed subpicture.

20. An image processing method comprising
decoding coded data obtained by encoding an image of a fixed subpicture being a subpicture in which a position of a reference pixel is fixed in a time direction, in subpictures that are partial areas obtained by dividing a picture, with a resolution variable in a time direction to generate the image of the resolution of the fixed subpicture.
